(19) United States
(12) Patent Application Publication
(10) Pub. No.: US 2023/0295203 A1
(43) Pub. Date: Sep. 21, 2023

(54) METAL ORGANIC COMPOUNDS

(71) Applicant: UMICORE AG & CO. KG, Hanau-Wolfgang (DE)

(72) Inventors: Nicholas RAU, Marburg (DE); Wolf SCHORN, Waldbronn (DE); Annika FREY, Hanau (DE); Angelino DOPPIU, Seligenstadt (DE); Eileen WOERNER, Nidderau (DE); Ralf KARCH, Kleinostheim (DE)

(73) Assignee: UMICORE AG & CO. KG, Hanau-Wolfgang (DE)

(21) Appl. No.: 17/995,132

(22) PCT Filed: Apr. 1, 2020
(86) PCT No.: PCT/EP2020/059261

§ 371 Date: Sep. 30, 2022

(51) Int. Cl. C07F 11/00

(52) U.S. Cl. CPC C07F 11/00

(57) ABSTRACT

The invention concerns a process for preparing an essentially silicon (Si) free compounds of the general formula [M(O)(OR)_{y}], wherein M = Mo, y = 3 or M = W, y = 3 or 4. Furthermore, it is directed towards compounds obtained by the aforementioned process and towards the use of such an obtained compound. Another objective of the herein described invention are essentially silicon free compounds of the general formula MOX_{y} or [MOX_{y}(solv)ₚ], prepared using the aforementioned process, wherein M = Mo, y = 3 or M = W, y = 3 or 4, X = Cl or Br, solv = an oxidizing agent Z binding or coordinating to M via at least one donor atom, p = 1 or 2. The invention is also directed towards the use of essentially silicon free compounds prepared using the aforementioned process of the general formula MOX_{y} or [MOX_{y}(solv)ₚ],

The present invention concerns a process for preparing an essentially silicon (Si) free compounds of the general formula [M(O)(OR)_{y}], wherein M = Mo and y = 3, M = W and y = 3 or 4. R is selected from the group consisting of a linear, branched or cyclic alkyl group (C5 - C10), a linear, branched or cyclic partially or fully halogenated alkyl group (C5 - C10), an alkylene alkyl ether group (R^{E}-O)ⁿ-R^{F}, wherein n = 1 to 5 or 1, 2 or 3, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene. R^{E} are independently from each other selected from the group consisting of a linear, a branched or a cyclic alkyl group (C1 - C6) and a linear, a branched or a cyclic partially or fully halogenated alkyl group (C1 - C6) and R^{F} are independently from each other selected from the group consisting of a linear, a branched or a cyclic alkyl group (C1 - C10) and a linear, a branched or a cyclic partially or fully halogenated alkyl group (C1 - C10). Furthermore, the present invention is directed towards compounds obtained by the aforementioned process and towards the use of such an obtained compound.

Oxyalkoxides of molybdenum and tungsten according to the general formula [M(O)(OR)_{y}], wherein M = Mo and y = 3 or M = W and y = 3 or 4, and processes for preparing them are known in the state of the art. Several volatile representatives of this group of tungsten(VI) oxyalkoxides, e.g. [W(O)(OiPr)₄] and [W(O)(OsBu)₄], are used as precursors for WO₃. For the preparation of WO₃ layer or films gas chemical vapour deposition (CVD) processes or sol-gel process are generally applied.

For all applications relating to deposition of compounds, semiconductor, photovoltaic or catalytic their precursors, e.g. [Mo(O)(OR)₄] and [W(O)(OR)₄], have to be producible in large amounts in a straightforward, cost-efficient process. In addition, it is mandatory that they comply with high purity specifications. Particularly, ionic contaminations, e.g. lithium, sodium and potassium ions, and contaminations by silicon (Si) or silicon compounds, shall be avoided.

According to the state of the art molybdenum(VI) and tungsten(VI) oxytetraalkoxide compounds of the type [Mo(O)(OR)₄] and [W(O)(OR)₄] are usually manufactured starting from molybdenum and tungsten(VI) oxytetrachloride. The target compounds [Mo(O)(OR)₄] and [W(O)(OR)₄] are obtained by chemical reaction with i) the free alcohol and ammonia or ii) the corresponding lithium alcoholate.

The first synthesis route i) starting from WOCl₄ and the corresponding alcohol and ammonia was published by H. Funk et al. for R = Me, Et, iPr, nBu, C₆H₁₁. Benzene is used as a solvent. (Z. Anorg. Allg. Chem. 1960, 304, 238 - 240) In order to obtain the chloride-free compounds selectively it is mandatory to pass ammonia gas into the reaction mixture. Thereby large amounts of NH₄Cl are formed. To avoid precipitation of a major part of the product and the NH₄Cl freight at the same three times as much alcohol has to be added as is needed for substitution of the four chlorine atoms. The difficulty with this route is particularly the use of the hydrolysis-sensitive starting material WOCl₄. The latter has to be prepared in a previous reaction step, to be isolated and to be purified by sublimation before further application.

The synthetic route ii) was presented in WO 2016/006231 A1, for [W(O)(OsBu)₄], for example, wherein sBuOH, nBuLi and WOCl₄ are applied as starting materials and tetrahydrofuran and toluene are used as solvents. After vacuum distillation the product is obtained as slightly yellow liquid in a yield of 73% (87 mmol). [W(O)(OiPr)₄] is isolated after sublimation in a yield of 46% (5.5 mmol). When trying to upscale the process for [W(O)(OiPr)₄] - starting from 144 mmol WOCl₄ - a non-identifiable brown oil was obtained. Therefore, the preparation of [W(O)(OiPr)₄] on industrial scale is regarded as difficult (cf. paragraph [0093]). A disadvantage with this preparation method is the formation of four equivalents LiCI being - if at all - only particularly difficult to separate from ether solutions. Moreover, formation of non-separable lithium tungstate complexes is possible. (Z. A. Starikova et al., Polyhedron 2002, 21, 193 - 195 und V. G. Kessler et al., J. Chem. Soc., Dalt. Trans. 1998, 21 - 29)

In Koord. Khimiya 1985, 11, 1521 - 1528 S. I. Kucheiko et al. reported on the preparation of [W(O)(OR)₄] (R = Me, Et, iPr, tBu) starting from WOCl₄ and the corresponding NaOR in a ROH/Et₂O solvent mixture. The synthesis of [W(O)(OtBu)₄] is conducted from WOCl₄ and LiOtBu in tetrahydrofuran.

In 1986 a procedure for preparing compounds of the general formula [WO(OR)₄] (R = alkyl) was described in JPS6136292 by K. Ishio et al. In a first step a tungsten halide, preferably WCl₆, is reacted with an alcohol, preferably comprising 1 to 10 carbon atoms. Preferentially, a solvent mixture of a chlorine-based solvent, e.g. carbon tetrachloride, with an aromatic solvent, e.g. benzene, is used as a solvent. The reaction temperature usually equal to or lower than 60° C. Subsequently, the intermediate product is reacted with a deacidifying agent, preferably ammonia gas. This method differs from the above-described synthesis route i) concerning the tungsten(VI) starting material being commercially available WCl₆ instead of WOCl₄. However, the major drawback is the same as explained above, i.e. use of a large excess of the alcohol has to be applied. This is disadvantageously not only from an environmental and commercial point of view, but also with respect to the product quality and the product purity, respectively. The reason for the latter is that, particularly in case of long-chain and thus high-boiling alcohols the separation of excess alcohol is very challenging, if possible at all.

A major drawback of most of the known processes for preparing compounds of the type [W(O)(OR)₄] is the use of WOCl₄ being hardly commercially available in high quality. The hydrolysis-sensitive starting material WOCl₄ has to be manufactured in a previous synthesis, to be isolated and to be sublimated before further application. Thus, its preparation does not only comprise a further synthesis step, but is, in addition, complex and cost-intensive. The use of nBuLi for the production of the lithium alcoholate LiOR is also elaborate and expensive. Another disadvantage is that large amounts of inorganic salts such as LiCI or NH₄Cl are formed whose quantitative separation is – if possible at all – difficult in many cases. The reason for that is that the reactions are usually carried out in tetrahydrofuran or alcohols as a solvent. Furthermore, in the presence of lithium ions formation of lithium tungstate complexes is possible, e.g. Li[W(O)(OR)₅], which are also very difficult to separate or non-separable.

The procedures known from literature normally provide a complex purification by fractional distillation and/or sublimation. However, the obtained products can comprise contaminations by inorganic salt, which are not exactly quantifiable. Thus, their characteristics can be altered and diminished, respectively, – in comparison to the pure products – in a non-controllable and partly irreversible manner. Another major drawback is the application of a large excess of the alcohol. This is disadvantageously not only from an environmental and commercial point of view, but also with respect to the product quality and the product purity, respectively. The reason for the latter is that the separation of excess alcohol is time-consuming and, in case of long-chained and thus high-boiling alcohols, also very challenging, if possible at all. Moreover, in view of an industrial application the yields achieved by most of the aforementioned preparation methods are comparatively low.

With respect to the synthesis of WOCl₄ probably being the most common starting material for the synthesis of tungsten(VI) oxyalkoxides of the general formula [W(O)(OR)₄] basically three different reaction types, namely transport reactions, solid reactions and wet-chemical processes, are known in the state of the art. With respect to the wet-chemical methods there exist essentially two established methods. A first wet-chemical procedure a) for preparing WOCl₄ starts from WO₃ and a chlorine source such as CCl₄, C₅Cl₈, S₂Cl₂, SOCl₂, Cl₃CNO₂. By-products are, for example, COCl₂ (reaction with CCl₄), SO₂ (reaction with SOCl₂ or S₂Cl₂) and Cl₂. The major disadvantage of this synthesis route is that both the chlorine sources and the by-products are dangerous to the environment. Thus, specific security measures and waste disposal concepts are required, making a production according to this route not only non-ecological but also uneconomical and hence unsatisfactory. According to a second wet-chemical procedure b) WCl₆ is reacted with an oxidizing agent, particularly a siloxane based one. For instance, hexamethyldisiloxane (TMS₂O) or tBuOTMS are applied as oxidizing agents. Unfavourably, the target compound is contaminated with silicon (Si) and/or a silicon comprising compound. This is a major disadvantage, particularly in the field of electrical engineering, electrochemistry and semiconductors, as problems will probably arise in conjunction with the end applications. In addition, the by-product of route b), TMSCI, is toxic and reacts to hydrogen chloride during air contact.

In summary, the predescribed processes, from the ecological and economical point of view, are classified as unsatisfactory.

It is an objective of the present invention to overcome the above-mentioned and other disadvantages of the state of the art and to provide a process for preparing molybdenum(V) oxyalkoxides, tungsten(V) oxyalkoxides and tungsten(VI) oxyalkoxides being essentially free of alkali metal ions, silicon (Si) and silicon compounds. The process should be versatile, straight-forward, cost-efficient, reproducible, comparatively environmentally friendly and easily scalable for industrial production with high purities and good yields. The oxyalkoxides obtained by this process should comply with the highly-demanding purity specifications required for applications like deposition of compounds, semiconductor, photovoltaic or catalysis. Furthermore, the present invention is directed towards the use of such oxyalkoxides in applications like deposition of compounds, semiconductor, photovoltaic or catalysis. Another objective of the present invention is to provide a process for preparing molybdenum(V) oxyhalogenides, tungsten(V) oxyhalogenides and tungsten(VI) oxyhalogenides being essentially free of silicon (Si) and silicon compounds. The process should be versatile, straight-forward, cost-efficient, comparatively environmentally friendly, reproducible and easily scalable for industrial production with high purities and good yields. In addition, the present invention relates to the use of oxyhalogenides prepared by the method herein for preparing molybdenum(V) oxyalkoxides, tungsten(V) oxyalkoxides and tungsten(VI) oxyalkoxides being essentially free of alkali metal ions, silicon (Si) and silicon compounds.

The main characteristics of the invention are indicated in the claims.

The problem is solved by a process for preparing an essentially silicon (Si) free compound of the general formula

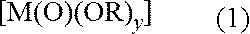

wherein
M = Mo and y = 3 or M = W and y = 3 or 4 and
R is selected from the group consisting of a linear, branched or cyclic alkyl group (C1 C10), a linear, branched or cyclic partially or fully halogenated alkyl group (C1 -C10), an alkylene alkyl ether group (R^{E}-O)ⁿ-R^{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{E} are independently from each other selected from the group consisting of a linear, a branched or a cyclic alkylene group (C1 - C6) and a linear, a branched or a cyclic partially or fully halogenated alkylene group (C1 - C6),
   R^{F} are independently from each other selected from the group consisting of a linear, a branched or a cyclic alkyl group (C1 - C10) and a linear, a branched or a cyclic partially or fully halogenated alkyl group (C1 - C10), a substituted or unsubstituted aryl group (C6 - C11), and
   n = 1 to 5 or 1, 2 or 3,
comprising the steps of
a) reacting a compound of the general formula MX_{y}+₂ wherein
   M and y are defined as above and
   X = Cl or Br,
   with an essentially silicon (Si) free oxidizing agent Z comprising 1 to 10 carbon atoms
   at a molar ratio of MX_{y}+₂ to the oxidizing agent Z of at least 1 : 0.75.
   in at least one aprotic solvent A,
b) addition of an alcohol ROH, wherein
   R is defined as above,
   a molar ratio of MX_{y}+₂ to the alcohol ROH is at least 1 : 3, and
   ROH is different from the oxidizing agent Z of step a),
c) supply of at least one essentially silicon (Si) free base.

Within the scope of the present invention the term “essentially silicon-free” means that a reagent, reactant, additive, precursor, a solvent or a product does not contain silicon in its formula but may contain minor amounts (around the detection limit) of free or bound silicon. In particular, this concerns the applied oxidizing agents and bases as well as target compounds of the general formula [M(O)(OR)_{y}] (I). Thus, in the context of the present invention, an oxidizing agent, a base or a target compound according to the general formula [M(O)(OR)_{y}] (I), respectively, is considered as “essentially silicon-free” if it has a silicon content of 1000 ppm (thousand) or less, favourably of 500 ppm (five hundred) or less, in particular 70 ppm (seventy) ppm or less, more specifically 50 (fifty) ppm or less; or 10 ppm (ten) or less, particularly of 1.500 ppb (fifteen hundred) or less. A suitable method for determining the silicon content of the applied reagent, reactant, additive, precursor or solvent or of a product, particularly of the applied oxidizing agents and bases and the target compounds of the general formula [M(O)(OR)_{y}] (I), is inductively coupled plasma optical emission spectrometry (ICP-OES).

Steps a), step b) or both may comprise a distillation. Such a distillation is to be carried out after the chemical reaction of the reactants has been completed. Such a distillation may be carried out to remove unreacted educts, by-products of the reaction, the reaction medium / solvent in order to employ a different solvent in a subsequent step, or all of the foregoing.

The respective desired product is, in this reaction, supposed to not be removed, but to remain in the reaction container in order to be subjected to the following reaction step in the sense of a “one-pot-reaction”.

If a distillation is carried out as part of step a), the by-product of the reaction of the compound of the general formula MX_{y}+₂ and the essentially silicon-free oxidizing agent Z can be removed. These usually are compounds like dichloro hydrocarbons, chloro hydrocarbons and/or hydrogen chloride. For example, when acetone is used as the essentially silicon-free oxidizing agent Z, the by-product which is distilled is 2,2-dichloropropane. Depending on the conditions under which the distillation is carried out, unreacted oxidizing agent Z, aprotic solvent A or both may be removed as well.

If a distillation is carried out as part of step b), the by-product of the reaction of the alcohol ROH that is different from the oxidizing agent Z may be removed and, depending on the distillation conditions, either simultaneously or sequentially with the removal of by-products of step a), optionally together with unreacted alcohol ROH, if any, unreacted oxidizing agent Z, if any, aprotic solvent A, or all of the foregoing.

In a specific embodiment, the distillation is carried out as part of step b), which might under some conditions facilitate step c).

The general formula I comprises not only monomers but also possible oligomers. For instance, [W(O)(OiPr)₄] exists as a dimer in the solid state. (W. Clegg et al., J. Chem. Soc., Dalt. Trans. 1992, 1, 1431 - 1438)

R can not only be a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, a linear, branched or cyclic alkyl group (C5 -C10) being not, partially or fully halogenated, but can also comply with the formula (R^{E}-O)n-R^{F} - both in formula (I), [M(O)(OR)_{y}], and in the applied alcohol ROH. Here n is an integer from 1 to 5, e.g. 4, particularly 1, 2 or 3.

If R corresponds to the formula (R^{E}-O)n-R^{F} several residues R^{E} can be present, provided that n is larger than 1, i.e. 2, 3, 4, or 5. The residues can be identical or different and the residues R^{E} can be selected independently from each other from the group consisting of

a linear, a branched or a cyclic alkylene group having one to six carbon atoms, in particular two to four, such as methylene (CH₂), ethylene (CH₂CH₂), propylene (CH₂CH₂CH₂), isopropylene (CH(CH₃)CH₂), n-butylene (CH₂CH₂CH₂CH₂), pentylene (CH₂CH₂CH₂CH₂CH₂), hexylene (CH₂CH₂CH₂CH₂CH₂CH₂) and a linear, a branched or a cyclic partially or fully halogenated alkyl group having one to six carbon atoms, more specifically two to four. Consequently, if n is, for instance, 2, the formula (R^{E}-O)n-R^{F} is (R^{E1}-O)-(R^{E2}-O)-R^{F}, wherein R^{E1} and R^{E2} can be identical, e.g. n-propylene, or different, e.g. R^{E1} is n-propylene and R^{E2} is n-butylene, or R^{E1} and R^{E2} are isomers, e.g. R^{E1} is n-propylene and R^{E2} is iso-propylene. It is also possible to apply several isomeric or different residues so that a mixture of different residues R^{E} and thus different residues R are present in ROH and (R^{E}-O)ⁿ-R^{F}, respectively, leading to isomer mixtures of [M(O)(OR)_{y]} (I).

If the residue R corresponds to the formula (R^{E}-O)ⁿ-R^{F}, the residues R^{F} can be selected independently from each other from the group consisting of a linear, a branched or a cyclic alkyl group having one to ten carbon atoms (C1 - C10), in particular having three to seven carbon atoms (C3 - C7), and a linear, a branched or a cyclic partially or fully halogenated alkyl group having one to ten carbon atoms (C1 -C10) or a substituted or unsubstituted aryl group (C6 - C11), such as phenyl, benzyl, toluyl, mesityl, naphthyl, in particular C6 to C8, like phenyl, toluyl, mesityl or benzyl. The residues R^{F} can also be dissimilar in the same manner as the residues R^{E} can be different and thus result in unequal residues R. If different residues R^{F} and/or R^{E} and thus mixed residues R are present, as stated above, the applied alcohols ROH are mixtures. Advantageously, particularly isomer mixtures are included, e.g. dibutylene glycol monopropyl ether being an isomer mixture of various isomers of dibutylene glycol monopropyl ether, wherein dibutylene glycol monopropyl ether is the main isomer.

In one embodiment of the herein claimed process the alcohol ROH is selected from the group consisting of methanol, ethanol, propanol, isopropanol, n-butanol, s-BuCH₂OH, i-BuCH₂OH, (iPr)(Me)CHOH, (nPr)(Me)CHOH, (Et)₂CHOH, (Et)(Me)₂COH, C₆H₁₁OH, C₆H₅CH₂OH and C₆H₅OH, and mixtures thereof. Alternatively, or as a complement, the alcohol ROH is selected from the group consisting of (2,2-Dichloro-3,3-dimethylcyclopropyl)methanol, (2,2-dichloro-1-phenylcyclopropyl)methanol, 1,1,5-trihydroperfluorpentanol, 6-chloro-1-hexanol, 6-bromo-1-hexanol, 8-chloro-1-octanol, 8-bromo-1-octanol, 10-chloro-1-decanol, 10-bromo-1-decanol, C₆H₅C(CF₃)₂OH, derivatives thereof, and mixtures thereof.

Another embodiment of the claimed process provides that the alcohol ROH is a glycol ether. The term “glycol ether” also comprises poly ethers and poly glycol ethers. In one variant of the process the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof.

More specifically, R may be an alkylene alkyl ether group (R^{E}-O)ⁿ-R^{F}, wherein R^{F} is selected from the group consisting of methyl, ethyl, propyl, isopropyl, butyl, isobutyl, tert.-butyl, sec-butyl, pentyl, sec-pentyl, 3-pentyl, 2-methylbutyl, 3-methylbutyl, 2-methylbut-2-yl, 3-methylbut-2-yl, neopentyl, hexyl, 1-hexyl, 2-hexyl,3-hexyl,2-methylpent-1-yl, 3-methylpent-1-yl, 4-methylpent-1-yl, 2-methylpent-2-yl, 3-methylpent-2-yl, 4-methylpent-2-yl, 2-methylpent-3-yl, 3-methylpent-3-yl, 2,2-dimethylbut-1-yl, 2,3-dimethylbut-1-yl, 3,3-dimethylbut-1-yl, 2,3-dimethylbut-2-yl, 3,3-dimethylbut-2-yl, 2-ethylbut-1-yl, phenyl, benzyl, toluyl, mesityl, naphthyl and combinations thereof; and R^{E} is selected from the group consisting of methylene (—CH₂—), ethylene (—CH₂CH₂—), propylene (—CH₂CH₂CH₂—), isopropylene (—CH(CH₃)CH₂—), n-butylene (—CH₂CH₂CH₂CH₂—), pentylene (—CH₂CH₂CH₂CH₂CH₂—), hexylene (—CH₂CH₂CH₂CH₂CH₂CH₂—), with n advantageously being 1, 2 or 3.

According to a further embodiment of the herein described process the glycol ether is selected from the group consisting of ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof. The indicated glycol ethers can also be used as isomer mixtures. For instance, dibutylene glycol monopropyl ether is an isomer mixture of various isomers of dibutylene glycol monopropyl ether, wherein dibutylene glycol monopropyl ether is the main isomer. Advantageously, the glycol ether is selected from the group consisting of iso-propylene glycol monobenzyl ether C₆H₅CH₂-O-CH₂-C(CH₃)-OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

The compound of the general formula MX_{y}+₂ is commercially available in a satisfactory to high quality. The formula MX_{y}+₂ also includes possibly existing solvent adducts.

A further embodiment of the claimed process provides that the essentially silicon-free oxidizing agent Z is selected from the group consisting of alcohols, ketones, ethers, and mixtures thereof. This is of major advantage as the oxidizing agent itself is comparatively eco-friendly and does not comprise any elements being critical with respect of the target compound’s purity. Particularly, the oxidizing agent is essentially silicon-free or silicon-free so that formation of silicon containing by-products is impossible. Favourably, in most cases only easily separable comparatively environmentally friendly by-products, such as HCl, MeCl, tBuCl, C(CH₃)₂Cl₂ and isobutene, are formed when applying one of the aforementioned oxidizing agents. For instance, in case of using a ketone as the oxidizing agent the only by-product is a dichloroalkane. When applying an alcohol as the oxidizing agent, hydrogen chloride and at least one halogenoalkane are formed as by-products. Moreover, a separation of by-products resulting from step a) by distillation and/or under subatmospheric pressure is not mandatory at this stage because the formed by-products do not disturb the further process. However, a separation of the by-products is possible after completion of step a) and/or after reaction step c), wherein the separation can be conducted partly and fully each. Overall, when using one of the aforementioned oxidizing agents it can be almost excluded, advantageously excluded, that the desired target compounds comprise silicon or any halogens or any compounds comprising silicon, metals other than M or a halogen.

Another embodiment of the claimed process provides that the essentially silicon-free oxidizing agent Z comprises 1 to 8 carbon atoms, e.g. 5 carbon atoms such as methyl tert-butyl ether. According to a further embodiment the essentially silicon-free oxidizing agent Z comprises 1 to 6 carbon atoms, e.g. 4 carbon atoms such as tetrahydrofuran. In another variant the essentially silicon-free oxidizing agent Z comprises 1 to 4 carbon atoms, e.g. 1, 2 or 3 carbon atoms such as methanol, ethanol or propanol.

Within the scope of the present invention the term “alcohol” refers to unsaturated and saturated aliphatic and alicyclic monoalcohols, polyols and glycol ethers. The term “polyol” means an organic compound containing at least two hydroxyl groups. Thus, “polyol” refers to a diol, usually a 1,2-diol. Examples are ethylene glycol (EG) and its derivatives. Further, the term “polyol” refers to diethylene glycol (DEG), triethylene glycol (TEG), tetraethylene glycol (TTEG) etc. up to poly(ethylene glycol) (PEG). In addition, “polyol” means isomers of propanediol, butanediol, pentanediol etc. Compounds having more than two hydroxyl groups, e.g. glycerol (GLY), pentaerythritol and carbohydrates, also fall under the definition of “polyol” within the scope of the present invention.

In one embodiment of the claimed process the essentially silicon-free oxidizing agent Z is an alcohol or a mixture of alcohols according to the general formula R^{A}OH, wherein R^{A} represents a linear, a branched or a cyclic alkyl group or an aryl group having 1 to 10 carbon atoms. Another embodiment provides that R^{A} represents a linear, a branched or a cyclic alkyl group or an aryl group having 1 to 8 carbon atoms, e.g. 5 carbon atoms. Alternatively, R^{A} represents a linear, a branched or a cyclic alkyl group or an aryl group having 1 to 6 carbon atoms, e.g. 3 carbon atoms. In a further variant R^{A} represents a linear, a branched or a cyclic alkyl group or an aryl group having 1 to 4 carbon atoms, e.g. 2 or 3 carbon atoms. For instance, R^{A}OH is selected from the group consisting of MeOH, EtOH, nPrOH, iPrOH, nBuOH, tBuOH, sBuOH, iBuOH, sBuCH₂OH, iBuCH₂OH, (iPr)(Me)CHOH, (nPr)(Me)CHOH, (Et)₂CHOH, (Et)(Me)₂COH, C₆H₅CH₂OH, C₆H₅OH, 2-fluoroethanol, 2,2-dichloro-2-fluoroethanol, 2-chloroethanol, 2-bromoethanol, 2,2-dibromoethanol, 2,2,2-tribromoethanol, hexafluoroisopropanol, (2,2-dichlorocyclopropyl)methanol and (2,2-dichloro-1-phenylcyclopropyl)methanol, and mixtures thereof.

It is important to note that the oxidizing agent Z, if it is an alcohol, must be different from the alcohol ROH to make sure that by-products differ from the final products and can be more easily separated from each other. Suitable alcohols to be used as oxidizing agent Z are alcohols with one to eight carbon atoms (C1-C8), in particular one to six carbon atoms (C1-C6), such as methanol, ethanol, n-propanol, iso-propanol, n-butanol, sec-butanol, iso-butanol, tert-butanol, 1-heptanol, 2-heptanol, 3-heptanol, 4-heptanol, hexan-1-ol.

In a further embodiment of the claimed process the essentially silicon-free oxidizing agent Z is a glycol ether or a mixture of two or more glycol ethers, each glycol ether comprising 3 to 6 carbon atoms. In a variant each glycol ether comprises 4 to 6 carbon atoms, e.g. 5 carbon atoms. According to another embodiment each glycol ether comprises 3 or 4 carbon atoms. For instance, the glycol ether is selected from the group consisting of ethylene glycol dimethyl ether, ethylene glycol diethyl ether, propylene glycol methyl ether, ethylene glycol monobutyl ether, and mixtures thereof.

In another embodiment of the herein described process the essentially silicon-free oxidizing agent Z is a ketone or a mixture of ketones according to the general formula R^{K}(CO)R^{L}, wherein R^{K} and R^{L} represent independently from each other a linear, a branched or a cyclic alkyl group or an aryl group having 1 to 8 carbon atoms, e.g. 6 carbon atoms. In a variant wherein R^{K} and R^{L} represent independently from each other a linear, a branched or a cyclic alkyl group or an aryl group having 1 to 6 carbon atoms, e.g. 4 carbon atoms. Another embodiment provides that R^{K} and R^{L} represent independently from each other a linear, a branched or a cyclic alkyl group or an aryl group having 1 to 4 carbon atoms, e.g. 2 carbon atoms. In a further embodiment R^{K} and R^{L} represent independently from each other a linear, a branched or a cyclic alkyl group or an aryl group having 1 or 2 carbon atoms. For example, R^{K}(CO)R^{L} is selected from the group consisting of dimethyl ketone, methyl ethyl ketone, methyl-n-propyl ketone, methyl isopropyl ketone, methyl-n-butyl ketone, methyl isobutyl ketone, methyl-sec-butyl ketone, methyl tert-butyl ketone, methyl n-pentyl ketone, methyl octyl ketone, diethyl ketone, ethyl-n-propyl ketone, ethyl isopropyl ketone, ethyl-n-butyl ketone, ethyl isobutyl ketone, ethyl-sec-butyl ketone, ethyl tert-butyl ketone, ethyl n-pentyl ketone, diisopropyl ketone, di-n-propyl ketone, di-n-butyl ketone, diisobutyl ketone, n-methyl-2-pyrrolidone, cyclohexanone, acetophenone, and mixtures thereof. Ketones do also encompass compounds with more than one keto group, such as, for example, diones, like acetylacetone, cyclohexadione or quinone.

A further embodiment of the claimed process provides that the essentially silicon-free oxidizing agent Z is an ether or a mixture of ethers according to the general formula R^{G}-O-R^{H}, wherein R^{G} and R^{H} represent independently from each other a linear, a branched or a cyclic alkyl group or an aryl group having 1 to 9 carbon atoms, e.g. R^{H} = 1 and R^{G} = 4 carbon atoms, and wherein R^{G} and R^{H} can optionally form a ring, e.g. as in the case of tetrahydrofuran. According to another embodiment R^{G} and R^{H} represent independently from each other a linear, a branched or a cyclic alkyl group or an aryl group having 1 to 7 carbon atoms, e.g. R^{H} = 2 and R^{G} = 3 carbon atoms, and wherein R^{G} and R^{H} can optionally form a ring, e.g. as in the case of tetrahydrofuran. Alternatively, R^{G} and R^{H} represent independently from each other a linear, a branched or a cyclic alkyl group or an aryl group having 1 to 5 carbon atoms, e.g. R^{H} = 1 and R^{G} = 3 carbon atoms, and wherein R^{G} and R^{H} can optionally form a ring, e.g. as in the case of tetrahydrofuran. According to another embodiment R^{G} and R^{H} represent independently from each other a linear, a branched or a cyclic alkyl group or an aryl group having 1 to 3 carbon atoms, e.g. R^{H} = 1 and R^{G} = 2, and wherein R^{G} and R^{H} can optionally form a ring. For example, R^{G}-O-R^{H} is selected from the group consisting of dimethyl ether, diethyl ether, ethyl methyl ether, methyl-n-propyl ether, methyl isopropyl ether, ethyl-n-propyl ether, ethyl isopropyl ether, di-n-propyl ether, diisopropyl ether, dibutyl ether, methyl tert-butyl ether (MTBE), ethyl tert-butyl ether (ETBE), tert-amyl methyl ether (TAME), 1,4-dioxane, tetrahydrofuran, and mixtures thereof.

The essentially silicon-free oxidizing agent Z is selected from the group consisting of alcohols, ketones, ethers and mixtures thereof. Consequently, different alcohols, ketones or ethers can be employed both as pure compounds or either with different oxidizing agents of the same class, such as different alcohols, like a mixture of methanol and ethanol, different ketones, such as a mixture of acetone with methyl ethyl ketone or a mixture of different ethers, such as a mixture of diethyl ether and tetrahydrofuran. Mixtures between different types of oxidizing agents are also possible, such as mixtures of e.g. alcohols with ketones, ketones with ethers or alcohols with ethers or mixtures of alcohols, ethers and ketones. Possible Examples may be mixtures of ethanol and acetone, mixtures of acetone and tetrahydrofuran, mixtures of methanol with diethyl ether or mixtures of ethanol with tetrahydrofuran and acetone.

According to another embodiment of the claimed process the molar ratio of MX_{y}+₂ to the essentially silicon-free oxidizing agent Z is in the range of 1 : 0.75 to 1 : 2.50. For instance, when applying a molar ratio of one mole equivalent WCl₆ and 2.00 mole equivalents acetone the solvent adduct [W(O)Cl₄(acetone)] is obtained. However, during the further reaction step this compound reacts in a similar way as WOCl₄. In another embodiment the molar ratio of MX_{y}+₂ to the essentially silicon-free oxidizing agent Z is in the range of 1 : 0.80 to 1 : 1.50. A further embodiment provides that the molar ratio of MX_{y}+₂ to the essentially silicon-free oxidizing agent Z is in the range of 1 : 0.85 to 1 : 1.30. Usually the oxidizing agent is applied in a stoichiometric amount or with a slight excess such as 1 : 1.15, i.e. an essentially stochiometric amount, which is particularly cost-efficient and ecologically advantageous. However, if an excess of the essentially silicon-free oxidizing agent is applied, excess oxidizing agent can be relatively easily removed, either after completion of step a) or before and/or during the isolation of the respective target compound. This applies in particular to oxidizing agents having comparatively few carbon atoms, particularly one, two, three, four or five carbon atoms, such as methanol, ethanol, tert-butanol, acetone, methyl tert-butyl ether and tetrahydrofuran. Whereas in step a) the use of comparatively short-chain and thus low-boiling alcohols having one, two, three or four carbon atoms is of advantage the alcohol ROH applied in step b) has five, six, seven, eight, nine or ten carbon atoms.

The term “solvent” refers to a single solvent or a solvent mixture.

“Supply of at least one essentially silicon (Si) free base” according to step c) includes the options of adding the essentially silicon-free base by introducing a gas or a liquid or a solid, each being or comprising the at least one essentially silicon-free base, by introducing a solution comprising the at least one essentially silicon-free base or by pressurisation of the respective essentially silicon-free base in a pressure vessel.

The completeness of the reaction and the end of the reaction of step c), respectively, can be determined, for instance, by the fact that ammonia gas passed into the reactor is no longer consumed in the reaction mixture, but only passing through the reaction mixture. Alternatively, or as a complement, it is observed that the temperature of the reaction mixture decreases and the exothermicity decays. For this purpose, a bubble counter, a pressure relief valve and/or a pressure sensor, a mass flowmeter or a flowmeter, a temperature sensor and a temperature switch, respectively, can be used, for example. In case the completeness of the reaction is only determined after a certain time lag excess ammonia gas can be removed from the reaction mixture by creating subatmospheric pressure or vacuum within the reactor. A similar approach can be applied if ammonia and/or an amine is passed into the reactor in the form of gas under pressure or added to the reaction mixture in the liquid state or as a solution.

The term “reactor” is not limited to any capacity, material, feature or form of the reaction vessel. Suitable reactors are, for instance, stirring tank reactors, stirring pressure reaction vessel, tubular reactors, microreactors, and flow-through reactors.

The oxyalkoxide complexes of the type [M(O)(OR)_{y}] (I) prepared by the herein described process have been shown — according to NMR and elemental analyses — to contain neither amine nor ammonia after their isolation. However, the isolated compounds might comprise amine and/or ammonia in an amount around or below the detection limit. In this case they are referred to as “essentially ammonia-free”. It can therefore be deduced that an ammonia adduct of the respective target compound is — if at all — only present in solution. Introducing ammonia into the reaction mixture over a too long period after completion of the reaction is unfavourable, both under ecological and under economical aspects.

It has also been proven — by elemental analyses and trace metals analyses by ICP-OES — that compounds of the general formula [M(O)(OR)_{y}] (I) prepared by the claimed process are essentially silicon-free, and essentially free of alkali metals. Consequently, they comprise a silicon content of 1000 ppm (thousand) or less, favourably of 500 ppm (five hundred) or less, in particular 70 ppm (seventy) ppm or less, more specifically 50 (fifty) ppm or less; or 10 ppm (ten) or less, particularly of 1.500 ppb (fifteen hundred) or less, determined by inductively coupled plasma optical emission spectrometry (ICP-OES).

The compounds of the general formula [M(O)(OR)_{y}] (I) prepared by the claimed process comprise an alkali metal content of 1000 ppm (thousand) or less, favourably of 500 ppm (five hundred) or less, in particular 70 ppm (seventy) ppm or less, more specifically 50 (fifty) ppm or less; or 10 ppm (ten) or less, particularly of 0.20 ppm or less (with 0.20 ppm being the detection limit).

The compounds of the general formula [M(O)(OR)_{y}] (I) prepared by the claimed process comprise a halogen content, in particular a chlorine content, of below 1000 (thousand) ppm, or below 500 ppm (five hundred) or below 250 ppm (two hundred and fifty).

The herein claimed process is conducted as a one-pot synthesis comprising only three steps and yielding essentially silicon-free compounds of the general formula [M(O)(OR)_{y}] (I), in particular [W(O)(OR)₄]. The starting materials, including MX_{y+2}, particularly WCl₆, WCl₅ or MoCl₅, are commercially available and inexpensive. For instance, the hydrolysis-sensitive tungsten(VI) compound WOCl₄ is synthesized according to step a) by reacting WCl₆ with an essentially silicon-free oxidizing agent, favourably methanol, tert-butanol, acetone, butanone, methyl tert-butyl ether, ethyl tert-butyl ether, diisopropyl ether, tert-amyl methyl ether or tetrahydrofuran, in an aprotic solvent or a solvent mixture, favourably in an aliphatic or an aromatic hydrocarbon being not halogenated, partly or fully halogenated, or a mixture thereof. Advantageously, the intermediate product of step a) is not isolated. This is particularly beneficial as the complex isolation and sublimative purification of WOCl₄ being only the intermediate product in this case is unnecessary. Moreover, a separation by distillation and/or creating subatmospheric pressure or vacuum of comparatively environmentally friendly by-products resulting from step a), e.g. HCl, MeCl, tBuCl, C(CH₃)₂Cl₂ and isobutene, is not mandatory at this stage, but possible, wherein the separation can be conducted partly and fully. A further advantage is that the oxidizing agent is essentially silicon-free or silicon-free so that formation of silicon containing by-products is impossible. Usually the oxidizing agent is applied in a stoichiometric or a slight excess or shortage, i.e. an essentially stochiometric amount, which is particularly cost-efficient and ecologically advantageous. However, if an excess of the essentially silicon-free oxidizing agent is applied, excess oxidizing agent can be relatively easily removed, either after completion of step a) or before and/or during the isolation of the respective target compound. Particularly, this applies to oxidizing agents having comparatively few carbon atoms, particularly one, two, three, four or five carbon atoms, such as tert-butanol, acetone, methyl tert-butyl ether and tetrahydrofuran. According to step b) the respective metal oxyalkoxide complex is obtained by addition of at least four mole equivalents of the alcohol ROH - with regard to MX_{y+2}, e.g. WCl₆ -, whereby only four mole equivalents are required for the preparation of compounds of the general formula [M(O)(OR)_{y]} (I), e.g. [W(O)(OR)₄]. Favourably, the reaction according to step b) is not disturbed by a competitive reaction of the by-products from step a) in which the alcohol ROH also takes part. In general, four to six or four to five equivalents of the alcohol are sufficient. In case the oxidizing agent of step a) is an alcohol it differs from the alcohol ROH of step b). Whereas in step a) the use of comparatively short-chain and thus low-boiling alcohols having one, two, three or four carbon atoms is of advantage — as explained above — the alcohol ROH applied in step b) has five, six, seven, eight, nine or ten carbon atoms. As the alcohol ROH is — in most cases — applied in a stoichiometric amount or in a slight excess, i.e. an essentially stoichiometric amount, and thus fully consumed during the formation of the respective target compound higher-boiling alcohols ROH are applicable in step b). By supply of an essentially silicon-free base according to step c), e.g. ammonia and/or at least one amine, favourably ammonia gas or an ammonia solution or a liquid amine, the hydrogen chloride formed in step a) and/or step b) is trapped and consumed, respectively, by formation of NH₄Cl, for example. Consequently, the chemical equilibrium of the reaction is shifted to the desired product [M(O)(OR)_{y}] (I). After conducting the steps a) to c) of the claimed process only the desired essentially silicon-free oxyalkoxides of the type [M(O)(OR)_{y}] (I), solvents, where appropriate, and the defined, easily separable by-product of the reaction of an amine and/or ammonia, e.g. NH₄Cl, are present. These impurities can generally be present in amounts of less than two weight percent (< 2 wt.-%), less than one weight percent (< 1 wt.-%) and particularly less than one half of one weight percent (< 0.5 wt.-%). One reason for the fact that the by-product is easily separable, e.g. by filtration or centrifugation and/or decantation, is the choice of an aprotic solvent such as hydrocarbons or chlorinated hydrocarbons like benzene, petrol ether 40-60, hexane, heptane, octane or other alkanes, dichloromethane and chloroform as a solvent will usually lead to quantitative precipitation of NH₄Cl while the product, e.g. [Mo(O)(OR)₃] or [W(O)(OR)₄] will remain in solution. As a result, contamination of the respective oxyalkoxide by the formed NH₄Cl freight is significantly reduced. Another advantage of the claimed process is that no undefinable by-products such as lithium tungstate complex salts are formed, which are — if at all — very different to separate. The respective target compound being in solution can be reacted directly with one or more reactants. Alternatively, the compound of the type [M(O)(OR)₄] or [M(O)(OR)_{y}] can be isolated by a straightforward filtration using, where appropriate, a filter auxiliary such as charcoal, perlite, montmorillonite or an alumosilicate, followed by removal of all volatile components such as solvents. A major benefit of the claimed process is that NH₄Cl is almost quantitatively, preferably quantitatively, separable in a straightforward manner by a filtration step. Another major advantage is that the isolated compound contains neither ammonia nor contaminations by silicon or alkali metals or silicon or alkali metals comprising compounds. In general, the final product can comprise solvent residues or the defined, easily separable by-product of the reaction of amine or ammonia such as NH₄Cl. Consequently, the final product has a purity of at least 95%, favourably of more than 95%, particularly of more than 98% or 99%. Thus, after isolation the target compound can be applied and/or stored without further purification. The reproducible yield is, depending on the chosen alcohol and the solvent or solvent mixture, even in case of an upscaling towards industrial scale, usually > 80% or > 90%.

Overall, the drawbacks of the state of the art are overcome by the claimed process. Thereby, in particular considerably less contaminations by challengingly separable salt freights, such as LiCl in tetrahydrofuran or NH₄Cl in an alcohol, are formed and/or present. The herein described process is particularly versatile, straight-forward and cost-efficient as it is conducted as a one-pot synthesis. Moreover, only few reaction steps are required, all of them being relatively simple to accomplish and easily scalable, particularly for industrial production. Thereby commercially available and cost-efficient starting materials are applied. Exclusively definable, easily and well separable by-products are formed, being almost quantitatively, favourably quantitatively, separable. In particular, formation of non-separable lithium tungstate complexes, e.g. Li[W(O)(OR)₅], is excluded. Therefore, the desired oxyalkoxide is - without further distillative and/or sublimative purification -obtained reproducibly in an improved high purity. Particularly, the oxyalkoxides obtained by this process comply with the highly-demanding purity specifications required for applications relating to the deposition of compounds, semiconductor, photovoltaic or catalytic applications. The yields and purities are good to very good and reproducible in large scale and the process allows easy upscaling. The claimed process is time-efficient, comparatively environmentally friendly, energy and cost saving. In comparison it can be classified as more efficient.

When using one of the above-mentioned alcohols and oxidizing agents, respectively, the compounds of the type [M(O)(OR)₄] or [M(O)(OR)₃] are obtained in a straightforward and reproducible manner in high purity, i.e. essentially ammonia-free, free of alkali metals, halogen-free and silicon-free, favourably ammonia-free, free of alkali metals, halogen-free and silicon-free, and in good to very good yields by the herein claimed process.

In another embodiment of the claimed it is provided that MX_{y}+₂ is applied as a solid, a saturated solution in the aprotic solvent A, a suspension in the aprotic solvent A or as a solution in the aprotic solvent A or in a solvent miscible with the solvent A. According to another embodiment of the herein described process the neat essentially silicon-free oxidizing agent Z or a solution of the essentially silicon-free oxidizing agent Z in the aprotic solvent A or in a solvent miscible with the aprotic solvent A is applied. The way of applying MX_{y}+₂ and the essentially silicon-free oxidizing agent Z can be chosen dependent on the other reaction parameters in order to have increased control over the reaction process and the exothermicity, respectively.

According to another embodiment of the process the at least one essentially silicon-free base is favourable selected from the group consisting of organic, organometallic and inorganic bases, and mixtures thereof. In a further variant the at least one essentially silicon-free base is selected from the group consisting of amines, ammonia, heterocyclic nitrogenous bases, alkali metal oxides and alkali metal amides, and mixtures thereof. In case the base is an alkali metal oxide and/or an alkali metal amide the base is favourably selected from the group consisting of lithium, sodium and potassium metal oxides and amides and more favourably selected from sodium and potassium metal oxides and amides. In a further embodiment of the claimed process the at least one essentially silicon-free base is an organic or an inorganic base. Advantageously, at least one essentially silicon-free base is selected from the group consisting of amines, ammonia and heterocyclic nitrogenous bases. If a low alkali metal content is desired, alkali metal containing silicon-free bases are to be avoided. In general, the method of the invention results in products exhibiting a low content of metallic impurities because they can be introduced only via the metallic educts used, such as the molybdenum and tungsten compounds or metal-containing, silicon-free bases such as alkali metal or earth alkaline metal oxides, hydroxides or amides, such as potassium hydroxide, sodium hydroxide, calcium hydroxide, potassium oxide, sodium oxide, calcium oxide, or similar compounds. Avoiding metal-containing bases in general will result in a low amount / low concentration of metallic impurities.

By supply and addition, respectively, of an essentially silicon-free base according to step c), e.g. ammonia and/or at least one amine, advantageously ammonia gas or an ammonia solution, e.g. a methanolic one, or a liquid amine, the hydrogen chloride formed in step a) and/or step b) is trapped and consumed, respectively, by formation of NH₄Cl, for instance. After conducting the steps a) to c) of the claimed process only the desired essentially silicon-free metal oxyalkoxides of the type [M(O)(OR)_{y}], solvents, where appropriate, and the defined, easily separable by-product of the reaction of an amine and/or ammonia, e.g. NH₄Cl, are present. These impurities can generally be present in amounts of less than two weight percent (< 2 wt.-%), less of one weight percent (< 1 wt.-%) and particularly less than one half of one weight percent (< 0.5 wt.-%). One reason for the fact that the by-product being favourably NH₄Cl is easily separable, e.g. by filtration or centrifugation and/or decantation, is the advantageous choice of an aprotic solvent. For example, application of heptane, another aliphatic solvent, such as iso-hexane or mixtures of hexane isomers, pentane, or dichloromethane particularly leads to quantitative precipitation of NH₄Cl, while the target compound, e.g. [M(O)(OR)₄] or [M(O)(OR)₃] remains in solution. Thus, advantageously a contamination of the respective oxyalkoxide by the formed NH₄Cl freight is significantly reduced. The respective target compound being in solution can be reacted directly with one or more reactants. Alternatively, the compound of the type [M(O)(OR)₄] or [M(O)(OR)₃] can be isolated by a straightforward filtration using, where appropriate, a filter auxiliary, e.g. charcoal, perlite, montmorillonite or an alumosilicate followed by removal of all volatile components such as solvents. A major benefit of the claimed process is that NH₄Cl is almost quantitatively, preferably quantitatively, separable in a straightforward manner by a filtration step. Another major advantage is that the isolated compound contains neither ammonia nor amine residues or other contaminations resulting directly or indirectly, i.e. due to side-reactions of the base, from the applied base. In general, the final product can comprise solvent residues or the defined, easily separable by-product of the reaction of amine or ammonia, e.g. NH₄Cl. Consequently, the final product has a purity of at least 95%, favourably of more than 95%, particularly of more than 98% or 99%. Thus, after isolation the target compound can be applied and/or stored without further purification. The reproducible yield is, depending on the chosen alcohol and the solvent or solvent mixture, even in case of an upscaling towards industrial scale, usually > 80% or > 90%.

For example, a large variety of amines is applicable, also as a mixture. The amine can be selected from the group consisting of primary, secondary and tertiary amines and may be alkyl amines, aryl amines or combinations thereof. Alkyl amines can be advantageously used, e.g. methyl amine, ethyl amine, propyl amine, isopropyl amine, butyl amine, tert-butyl amine, cyclohexyl amine, dimethyl amine, diethyl amine, dipropyl amine, diisopropyl amine, dibutyl amine, di-tert-butyl amine, dicyclohexyl amine, trimethyl amine, triethyl amine, tripropyl amine, triisopropyl amine, tributyl amine, tri-tert-butyl amine, tricyclohexyl amine, and derivatives and mixtures thereof. Mixed substituted amines and mixtures thereof are also conceivable, e.g. diisopropyl ethyl amine (DIPEA). In addition, acetamidine, ethylene diamine, triethylene tetramine, N, N, N, N-tetramethylethylene diamine (TMEDA), guanidine, urea, thiourea, imines, aniline, pyridine, imidazole, dimethylaminopyridine, pyrrole, morpholine, quinoline and mixtures thereof are applicable.

Ammonia is advantageously applicable as the gas itself or as an ammonia solution. In one embodiment of the herein described process the ammonia solution comprises at least one aprotic organic solvent B and/or at least one alcohol R^{B}OH, wherein
R^{B} is selected from the group consisting of a linear, branched or cyclic alkyl group (C1 - C10), a linear, branched or cyclic partially or fully halogenated alkyl group (C1
C10), an alkylene alkyl ether group (R^{K}-O)ₙ-R^{L}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{K} are independently from each other selected from the group consisting of a linear, a branched or a cyclic alkyl group (C1 - C6) and a linear, a branched or a cyclic partially or fully halogenated alkyl group (C1 - C6),
   R^{L} are independently from each other selected from the group consisting of a linear, a branched or a cyclic alkyl group (C1 - C10) and a linear, a branched or a cyclic partially or fully halogenated alkyl group (C1 - C10) and
R^{B}OH differs from the oxidizing agent Z.

In a further embodiment the aprotic organic solvent B is selected from the group hydrocarbons, halogenated hydrocarbons, ether, benzene, benzene derivatives, and mixtures thereof.

According to another embodiment the alcohol R^{B}OH is selected from the group consisting of sBuCH₂OH, iBuCH₂OH, (iPr)(Me)CHOH, (nPr)(Me)CHOH, (Et)₂CHOH, (Et)(Me)₂COH, C₆H₁₁OH, C₆H₅CH20H and C₆H₅OH, and mixtures thereof. In an alternative embodiment of the claimed process the R^{B}OH is selected from the group consisting of (2,2-Dichloro-3,3-dimethylcyclopropyl)methanol, (2,2-dichloro-1-phenylcyclopropyl)methanol, 1,1,5-trihydroperfluorpentanol, 6-chloro-1-hexanol, 6-bromo-1-hexanol, 8-chloro-1-octanol, 8-bromo-1-octanol, 10-chloro-1-decanol, 10-bromo-1-decanol, C₆H₅C(CF₃)₂OH, derivatives thereof, and mixtures thereof. Another embodiment provides that the alcohol R^{B}OH is a glycol ether. For instance, the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof. Examples of a glycol ether are ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂-O-CH₂CH(CH₃)OCH₂CH(CH₃)OH, iso-propylene glycol monobenzyl ether C₆H₅CH₂-O-CH₂-C(CH₃)-OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

Advantageously, the alcohol R^{B}OH is selected from the group consisting of dibutylene glycol monopropyl ether, iso-propylene glycol monobenzyl ether C₆H₅CH₂-O-CH₂-C(CH₃)-OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

In another embodiment the alcohol R^{B}OH is advantageously identical to the alcohol ROH from step b) of the claimed process. In this case, the number of reagents and solvents is reduced, which leads to a further simplification of the herein claimed process and thus to an improvement under economic and ecological aspects. In general, a solution of ammonia gas in another protic or aprotic solvent is applicable, including, but not limited to, one of the following ammonia solutions can be applied: 7N in methanol, 0.4 M in dioxane, 2.0 M in ethanol, 4 M in methanol or 0.4 M in tetrahydrofuran. Advantageously, a methanolic ammonia solution can be used, wherein the solution comprises 20 weight percent ammonia gas.

One or more heterocyclic nitrogenous essentially silicon-free base can be selected from the group consisting of urotropin, morpholine, N-methyl morpholine, 1,8-diazabicyclo[5.4.0]undec-7-en (DBU), 1,4-diazabicyclo[2.2.2]octane (DABCO®), pyridine, pyrazine, pyrazole, pyrimidine, pyridazine, triazine, triazole, oxazole, thiazole, purine, pteridine, quinoline, quinolinone, imidazole, quinazoline, quinoxaline, acridine, phenazine, cinnoline, 8-Methyl-8-azabicyclo[3.2.1]octane, derivatives, isomers and derivates thereof, and mixtures thereof.

The pressure during the reaction can be varied and may be at ambient pressure or above, as required. More specifically, the pressure p_{R} during the reaction can be in the range of 1013.25 hectopascal (hPa) to 6000 hectopascal (hPa), for example in the range of 1500 hectopascal (hPa) to 4500 hectopascal (hPa) or 1500 hectopascal (hPa) to 3000 hectopascal (hPa).

According to the present invention the term “pressure p_{R}” refers to the internal pressure of the respective reactor. The term “reactor” is defined as above.

According to a further variant of the claimed process the aprotic solvent A is selected from the group consisting of linear or cyclic, saturated or unsaturated, aliphatic or aromatic hydrocarbons, partly or fully halogenated linear or cyclic, saturated or unsaturated, aliphatic or aromatic hydrocarbons, ether, benzene and benzene derivatives, and mixtures thereof. In another embodiment of the process, the aprotic solvent A is favourably selected from the group consisting of aliphatic hydrocarbons, halogenated aliphatic hydrocarbons, and benzene derivates, and mixtures thereof, such as benzene, petrol ether 40-60, hexane, heptane, octane or other alkanes, dichloromethane and chloroform may be applied as the aprotic solvent A, for example.

Another embodiment of the herein described process provides that the reaction according to step a) comprises the steps of
i. providing a solution or suspension of MX_{y}+₂ in the aprotic solvent A,
ii. addition of the essentially silicon-free oxidizing agent Z, wherein during the addition and/or after the addition of the essentially silicon-free oxidizing agent Z a reaction of MX_{y}+₂ and the essentially silicon-free oxidizing agent Z occurs.

The aprotic solvent can also be a solvent mixture. In one embodiment of the process the molar ratio of MX_{y}+₂ to the essentially silicon-free oxidizing agent Z is 1 : 1.

In another variant of the process it is provided that the addition of the essentially silicon-free oxidizing agent Z in step a) ii. to the solution or suspension of MX_{y+2}, particularly WCl₆, in the aprotic solvent A is conducted by using a metering device. For example, the addition can be done drop-wise or by injection. Alternative, or as a complement, a stop valve and/or a stopcock and/or a metering pump can be provided in a supply line of the reactor. According to a further embodiment of the process a solution of the essentially silicon-free oxidizing agent Z in a solvent S is added to the solution or suspension of MX_{y}+₂ in the aprotic solvent A, the solvent S, in which the essentially silicon-free oxidizing agent Z is dissolved or suspended, being miscible with or identical to the aprotic solvent A. Dependent on the other reaction parameters this approach can be advantageous in order to have increased control over the reaction process and the exothermicity, respectively.

Dependent on the choice of the aprotic solvent or solvent mixture A and the other reaction conditions, such as the addition form of the oxidizing agent Z, i.e. as substance or dissolved in a solvent, period of the addition of the oxidizing agent Z, stirring rate, internal temperature of the reactor, the reaction of MX_{y}+₂ with the oxidizing agent Z already occurs during the addition and/or after the addition of the essentially silicon-free oxidizing agent Z.

In another embodiment of the claimed process the reaction of MX_{y}+₂ and the oxidizing agent Z is conducted at a temperature T_{R} is in the range of -100° C. to 200° C.

Within the scope of the present invention the term “temperature T_{R}” refers to the internal temperature of the respective reactor. An internal temperature of the reactor can be determined by means of at least one temperature sensor for at least one domain within the reactor. Thereby provision is made for at least one temperature sensor determining the internal temperature T_{R} which is usual identical to an average internal temperature T_{A} of the reactor.

Due to the exothermicity of the reaction it might be advantageous to keep the speed rate and/or the internal temperature during the addition of the oxidizing agent comparatively low. Alternatively, or as a complement, it can be provided that a solution of the oxidizing agent Z in an aprotic solvent or solvent mixture is added. The respective procedure has to be chosen in consideration of the other reaction parameters, such as the concentration of MX_{y}+₂ and the solvent or solvent mixture.

In another embodiment of the herein presented process the temperature T_{R} is in the range of -90° C. to 170° C. According to a further variant the temperature T_{R} is in the range of -20° C. to 140° C. A further embodiment provides that temperature T_{R} is in the range of 10° C. and 100° C. or in the range of 20° C. and 100° C. during the reaction of MX_{y}+₂ and the oxidizing agent Z.

Another embodiment of the process provides that the internal temperature T_{R} is regulated and/or controlled by means of a heat transfer medium W_{R}. For this purpose, a cryostat can be used which ideally comprises a heat transfer medium applicable for both cooling and heating. By using the heat transfer medium W_{R} deviations of the internal temperature T_{R} from a defined set point T_{S1} can be counterbalanced to the greatest extent. Realisation of a constant internal temperature T_{R} is — due to the common equipment impairments — hardly possible. However, by applying the heat transfer medium W_{R} step a) can be carried out in at least two predefined temperature ranges T_{R1} and T_{R2}. “Temperature T_{R1}” and “temperature T_{R2}”, respectively, refers to the internal temperature T_{R1} and T_{R2}, respectively, of the respective reactor. Provision is made for at least one temperature sensor determining the internal temperature T_{R1} and T_{R2}, respectively, which is usual identical to an average internal temperature T_{A1} and T_{A2}, respectively, of the reactor. The temperature sensor for determining the internal temperature T_{R1} and T_{R2}, respectively, may be identical to that one applied for determining the internal temperature T_{R}. It might be advantageous — dependent on the other reaction conditions - to implement a temperature program for the reaction of step a), the temperature program comprising at least two stages. Thereby a better control of the reaction process and/or the exothermicity can be achieved. For example, during a first phase of the addition of the oxidizing agent Z a comparatively lower temperature and a comparatively lower temperature range, respectively, can be chosen than in a second phase of the addition of the oxidizing agent Z. It can also be provided more than two phases of addition of the oxidizing agent Z and thus more than two preselected temperatures and temperature ranges, respectively. Dependent on the selection of the other reaction parameters, e.g. the concentration of MX_{y}+₂ and the solvent or solvent mixture, it might be advantageous to increase the temperature T_{R} during the addition of the oxidizing agent Z and/or after the addition of the oxidizing agent Z by using the heat transfer medium W_{R}. Thereby it might be ensured, where appropriate, that the reaction of MX_{y}+₂ with the oxidizing agent Z occurs entirely. A period of increasing the temperature T_{R} by applying the heat transfer medium W_{R} might be between 10 min and 6 h.

In another embodiment of the process it is provided that the addition of the alcohol ROH in step b) is conducted by using a metering device. For example, the addition can be done drop-wise or by injection. Alternative, or as a complement, a stop valve and/or a stopcock and/or a metering pump can be provided in a supply line of the reactor. According to a further embodiment of the process a solution of the alcohol ROH in a solvent M is added to the reaction mixture of step a). Thereby, the solvent M, in which the alcohol ROH is dissolved, is miscible with or identical to the aprotic solvent A of step a). Dependent on the other reaction parameters this approach can be advantageous in order to have increased control over the reaction process and the exothermicity, respectively.

In another embodiment of the process the molar ratio of MX_{y}+₂ to the alcohol ROH may be at least 1 : 3 or 1 : 4. More specifically, the molar ratio of MX_{y}+₂ to the alcohol ROH is at least 1 : 3 for y = 3 or 1 : 4 for y = 4 or ranges from 1 : 3 to 1 : 40 or from 1 : 6.1 to 1 : 40 or from 1 : 4 to 1 : 6.1. Thereby the molar ratio is chosen dependent on the respective alcohol ROH and on the respective solvent and solvent mixture.

A further variant of the claimed process provides that a temperature Tc ranges from -30° C. to 50° C. during and/or after the addition of the alcohol ROH. In another embodiment the temperature Tc ranges from -25° C. to 30° C. during and/or after the addition of the alcohol ROH. Alternatively, the temperature Tc ranges from -15° C. to 20° C. during and/or after the addition of the alcohol ROH. Provision is made for at least one temperature sensor determining the internal temperature Tc, which is usual identical to an average internal temperature T_{A3} of the reactor. The temperature sensor for determining the internal temperature Tc may be identical to that one applied for determining the internal temperature T_{R}.

Another embodiment of the process provides that the internal temperature T_{c} is regulated and/or controlled by means of a heat transfer medium W_{c}. For this purpose, a cryostat can be used which ideally comprises a heat transfer medium applicable for both cooling and heating. By using the heat transfer medium Wc deviations of the internal temperature T_{c} from a defined set point T_{S2} can be counterbalanced to the greatest extent. Realisation of a constant internal temperature T_{c} is — due to the common equipment impairments - hardly possible. However, by applying the heat transfer medium W_{c}, usually being identical to the heat transfer medium W_{R}, step b) can be carried out in at least two predefined temperature ranges T_{C1} and T_{C2}. “Temperature T_{C1}” and “temperature T_{C2}”, respectively, refers to the internal temperature T_{C1} and T_{C2}, respectively, of the respective reactor. Provision is made for at least one temperature sensor determining the internal temperature T_{C1} and T_{C2}, respectively, which is usual identical to an average internal temperature T_{A4} and T_{A5}, respectively, of the reactor. The temperature sensor for determining the internal temperature T_{C1} and T_{C2}, respectively, may be identical to that one applied for determining the internal temperature T_{R}. It might be advantageous — dependent on the other reaction conditions — to implement a temperature program for the reaction of step b), the temperature program comprising at least two stages. Thereby a better control of the reaction process and/or the exothermicity can be achieved.

According to another embodiment of the process a temperature T_{N} ranges from -30° C. to 100° C. during and/or after of the supply of the at least one silicon (Si) free base, favourably ammonia gas. In a further variant the temperature T_{N} ranges from -25° C. to 80° C. during and/or after of the supply of the at least one silicon (Si) free base, favourably ammonia gas. Another embodiment of the process provides that the temperature T_{N} ranges from -20° C. to 60° C. during and/or after of the supply of the at least one silicon (Si) free base, favourably ammonia gas or an ammonia solution, e.g. a methanolic one. In this step c) ammonia and/or a base is introduced into the reaction mixture, which can be done by introducing a gas or a liquid being or comprising the at least one essentially silicon-free base, by introducing a solution comprising the at least one essentially silicon-free base or by pressurisation of the respective essentially silicon-free base. In case of pressurisation a pressure in the range of 1013.25 hectopascal (hPa) to 6000 hectopascal (hPa), for example in the range of 1100 hectopascal (hPa) to 4500 hectopascal (hPa) or 1500 hectopascal (hPa) to 3000 hectopascal (hPa). Provision is made for at least one temperature sensor determining the internal temperature T_{N}, which is usual identical to an average internal temperature T_{A6} of the reactor. The temperature sensor for determining the internal temperature T_{N} may be identical to that one applied for determining the internal temperature T_{R} and/or T_{C}.

Another embodiment of the process provides that the internal temperature T_{N} is regulated and/or controlled by means of a heat transfer medium W_{N}. For this purpose, a cryostat can be used which ideally comprises a heat transfer medium applicable for both cooling and heating. By using the heat transfer medium W_{N} deviations of the internal temperature T_{R} from a defined set point T_{S3} can be counterbalanced to the greatest extent. Realisation of a constant internal temperature T_{N} is — due to the common equipment impairments - hardly possible. However, by applying the heat transfer medium W_{N}, usually being identical to the heat transfer medium W_{R} and Wc, respectively, step c) can be carried out in at least two predefined temperature ranges T_{N1} and T_{N2}. “Temperature T_{N1}” and “temperature T_{N2}”, respectively, refers to the internal temperature T_{N1} and T_{N2}, respectively, of the respective reactor. Provision is made for at least one temperature sensor determining the internal temperature T_{N1} and T_{N2}, respectively, which is usual identical to an average internal temperature T_{A7} and T_{A3}, respectively, of the reactor. The temperature sensor for determining the internal temperature T_{N1} and T_{N2}, respectively, may be identical to that one applied for determining the internal temperature T_{R} and/or Tc.

According to another embodiment of the claimed process
a temperature T_{N1} ranges from -30° C. to 20° C. during a first phase of the supply of the at least one silicon (Si) free base, and
a temperature T_{N2} ranges from 21° C. to 100° C. during and/or after a second phase of the supply of the at least one silicon (Si) free base,
wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution, is introduced into the reactor. Alternatively, or as a complement, an amine is introduced into the reactor. In another alternative the temperature T_{N2} ranges from 22° C. to 80° C. during and/or after a second phase of the supply of the at least one silicon (Si) free base, wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution is introduced into the reactor. Alternatively, or as a complement, an amine is introduced into the reactor. A further embodiment provides that the temperature T_{N2} ranges from 23° C. to 60° C. during and/or after a second phase of the supply of the at least one silicon (Si) free base wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution is introduced into the reactor. Alternatively, or as a complement, an amine is introduced into the reactor.

By such a temperature program for the supply and the introduction, respectively, or the pressurisation of amine or ammonia, in particular of ammonia gas, an even better control of the reaction process and/or the exothermicity can be achieved.

The period of the supply and the introduction, respectively, or the pressurisation of amine or ammonia, in particular of ammonia gas, as well as the temperature T_{N} or T_{N1} and T_{N2} are dependent on, amongst other reaction parameters, the batch size, the choice of the alcohol ROH and the selection of the solvent or solvent mixture.

If the first and the second phase of the supply and the introduction, respectively, or the pressurisation of amine or ammonia, in particular of ammonia gas, the first and the second phase can be different from each other, particularly with regard to their duration.

For instance, the first phase can comprise a longer period of time at a comparatively lower temperature T_{N1} than the second phase at the comparatively higher temperature T_{N2}. For example, the first phase of the supply and the introduction, respectively, or the pressurisation of amine or ammonia, in particular of ammonia gas, might comprise one hour, wherein T_{N1} < 20° C., and the second phase of the supply and the introduction, respectively, or the pressurisation of amine or ammonia, in particular of ammonia gas, might comprise 30 min, wherein T_{N2} ≥ 21° C. Dependent on the choice of the reactant ROH and the selection of the solvent this procedure might be favourable in order to achieve a quantitative trapping and consumption, respectively, of the released hydrogen chloride by formation of NH₄Cl, for example. According to another embodiment of the process the first phase and the second phase of the supply and the introduction, respectively, or the pressurisation of amine or ammonia, in particular of ammonia gas, comprise identical periods of time. As a result, the procedure is comparatively simpler.

In another embodiment of the process it is provided that after step a) a reaction step is conducted comprising a removal of volatile by-products and/or solvent. In one embodiment of the claimed process this reaction step is carried out before conducting step b) and/or after conducting step c). The separation of the volatile by-products and/or solvent and solvent mixture, respectively, is simply conducted by evaporation, e.g. under reduced pressure and below the boiling point of the by-products, or by distillation.

A further variant of the claimed process provides that after step c) a reaction step d) is conducted comprising an isolation of the compound of the general formula [M(O)(OR)_{y}] (I). The isolation of the target compound according to step d) can comprise further reaction steps, e.g. a concentration of the reaction mixture, i.e. a reduction of the solvent volume, for instance by bulb-to-bulb, evaporation or distillation, an addition of a solvent and/or a solvent exchange to achieve a crystallization or precipitation of the product and/or to remove impurities or starting materials from the reaction mixture, a solid/liquid separation by decantation or filtration, purification and drying of the product, a recrystallization, distillation and/or a sublimation. If the target compound being in solution shall not be a reactant in a secondary reaction immediately following the preparation of the target compound but shall be isolated and stored and/or further used, the separation might comprise one or more steps.

In another embodiment the isolation of the target compound comprises the removal of by-products formed during the claimed process. In doing so primarily the hydrogen chloride having been trapped and consumed, respectively, by reaction with amine or ammonia can be separated as precipitated ammonium chloride and ammonium salt, i.e. the chloride of the applied amine, e.g. diethyl ammonium chloride, respectively. Principally, this can be done by all appropriate methods.

For instance, filtration is suitable, wherein the filter cake can advantageously be washed off with the applied solvent. Similarly, the precipitated by-products can be sedimented or centrifugated and the solution of the product [M(O)(OR)_{y}] can be separated by decantation.

In one embodiment separation is done by filtration, in a second step remained insoluble by-products are separated by centrifugation of the filtrate and subsequent decantation.

In one variant of the process the isolation comprises a filtration step. Thereby several filtration steps can be provided, also, where appropriate, one or more filtrations over a cleaning agent, such as activated carbon or silica, charcoal, perlite, montmorillonite or an alumosilicate so that soluble and fines can also be separated.

The filter cake, which can also comprise the NH₄Cl freight, for example, can be washed with a small amount of a highly volatile solvent, such as dichloromethane, in order to extract product possibly contained in the NH₄Cl freight. In a specific embodiment it is washed with the solvent applied as the reaction medium.

According to another variant of the herein claimed process for preparing essentially silicon (Si) free compounds of the general formula [M(O)(OR)_{y}] (I) the reaction mixture of steps b) and c) and the isolated compounds contain 1000 ppm (thousand) or less, favourably of 500 ppm (five hundred) or less, in particular 70 ppm (seventy) ppm or less, more specifically 50 (fifty) ppm or less; or favourably 10 ppm (ten) or less, particularly 1.500 ppb (fifteen hundred) or less, silicon each, wherein the silicon content is determined by inductively coupled plasma optical emission spectrometry.

Furthermore, the problem is solved by essentially silicon (Si) free compounds of the general formula

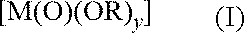

wherein
M = Mo and y = 3 or M = W and y = 3 or 4 and
R is selected from the group consisting of a linear, branched or cyclic alkyl group (C5 C10), a linear, branched or cyclic partially or fully halogenated alkyl group (C5 -C10), an alkylene alkyl ether group (R^{E}-O)ₙ-R_{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{E} are independently from each other selected from the group consisting of a linear, a branched or a cyclic alkyl group (C1 - C6) and a linear, a branched or a cyclic partially or fully halogenated alkyl group (C1 - C6),
   R^{F} are independently from each other selected from the group consisting of a linear, a branched or a cyclic alkyl group (C1 - C10) and a linear, a branched or a cyclic partially or fully halogenated alkyl group (C1 - C10), and
   n = 1 to 5 or 1, 2 or 3,
obtained according to any embodiment of the above described process for preparing an essentially silicon (Si) free compound of the general formula [M(O)(OR)_{y}] (I).

Advantageously, oxyalkoxides of the type [M(O)(OR)_{y}] (I) are particularly straightforward producible in a one-pot synthesis. The oxyalkoxides are reproducibly prepared in high purity, i.e. essentially ammonia-free, free of alkali metals, halogen-free and silicon-free, favourably ammonia-free, free of alkali metals, halogen-free and silicon-free, without further distillative and/or sublimative purification. In particular, the oxyalkoxides obtained according to any embodiment of the above claimed process comply with the highly-demanding purity specifications required for applications relating to the deposition of compounds, semiconductor, photovoltaic or catalytic applications. The yields are good to very good and reproducible. Additionally, the process can also be conducted in industrial scale, wherein the target compounds are obtained in comparable yields and purities.

The terms “essentially ammonia-free”, “essentially free of alkali metals” and “essentially halogen-free and silicon-free” are defined as above.

Particularly, without complex purification the isolated target compounds have a purity being at least as high as that of compounds of the type [M(O)(OR)_{y}], particularly [Mo(O)(OR)₄] or [W(O)(OR)₄], which have been synthesised according to methods from the state of the art and purified — as is customary in literature - by fractionating distillation and/or sublimation. For instance, this can be seen from the nuclear magnetic resonance spectra, elemental analyses as well as trace metal analysis. A major advantage is that the isolated compound contains neither ammonia nor contaminations by silicon or alkali metals or silicon or alkali metals comprising compounds. In general, the final product can comprise solvent residues or the defined, easily separable by-product of the reaction of amine or ammonia such as NH₄Cl. Impurities by solvents and the defined, easily separable by-product of the reaction of an amine and/or ammonia, e.g. NH₄Cl, can generally be present in amounts of less than two weight percent (< 2 wt.-%), less than one weight percent (< 1 wt.-%) and particularly less than one half of one weight percent (< 0.5 wt.-%). Consequently, the final product has a purity of at least 95%, favourably of more than 95%, particularly of more than 98% or 99%.

In one embodiment of the essentially silicon (Si) free compounds of the general formula

[M(O)(OR)_{y}] (I), obtained by a process for preparation of oxyalkoxides according to any one of the above described embodiments, R is selected from the group consisting of CH₂sBu, CH₂iBu, CH(Me)(iPr), CH(Me)(nPr), CH(Et)₂, C(Me)₂(Et), C₆H₁₁, CH₂C₆H₅ and C₆H₅.

According to another embodiment of the essentially silicon (Si) free compounds of the general formula [M(O)(OR)_{y}] (I), obtained by a process for preparation of oxyalkoxides according to any one of the above described embodiments, R is selected from the group consisting of (2,2-Dichloro-3,3-dimethylcyclopropyl)methyl, (2,2-dichloro-1-phenylcyclopropyl)methyl, 1,1,5-trihydroperfluorpentyl, 6-chloro-1-hexanyl, 6-bromo-1-hexanyl, 8-chloro-1-octyl, 8-bromo-1-octyl, 10-chloro-1-decyl, 10-bromo-1-decyl, C₆H₅C(CF₃)₂.

In another embodiment of the essentially silicon (Si) free compounds of the general formula [M(O)(OR)_{y}] (I), obtained by a process for preparation of oxyalkoxides according to any one of the above described embodiments OR is a base corresponding to glycol ether. For instance, the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof.

According to a further embodiment of the essentially silicon (Si) free compounds of the general formula [M(O)(OR)_{y}] (I), obtained by a process for preparation of oxyalkoxides according to any one of the above described embodiments the glycol ether is selected from the group consisting of ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof. The indicated glycol ethers can also be used as isomer mixtures. For instance, dibutylene glycol monopropyl ether is an isomer mixture of various isomers of dibutylene glycol monopropyl ether, wherein dibutylene glycol monopropyl ether is the main isomer.

According to another variant of the essentially silicon (Si) free compounds of the general formula [M(O)(OR)_{y}] (I), obtained by a process for preparation of oxyalkoxides according to any one of the above described embodiments the isolated compounds contain 1000 ppm (thousand) or less, favourably of 500 ppm (five hundred) or less, in particular 70 ppm (seventy) ppm or less, more specifically 50 (fifty) ppm or less; or favourably 10 ppm (ten) or less, particularly 1.500 ppb (fifteen hundred) or less, silicon each, wherein the silicon content is determined by inductively coupled plasma optical emission spectrometry.

Several of the aforementioned compounds of the type [M(O)(OR)_{y}] (I) exhibit comparatively low melting points due to the composition of the residue R and the ligand OR, respectively. Thereby some representatives of these oxyalkoxides are liquid at or slightly above ambient temperature. These low-melting compounds of the general formula [M(O)(OR)_{y}] (I), such as [Mo(O)(OR)₃] and [W(O)(OR)₄], are particularly qualified for applications relating to the deposition of compounds, semiconductor, photovoltaic or catalytic applications.

In addition, the problem is solved by a process for preparing an essentially silicon (Si) free compound of the general formula

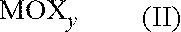

or

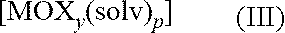

wherein
M = Mo and y = 3 or M = Wand y = 3 or 4,
X = Cl or Br,
solv = an oxidizing agent Z binding or coordinating to M via at least one donor atom and
p=1 and y = 4 or p = 2 and y = 3,
the process comprising the steps of
   a) providing a compound of the general formula MX_{y+2} and
   b) reacting MX_{y+2} with at least one essentially silicon (Si) free oxidizing agent Z comprising 1 to 10 carbon atoms at a molar ratio of MX_{y+2} to the oxidizing agent Z of at least 1 : 0.75 in at least one aprotic solvent A.

The compound of the general formula MX_{y+2}, i.e. MoCl₅, WCl₅ and WCl₆, is commercially available in a satisfactory to high quality. The formula MX_{y+2} also includes possibly existing solvent adducts.

Definitions of the terms “essentially silicon-free” and “solvent” are already given above.

Advantageously, the herein claimed process is conducted as a one-pot synthesis comprising only two steps and yielding essentially silicon-free compounds of the general MOX_{y} (II) or [MOX_{y}(solv)ₚ] (III), in particular [WOCl₄] and [WOCl₄(acetone)]. The starting materials, including MX_{y+2}, particularly WCl₆, are commercially available and inexpensive. For instance, the hydrolysis-sensitive tungsten(VI) compound WOCl₄ is synthesized according to step a) by reacting WCl₆ with an essentially silicon-free oxidizing agent, favourably methanol, tert-butanol, acetone, butanone, methyl tert-butyl ether, ethyl tert-butyl ether, diisopropyl ether, tert-amyl methyl ether or tetrahydrofuran, in an aprotic solvent or a solvent mixture, favourably in an aliphatic or an aromatic hydrocarbon being not halogenated, partly or fully halogenated, or a mixture thereof. Advantageously, after conducting steps a) and b) and isolating the target compound no further complex purification is required, particularly no complex and time-consuming sublimative purification. A major advantage is that the oxidizing agent is essentially silicon-free or silicon-free so that formation of silicon containing by-products is impossible. Usually the oxidizing agent is applied in a stoichiometric or a slight excess or shortage, i.e. an essentially stochiometric amount, which is particularly cost-efficient and ecologically advantageous. However, if an excess of the essentially silicon-free oxidizing agent is applied, excess oxidizing agent can be relatively easily removed, either after completion of step b) or before and/or during the isolation of the respective target compound. This applies in particular to oxidizing agents having comparatively few carbon atoms, particularly one, two, three, four or five carbon atoms, such as tert-butanol, acetone, methyl tert-butyl ether and tetrahydrofuran. Moreover, after completion of the reaction of MX_{y+2} and the at least one essentially silicon (Si) free oxidizing agent Z separation of by-products resulting from step b), e.g. such as HCl, MeCl, tBuCl, C(CH₃)₂Cl₂ and isobutene, and/or removal of the applied solvent or solvent mixture A can easily be conducted by distillation and/or under subatmospheric pressure or vacuum. The by-products and/or the solvent or solvent mixture A can be separated and removed, respectively, fully or only partly, where appropriate. A partial separation of the by-products and/or a partial removal of the solvent or solvent mixture might be sufficient in case of a directly following secondary reaction comprising the target compound MOX_{y} (II) or [MOX_{y}(solv)ₚ] (III) contained in the reaction mixture as a reactant and in which the by-products and/or solvent or solvent mixture A does not disturb due to any side reactions. Another advantage is that the reaction mixture comprising the compound of the general formula MOX_{y} (II) or [MOX_{y}(solv)ₚ] (III) can immediately, i.e. without time-consuming, expensive and/or complicated purification, be used as a starting material and/or a reactant in a secondary reaction. Alternatively, or as a complement, the reaction mixture comprising the compound of the general formula MOX_{y} (II) or [MOX_{y}(solv)ₚ] (III) can be stored over a period of at least one week without any altering, ageing and/or decomposition of the product.

One embodiment of the claimed process provides that the essentially silicon-free oxidizing agent Z is selected from the group consisting of alcohols, ketones, ethers, and mixtures thereof. This is of major advantage as the oxidizing agent itself is comparatively eco-friendly and does not comprise any elements being critical with respect of the target compound’s purity. Particularly, the oxidizing agent is essentially silicon-free or silicon-free so that formation of silicon containing by-products is impossible. Favourably, in most cases only easily separable and comparatively environmentally friendly by-products, such as HCl, MeCl, tBuCl, C(CH₃)₂Cl₂ and isobutene, are formed when applying one of the aforementioned oxidizing agents. For instance, in case of using a ketone as the oxidizing agent the only by-product is a dichloroalkane. When applying an alcohol as the oxidizing agent, hydrogen chloride and at least one halogenoalkane are formed as by-products.

Another embodiment of the claimed process provides that the essentially silicon-free oxidizing agent Z comprises 1 to 8 carbon atoms, e.g. 5 carbon atoms such as methyl tert-butyl ether. According to a further embodiment the essentially silicon-free oxidizing agent Z comprises 1 to 6 carbon atoms, e.g. 4 carbon atoms such as tetrahydrofuran. In another variant the essentially silicon-free oxidizing agent Z comprises 1 to 4 carbon atoms, e.g. 1, 2 or 3 carbon atoms such as methanol, ethanol or propanol.

In one embodiment of the claimed process the essentially silicon-free oxidizing agent Z is an alcohol or a mixture of alcohols according to the general formula R^{A}OH, wherein R^{A} represents a linear, a branched or a cyclic alkyl group or an aryl group having 1 to 10 carbon atoms. Another embodiment provides that R^{A} represents a linear, a branched or a cyclic alkyl group or an aryl group having 1 to 8 carbon atoms, e.g. 5 carbon atoms. Alternatively, R^{A} represents a linear, a branched or a cyclic alkyl group or an aryl group having 1 to 6 carbon atoms, e.g. 3 carbon atoms. In a further variant R^{A} represents a linear, a branched or a cyclic alkyl group or an aryl group having 1 to 4 carbon atoms, e.g. 2 or 3 carbon atoms. For instance, R^{A}OH is selected from the group consisting of MeOH, EtOH, nPrOH, iPrOH, nBuOH, tBuOH, sBuOH, iBuOH, sBuCH₂OH, iBuCH₂OH, (iPr)(Me)CHOH, (nPr)(Me)CHOH, (Et)₂CHOH, (Et)(Me)₂COH, C₆H₅CH₂OH, C₆H₅OH, 2-fluoroethanol, 2,2-dichloro-2-fluoroethanol, 2-chloroethanol, 2-bromoethanol, 2,2-dibromoethanol, 2,2,2-tribromoethanol, hexafluoroisopropanol, (2,2-dichlorocyclopropyl)methanol and (2,2-dichloro-1-phenylcyclopropyl)methanol, and mixtures thereof.

In a further embodiment of the claimed process the essentially silicon-free oxidizing agent Z is a glycol ether or a mixture of two or more glycol ethers, each glycol ether comprising 3 to 6 carbon atoms. In a variant each glycol ether comprises 4 to 6 carbon atoms, e.g. 5 carbon atoms. According to another embodiment each glycol ether comprises 3 or 4 carbon atoms. For instance, the glycol ether is selected from the group consisting of ethylene glycol dimethyl ether, ethylene glycol diethyl ether, propylene glycol methyl ether, ethylene glycol monobutyl ether, and mixtures thereof.

In another embodiment of the herein described process the essentially silicon-free oxidizing agent Z is a ketone or a mixture of ketones according to the general formula R^{K}(CO)R^{L}, wherein R^{K} and R^{L} represent independently from each other a linear, a branched or a cyclic alkyl group or an aryl group having 1 to 8 carbon atoms, e.g. 6 carbon atoms. In a variant wherein R^{K} and R^{L} represent independently from each other a linear, a branched or a cyclic alkyl group or an aryl group having 1 to 6 carbon atoms, e.g. 4 carbon atoms. Another embodiment provides that R^{K} and R^{L} represent independently from each other a linear, a branched or a cyclic alkyl group or an aryl group having 1 to 4 carbon atoms, e.g. 2 carbon atoms. In a further embodiment R^{K} and R^{L} represent independently from each other a linear, a branched or a cyclic alkyl group or an aryl group having 1 or 2 carbon atoms. For example, R^{K}(CO)R^{L} is selected from the group consisting of dimethyl ketone, methyl ethyl ketone, methyl-n-propyl ketone, methyl isopropyl ketone, methyl-n-butyl ketone, methyl isobutyl ketone, methyl-sec-butyl ketone, methyl tert-butyl ketone, methyl n-pentyl ketone, methyl octyl ketone, diethyl ketone, ethyl-n-propyl ketone, ethyl isopropyl ketone, ethyl-n-butyl ketone, ethyl isobutyl ketone, ethyl-sec-butyl ketone, ethyl tert-butyl ketone, ethyl n-pentyl ketone, diisopropyl ketone, di-n-propyl ketone, di-n-butyl ketone, diisobutyl ketone, n-methyl-2-pyrrolidone, cyclohexanone, acetophenone, and mixtures thereof.

A further embodiment of the claimed process provides that the essentially silicon-free oxidizing agent Z is an ether or a mixture of ethers according to the general formula R^{G}-O-R^{H}, wherein R^{G} and R^{H} represent independently from each other a linear, a branched or a cyclic alkyl group or an aryl group having 1 to 9 carbon atoms, e.g. R^{H} = 1 and R^{G} = 4 carbon atoms, and wherein R^{G} and R^{H} can optionally form a ring, e.g. as in the case of tetrahydrofuran. According to another embodiment R^{G} and R^{H} represent independently from each other a linear, a branched or a cyclic alkyl group or an aryl group having 1 to 7 carbon atoms, e.g. R^{H} = 2 and R^{G} = 3 carbon atoms, and wherein R^{G} and R^{H} can optionally form a ring, e.g. as in the case of tetrahydrofuran. Alternatively, R^{G} and R^{H} represent independently from each other a linear, a branched or a cyclic alkyl group or an aryl group having 1 to 5 carbon atoms, e.g. R^{H} = 1 and R^{G} = 3 carbon atoms, and wherein R^{G} and R^{H} can optionally form a ring, e.g. as in the case of tetrahydrofuran. According to another embodiment R^{G} and R^{H} represent independently from each other a linear, a branched or a cyclic alkyl group or an aryl group having 1 to 3 carbon atoms, e.g. e.g. R^{H} = 1 and R^{G} = 2, and wherein R^{G} and R^{H} can optionally form a ring. For example, R^{G}-O-R^{H} is selected from the group consisting of dimethyl ether, diethyl ether, ethyl methyl ether, methyl-n-propyl ether, methyl isopropyl ether, ethyl-n-propyl ether, ethyl isopropyl ether, di-n-propyl ether, diisopropyl ether, dibutyl ether, methyl tert-butyl ether (MTBE), ethyl tert-butyl ether (ETBE), tert-amyl methyl ether (TAME), 1,4-dioxane, tetrahydrofuran, and mixtures thereof.

According to another embodiment of the claimed process the molar ratio of MX_{y+2} to the essentially silicon-free oxidizing agent Z is in the range of 1 : 0.75 to 1 : 2.50. For instance, when applying a molar ratio of one mole equivalent WCl₆ and 2.50 mole equivalents acetone the solvent adduct [W(O)Cl₄(acetone)] is obtained. However, during secondary reactions in which [W(O)Cl₄(acetone)] is applied as a reactant it reacts in a similar way as WOCl₄. In another embodiment the molar ratio of MX_{y+2} to the essentially silicon-free oxidizing agent Z is in the range of 1 : 0.80 to 1 : 1.50. A further embodiment provides that the molar ratio of MX_{y+2} to the essentially silicon-free oxidizing agent Z is in the range of 1 : 0.85 to 1 : 1.30. Usually the oxidizing agent is applied in a stoichiometric amount or with a slight excess such as 1 : 1.15, i.e. an essentially stochiometric amount, which is particularly cost-efficient and ecologically advantageous. However, if an excess of the essentially silicon-free oxidizing agent is applied, excess oxidizing agent can be relatively easily removed, either after completion of step a) or before and/or during the isolation of the respective target compound. This applies in particular to oxidizing agents having comparatively few carbon atoms, particularly one, two, three, four or five carbon atoms, such as methanol, ethanol, tert-butanol, acetone, methyl tert-butyl ether and tetrahydrofuran.

According to a further variant of the claimed process the aprotic solvent A is selected from the group consisting of linear or cyclic, saturated or unsaturated, aliphatic or aromatic hydrocarbons, partly or fully halogenated linear or cyclic, saturated or unsaturated, aliphatic or aromatic hydrocarbons, ether, benzene and benzene derivatives, and mixtures thereof. In another embodiment of the process, the aprotic solvent A is favourably selected from the group consisting of aliphatic hydrocarbons, halogenated aliphatic hydrocarbons, and benzene derivates, and mixtures thereof. Advantageously, heptane, iso-hexane or mixtures of hexane isomers, pentane, dichloromethane or toluene are applied as the aprotic solvent A, for example.

Another embodiment of the herein described process provides that the reaction according to step a) comprises the steps of
i. providing a solution or suspension of MX_{y+2} in the aprotic solvent A,
ii. addition of the essentially silicon-free oxidizing agent Z,
wherein during the addition and/or after the addition of the essentially silicon-free oxidizing agent Z a reaction of MX_{y+2} and the essentially silicon-free oxidizing agent Z occurs.

The aprotic solvent can also be a solvent mixture. In one embodiment of the process a the molar ratio of MX_{y+2} to the essentially silicon-free oxidizing agent Z is 1 : 1.

One embodiment of the claimed process provides that MX_{y+2} is applied as a solid, a saturated solution in the aprotic solvent A, a suspension in the aprotic solvent A or as a solution in the aprotic solvent A or in a solvent miscible with the solvent A. In a further variant of the process the neat essentially silicon-free oxidizing agent Z or a solution of the essentially silicon-free oxidizing agent Z in the solvent A or in a solvent miscible with the solvent A is applied. In another variant of the process it is provided that the addition of the essentially silicon-free oxidizing agent Z in step a) ii. to the solution or suspension of MX_{y+2}, particularly WCl₆, in the aprotic solvent A is conducted by using a metering device. For example, the addition can be done drop-wise or by injection. Alternative, or as a complement, a stop valve and/or a stopcock and/or a metering pump can be provided in a supply line of the reactor. According to a further embodiment of the process a solution of the essentially silicon-free oxidizing agent Z in a solvent S is added to the solution or suspension of MX_{y+2} in the aprotic solvent A, the solvent S, in which the essentially silicon-free oxidizing agent Z is dissolved or suspended, being miscible with or identical to the aprotic solvent A. Dependent on the other reaction parameters this approach can be advantageous in order to have increased control over the reaction process and the exothermicity, respectively.

Dependent on the choice of the aprotic solvent or solvent mixture A and the other reaction conditions, such as the addition form of the oxidizing agent Z, i.e. as substance or dissolved in a solvent, period of the addition of the oxidizing agent Z, stirring rate, internal temperature of the reactor, the reaction of MX_{y+2} with the oxidizing agent Z already occurs during the addition and/or after the addition of the essentially silicon-free oxidizing agent Z.

In another embodiment of the claimed process the reaction of MX_{y+2} and the oxidizing agent Z is conducted at a temperature T_{R} is in the range of -100° C. to 200° C.

Within the scope of the present invention the term “temperature T_{R}” refers to the internal temperature of the respective reactor. An internal temperature of the reactor can be determined by means of at least one temperature sensor for at least one domain within the reactor. Thereby provision is made for at least one temperature sensor determining the internal temperature T_{R} which is usual identical to an average internal temperature T_{A} of the reactor.

Due to the exothermicity of the reaction it might be advantageous to keep the speed rate and/or the internal temperature during the addition of the oxidizing agent comparatively low. Alternatively, or as a complement, it can be provided that a solution of the oxidizing agent Z in an aprotic solvent or solvent mixture is added. The respective procedure has to be chosen in consideration of the other reaction parameters, such as the concentration of MX_{y+2} and the solvent or solvent mixture.

In another embodiment of the herein presented process the temperature T_{R} is in the range of -90° C. to 170° C. According to a further variant the temperature T_{R} is in the range of -20° C. to 140° C. A further embodiment provides that temperature T_{R} is in the range of 10° C. and 100° C. or in the range of 20° C. und 100° C. during the reaction of MX_{y+2} and the oxidizing agent Z.

Another embodiment of the process provides that the internal temperature T_{R} is regulated and/or controlled by means of a heat transfer medium W_{R}. For this purpose, a cryostat can be used which ideally comprises a heat transfer medium applicable for both cooling and heating. By using the heat transfer medium W_{R} deviations of the internal temperature T_{R} from a defined set point T_{S1} can be counterbalanced to the greatest extent. Realisation of a constant internal temperature T_{R} is — due to the common equipment impairments - hardly possible. However, by applying the heat transfer medium W_{R} step a) can be carried out in at least two predefined temperature ranges T_{R1} and T_{R2}. “Temperature T_{R1}” and “temperature T_{R2}”, respectively, refers to the internal temperature T_{R1} and T_{R2}, respectively, of the respective reactor. Provision is made for at least one temperature sensor determining the internal temperature T_{R1} and T_{R2}, respectively, which is usual identical to an average internal temperature T_{A1} and T_{A2}, respectively, of the reactor. The temperature sensor for determining the internal temperature T_{R1} and T_{R2}, respectively, may be identical to that one applied for determining the internal temperature T_{R}. It might be advantageous — dependent on the other reaction conditions - to implement a temperature program for the reaction of step a), the temperature program comprising at least two stages. Thereby a better control of the reaction process and/or the exothermicity can be achieved. For example, during a first phase of the addition of the oxidizing agent Z a comparatively lower temperature and a comparatively lower temperature range, respectively, can be chosen than in a second phase of the addition of the oxidizing agent Z. It can also be provided more than two phases of addition of the oxidizing agent Z and thus more than two preselected temperatures and temperature ranges, respectively. Dependent on the selection of the other reaction parameters, e.g. the concentration of MX_{y+2} and the solvent or solvent mixture, it might be advantageous to increase the temperature T_{R} during the addition of the oxidizing agent Z and/or after the addition of the oxidizing agent Z by using the heat transfer medium W_{R}. Thereby it might be ensured, where appropriate, that the reaction of MX_{y+2} with the oxidizing agent Z occurs entirely. A period of increasing the temperature T_{R} by applying the heat transfer medium W_{R} might be between 10 min and 6 h.

According to another embodiment of the herein claimed process for preparing an essentially silicon (Si) free compound of the general formula MOX_{y} (II) or [MOX_{y}(solv)ₚ] (III) it is provided that after step b) a reaction step c) is conducted, the step c) comprising
i. a separation of by-products and/or
ii.an isolation of the compound of the general formula MOX_{y} (II) or [MOX_{y}(solv)ₚ] (III).

The separation of the by-products, which are exclusively volatile, favourably highly volatile, according to step c) i. of the claimed process is simply conducted by evaporation, e.g. under reduced pressure and below the boiling point of the by-products, under vacuum or by distillation.

The isolation of the target compound according to step c) ii. can comprise further reaction steps, e.g. a concentration of the reaction mixture, i.e. a reduction of the solvent volume, for instance by bulb-to-bulb, evaporation or distillation, an addition of a solvent and/or a solvent exchange to achieve a crystallization or precipitation of the product and/or to remove impurities or starting materials from the reaction mixture, a solid/liquid separation by decantation or filtration, purification and drying of the product, a recrystallization, distillation and/or a sublimation.

In one embodiment of the herein claimed process the step c) ii. comprises at least one filtration step, at least one washing step and at least one drying step. In another embodiment the isolation of the target compound comprises the removal of by-products formed during the claimed process. Subsequently, the precipitated product is filtered off. Principally, this can be done by all appropriate methods.

According to another variant of the claimed process the reaction mixture from step a) and the isolated compound of the general formula MOX_{y} (II) or [MOX_{y}(solv)ₚ] (III) contain 100 ppm (hundred) or less, favourably 10 ppm (ten) or less, particularly 1.500 ppb (fifteen hundred) or less, silicon each, wherein the silicon content is determined by inductively coupled plasma optical emission spectrometry.

When using one of the above-mentioned oxidizing agents the compounds of the type MOX_{y} (II) or [MOX_{y}(solv)ₚ] (III) are obtained in a straightforward and reproducible manner in high purity, i.e. essentially free of alkali metals and silicon-free, favourably free of alkali metals and silicon-free, and in good to very good yields by the herein claimed process. In particular, it can be seen from X-ray powder diffractogram of the prepared Examples (cf. Fig. 1 to Fig. 5) that the positions of the relevant reflexes (= diffraction angles 2 theta) as well as their intensities are in good accordance with the reference each. Furthermore, no or minor reflexes resulting from any impurities, e.g. WO₂Cl₂, can be observed. In case, minor reflexes are observed this is most probably due to handling during the probe preparation as the target compounds are highly moisture-sensitive. Thus, it is proven that the herein claimed process yields silicon-free compounds of the general formula MOXy (II), e.g. WOCl₄, in high purity.

The complexes of the type MOX_{y} (II) or [MOX_{y}(solv)ₚ] (III) prepared by the herein described process have been shown – according to elemental analyses, particularly comprising a content determination for tungsten and chlorine as well as trace metals analysis by ICP-OES – to have purities of at least 97%, favourably of more than 97%, particularly of more than 98% or 99%. Thus, after isolation the target compound can be applied and/or stored without further purification. The reproducible yield is, depending on the chosen oxidizing agent Z and the solvent or solvent mixture, even in case of an upscaling towards industrial scale, usually > 75% or > 90%, favourably > 95%. Therefore, the yields are at least comparable to those achieved by procedures known from literature and using TMS₂O as oxidizing agent and the purities are comparatively better.

Overall, the drawbacks of the state of the art are overcome by the claimed process. Thereby, in particular considerably less contaminations by challengingly separable silicon compounds and silicon, respectively, are formed and/or present. The herein describe process is particularly versatile, comparatively eco-friendly, straight-forward and cost-efficient as it is conducted as a one-pot synthesis. Moreover, only few reaction steps are required, all of them being relatively simple to accomplish and easily scalable, particularly for industrial production. Thereby commercially available and cost-efficient starting materials are applied. Exclusively definable, easily and well separable by-products are formed, being almost quantitatively, favourably quantitatively, separable. Therefore, the desired compounds of the general formula MOX_{y} (II) or [MOX_{y}(solv)ₚ] (III) are — without further distillative and/or sublimative purification — obtained reproducibly in an improved high purity. Particularly, the compounds MOX_{y} (II) or [MOX_{y}(solv)ₚ] (III) obtained by this process comply with the highly-demanding purity specifications required for precursors for oxyalkoxides of the herein claimed oxyalkoxides of the type [M(O)(OR)_{y}], in particular for the preparation of [W(O)(OR)₄] being required in very high purity for further applications. The yields are good to very good and reproducible. Additionally, the process can also be conducted in industrial scale, wherein the target compounds are obtained in comparable yields and purities. The claimed process is time-efficient, environmentally friendly, energy and cost saving. In comparison it can be classified as more efficient.

Moreover, the problem is solved by essentially silicon (Si) free compounds of the general formula MOX_{y} (II) or [MOX_{y}(solv)ₚ] (III), obtained according to any embodiment of the claimed process for preparing an essentially silicon (Si) free compound of the general formula MOX_{y} (II) or [MOX_{y}(solv)ₚ] (III), wherein
M = Mo and y = 3 or M = W and y = 3 or 4,
X = Cl or Br,
solv = an oxidizing agent Z binding or coordinating to M via at least one donor atom and
p = 1 and y = 4 or p = 2 and y = 3.

Furthermore, the problem is solved by an essentially silicon (Si) free solution or suspension comprising a compound of the general formula MOX_{y} (II) or [MOX_{y}(solv)ₚ] (III), obtained according to any embodiment of the claimed process for preparing an essentially silicon (Si) free compound of the general formula MOX_{y} (II) or [MOX_{y}(solv)ₚ] (III), wherein
M = Mo and y = 3 or M = W and y = 3 or 4,
X = Cl or Br,
solv = an oxidizing agent Z binding or coordinating to M via at least one donor atom and
p = 1 and y = 4 or p = 2 and y = 3.

In this specific context the term “solution” also comprises a saturated solution of the compound according to the general formula MOXy (II) or [MOXy(solv)p] (III).

One embodiment of the essentially silicon (Si) free compounds of the general formula MOX_{y} (II) or [MOX_{y}(solv)ₚ] (III) or the essentially silicon (Si) free solution or suspension comprising a compound of the general formula MOX_{y} (II) or [MOX_{y}(solv)ₚ] (III), obtained according to any embodiment of the claimed process for preparing an essentially silicon (Si) free compound of the general formula MOX_{y} (II) or [MOX_{y}(solv)ₚ] (III), provides that the compound is MoOCl₃, WOCl₄, WOCl₃ or [MoOCl₃(solv)ₚ], [WOCl₄(solv)ₚ] or [WOCl₃(solv)ₚ], wherein a ligand solv is selected from the group consisting of alcohols, ketones and ethers and p may be 1 or two, more specifically p may be 1 and y may be 4 or p may be 2 and y may be 3. Advantageously, solv is selected from the group methanol, tert-butanol, acetone, butanone, tetrahydrofuran, methyl tert-butyl ether, ethyl tert-butyl ether, diisopropyl ether and tert-amyl methyl ether.

Compounds, such as MoOCl₃ and WOCl₄, are known in principle. However, compounds of the type MOX_{y} (II) or [MOX_{y}(solv)ₚ] (III), obtained by a process for preparing an essentially silicon (Si) free compound of the general formula MOX_{y} (II) or [MOX_{y}(solv)ₚ] (III) according to any one of the above described embodiments differ considerably — in terms of their characteristics - from those being prepared by a procedure from the state of the art. Particularly, the target compound being partly dissolved and/or suspended in the applied solvent and the isolated target compound, respectively, have - without complex purification, i.e. sublimation and/or distillation and/or recrystallisation - a purity being comparatively better than that of the respective commercially available compounds, in particular in the case of WOCl₄. This is, on the hand, due to the fact that the oxidizing agent is essentially silicon-free or silicon-free so that formation of silicon containing by-products is impossible. On the other hand, favourably in most cases only easily separable and comparatively environmentally friendly by-products, such as HCl, MeCl, tBuCl, C(CH₃)₂Cl₂ a and isobutene, are formed when applying one of the aforementioned oxidizing agents being selected from group consisting of alcohols, ketones and ethers. For instance, in case of using a ketone as the oxidizing agent the only by-product is a dichloroalkane. As a result, high purity of the isolated target compound of the general formula MOX_{y} (II), particularly WOCl₄, has be proven by inductively coupled plasma optical emission spectrometry (ICP-OES), for example. The result of this analytical method verifies that the silicon content of the isolated compounds, particularly of WOCl₄, is 100 ppm (hundred) or less, favourably 10 ppm (ten) or less, particularly 1.500 ppb (fifteen hundred) or less.

When using one of the above-mentioned oxidizing agents the compounds of the type MOX_{y} (II) or [MOX_{y}(solv)ₚ] (III) are obtained in a straightforward and reproducible manner in high purity, i.e. essentially free of alkali metals and silicon-free, favourably free of alkali metals and silicon-free, and in good to very good yields by the herein claimed process. In particular, it can be seen from X-ray powder diffractogram of the prepared Examples (cf. Fig. 1 to Fig. 5) that the positions of the relevant reflexes (= diffraction angles 2 theta) as well as their intensities are in good accordance with the reference each. Furthermore, no reflexes resulting from any impurities, e.g. WO₂Cl₂, can be observed. Thus, it is proven that the herein claimed essentially silicon (Si) free compounds of the general formula MOX_{y} (II) or [MOX_{y}(solv)ₚ] (III) and the essentially silicon (Si) free solution or suspension comprising a compound of the general formula MOX_{y} (II) or [MOX_{y}(solv)ₚ] (III), respectively, obtained according to any embodiment of the claimed process for preparing an essentially silicon (Si) free compound of the general formula MOX_{y} (II) or [MOX_{y}(solv)ₚ] (III), in particular WOCl₄, exhibits high purity.

The complexes of the type MOX_{y} (II) or [MOX_{y}(solv)ₚ] (III) prepared by the herein described process have been shown — according to elemental analyses, particularly comprising a content determination for tungsten and chlorine as well as trace metals analysis by ICP-OES - to have purities of at least 97%, favourably of more than 97%, particularly of more than 98% or 99%. Thus, after isolation the target compound can be applied and/or stored without further purification. The reproducible yield is, depending on the chosen oxidizing agent Z and the solvent or solvent mixture, even in case of an upscaling towards industrial scale, usually > 75% or > 90%, favourably > 95%. Therefore, the yields are at least comparable to those achieved by procedures known form literature and using TMS₂O as oxidizing agent and the yields are comparatively better.

Overall, the herein claimed essentially silicon (Si) free compounds of the general formula MOX_{y} (II) or [MOXy(solv)p] (III) and the essentially silicon (Si) free solution or suspension comprising a compound of the general formula MOX_{y} (II) or [MOX_{y}(solv)ₚ] (III), respectively, obtained according to any embodiment of the claimed process for preparing an essentially silicon (Si) free compound of the general formula MOX_{y} (II) or [MOX_{y}(solv)ₚ] (III), in particular WOCl₄, are suitable to be applied as a starting material for producing herein claimed oxyalkoxide complexes of the type [M(O)(OR)_{y}], in particular [Mo(O)(OR)₄] or [W(O)(OR)₄].

Furthermore, the problem is solved by use of an essentially silicon (Si) free compound of the general formula MOX_{y} (II) or [MOX_{y}(solv)ₚ] (III) or of an essentially silicon (Si) free solution or suspension comprising the essentially silicon (Si) free compound of the general formula MOX_{y} (II) or [MOX_{y}(solv)ₚ] (III), obtained according to any embodiment of the claimed process for preparing an essentially silicon (Si) free compound of the general formula MOX_{y} (II) or [MOX_{y}(solv)ₚ] (III) for preparing an essentially silicon (Si) free compound of the general formula [M(O)(OR)_{y}] (I). It is also possible to apply an essentially silicon-free mixture of at least two essentially silicon-free compounds according to the general formula MOX_{y} (II) and/or [MOX_{y}(solv)ₚ] (III) or an essentially silicon-free solution or suspension comprising at least two essentially silicon-free compounds according to the general formula MOX_{y} (II) and/or [MOX_{y}(solv)ₚ] (III).

An aforementioned use of the essentially silicon (Si) free compound of the general formula MOX_{y} (II) or [MOX_{y}(solv)ₚ] (III) or of the essentially silicon (Si) free solution or suspension comprising the essentially silicon (Si) free compound of the general formula MOX_{y} (II) or [MOX_{y}(solv)ₚ] (III) concerns a process for preparing an essentially silicon (Si) free compound of the general formula [M(O)(OR)_{y}] (I). The process is conducted by using an essentially silicon (Si) free compound of the general formula MOX_{y} (II) or [MOX_{y}(solv)ₚ] (III) or an essentially silicon (Si) free solution or suspension comprising the essentially silicon (Si) free compound of the general formula MOX_{y} (II) or [MOX_{y}(solv)ₚ] (III), obtained according to any embodiment of the above described process for preparing an essentially silicon (Si) free compound of the general formula MOX_{y} (II) or [MOX_{y}(solv)ₚ] (III) for preparing an essentially silicon (Si) free compound of the general formula [M(O)(OR)_{y}] (I). The following applies:
M = Mo and y = 3 or M = W and y = 3 or 4,
X = Cl or Br,
solv = an oxidizing agent Z binding or coordinating to M via at least one donor atom and
p=1 and y = 4 or p = 2 and y = 3,
R is selected from the group consisting of a linear, branched or cyclic alkyl group (C5 - C10), a linear, branched or cyclic partially or fully halogenated alkyl group (C5-C10), an alkylene alkyl ether group (R^{E}-O)n-R^{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{E} are independently from each other selected from the group consisting of a linear, a branched or a cyclic alkyl group (C1 - C6) and a linear, a branched or a cyclic partially or fully halogenated alkyl group (C1 - C6),
   R^{F} are independently from each other selected from the group consisting of a linear, a branched or a cyclic alkyl group (C1 - C10) and a linear, a branched or a cyclic partially or fully halogenated alkyl group (C1 - C10), and
   n = 1 to 5 or 1, 2 or 3.

The process comprises the steps of
a) providing the essentially silicon (Si) free compound of the general formula MOX_{y} (II) or [MOX_{y}(solv)ₚ](III),
b) addition of an alcohol ROH, wherein
   R is defined as above and
   a molar ratio of MOX_{y} (II) or [MOX_{y}(solv)ₚ](III) to the alcohol ROH is at least 1 :4,
c) supply of at least one essentially silicon (Si) free base.

It is also possible to apply an essentially silicon-free mixture of at least two essentially silicon-free compounds according to the general formula MOX_{y} (II) and/or [MOX_{y}(solv)ₚ](III) or an essentially silicon-free solution or suspension comprising at least two essentially silicon-free compounds according to the general formula MOX_{y} (II) and/or [MOX_{y}(solv)ₚ](III).

The general formula I comprises not only monomers but also possible oligomers. For instance, [W(O)(OiPr)₄]exists as a dimer in the solid state. (W. Clegg et al., J. Chem. Soc., Dalt. Trans. 1992, 1, 1431 - 1438)

The term “essentially silicon-free” is defined as above. The same applies to the terms “essentially free of alkali metals” and “essentially halogen-free”. The term “solvent” refers to a single solvent or a solvent mixture. “Supply of at least one essentially silicon (Si) free base” according to step c) includes the options of adding the essentially silicon-free base by introducing a gas or a liquid being or comprising the at least one essentially silicon-free base, by introducing a solution comprising the at least one essentially silicon-free base or by pressurisation of the respective essentially silicon-free base in a pressure vessel.

The completeness of the reaction and the end of the reaction of step c), respectively, can be determined, for instance, by the fact that ammonia gas passed into the reactor is no longer consumed in the reaction mixture, but only passing through the reaction mixture. Alternatively, or as a complement, it is observed that the temperature of the reaction mixture decreases and the exothermicity decays. For this purpose, a bubble counter, a pressure relief valve and/or a pressure sensor, a mass flowmeter or a flowmeter, a temperature sensor and a temperature switch, respectively, can be used, for example. In case the completeness of the reaction is only determined after a certain time lag excess ammonia gas can be removed from the reaction mixture by creating subatmospheric pressure or vacuum within the reactor. A similar approach can be applied if ammonia and/or an amine is passed into the reactor in the form of gas under pressure or added to the reaction mixture in the liquid state or as a solution.

The term “reactor” is not limited to any capacity, material, feature or form of the reaction vessel. Suitable reactors are, for instance, stirring tank reactors, stirring pressure reaction vessel tubular reactors, microreactors, and flow-through reactors.

R can not only be a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, a linear, branched or cyclic alkyl group (C5 —C10) being not, partially or fully halogenated, but can also comply with the formula (R^{E}-O)n-R^{F} - both in formula (I), [M(O)(OR)_{y}], and in the applied alcohol ROH. Here n is an integer from 1 to 5, e.g. 4, particularly 1, 2 or 3.

If R corresponds to the formula (R^{E}-O)n-R^{F} several residues R^{E} can be present, provided that n is larger than 1, i.e. 2, 3, 4, or 5. The residues can be identical or different and the residues R^{E} can be selected independently from each other from the group consisting of

a linear, a branched or a cyclic alkyl group having one to six carbon atoms and a linear, a branched or a cyclic partially or fully halogenated alkyl group having one to six carbon atoms. Consequently, if n is, for instance, 2, the formula (R^{E}-O)n-R^{F} is (R^{E1}-O)-(R^{E2}-O)-R^{F}, wherein R^{E1} and R^{E2} can be identical, e.g. n-propyl, or different, e.g. R^{E1} is n-propyl and R^{E2} is n-butyl, or R^{E1} and R^{E2} are isomers, e.g. R^{E1} is n-propyl and R^{E2} is iso-propyl. It is also possible to apply several isomeric or different residues so that a mixture of different residues R^{E} and thus different residues R are present in ROH and (R^{E}-O)n-R^{F}, respectively, leading to isomer mixtures of [M(O)(OR)_{y}] (I).

If the residue R corresponds to the formula (R^{E}-O)n-R^{F}, the residues R^{F} can be selected independently from each other from the group consisting of a linear, a branched or a cyclic alkyl group having one to ten carbon atoms (C1 - C10), in particular having three to seven carbon atoms (C3 - C7), and a linear, a branched or a cyclic partially or fully halogenated alkyl group having one to ten carbon atoms (C1 -C10). The residues R^{F} can also be dissimilar in the same manner as the residues R^{E} can be different and thus result in unequal residues R. If different residues R^{F} and/or R^{E} and thus mixed residues R are present, as stated above, the applied alcohols ROH are mixtures. Advantageously, particularly isomer mixtures are included, e.g. dibutylene glycol monopropyl ether being an isomer mixture of various isomers of dibutylene glycol monopropyl ether, wherein dibutylene glycol monopropyl ether is the main isomer.

In one embodiment of the herein claimed process the alcohol ROH is selected from the group consisting of sBuCH₂OH, iBuCH₂OH, (iPr)(Me)CHOH, (nPr)(Me)CHOH, (Et)₂CHOH, (Et)(Me)₂COH, C₆H₁₁OH, C₆H₅CH₂OH and C₆H₅OH, and mixtures thereof. Alternatively, or as a complement, the alcohol ROH is selected from the group consisting of (2,2-Dichloro-3,3-dimethylcyclopropyl)methanol, (2,2-dichloro-1-phenylcyclopropyl)methanol, 1,1,5-trihydroperfluorpentanol, 6-chloro-1-hexanol, 6-bromo-1-hexanol, 8-chloro-1-octanol, 8-bromo-1-octanol, 10-chloro-1-decanol, 10-bromo-1-decanol, C₆H₅C(CF₃)₂OH, 2,2-bis(bromomethyl)-1,3-propanediol, derivatives thereof, and mixtures thereof.

Another embodiment of the claimed process provides that the alcohol ROH is a glycol ether. The term “glycol ether” also comprises poly ethers. In one variant of the process the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof. According to a further embodiment of the herein described process the glycol ether is selected from the group consisting of ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂-O-CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof. As mentioned above, the indicated glycol ethers can also be used as isomer mixtures. Advantageously, the glycol ether is selected from the group consisting of dipropylene glycol monopropyl ether CH₃CH₂CH₂-O-CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

The oxyalkoxide complexes of the type [M(O)(OR)_{y}] (I) prepared by the herein described process contain neither amine nor ammonia after their isolation. However, the isolated compounds might comprise amine and/or ammonia in an amount around or below the detection limit. In this case they are referred to as “essentially ammonia-free”. It can therefore be deduced that an ammonia adduct of the respective target compound is — if at all — only present in solution. Introducing ammonia into the reaction mixture over a too long period after completion of the reaction is unfavourable, both under ecological and under economical aspects. Moreover, advantageously the compounds of the general formula [M(O)(OR)_{y}] (I) prepared by the claimed process are essentially silicon-free — particularly due to the use of an essentially silicon (Si) free compound of the general formula MOX_{y} (II) or [MOX_{y}(solv)ₚ](III) or an essentially silicon (Si) free solution or suspension comprising the essentially silicon (Si) free compound of the general formula MOX_{y} (II) or [MOX_{y}(solv)ₚ](III), obtained according to any embodiment of the above described process for preparing an essentially silicon (Si) free compound of the general formula MOX_{y} (II) or [MOX_{y}(solv)ₚ](III) is applied - and essentially free of alkali metals. Consequently, they comprise a silicon content of 100 ppm and an alkali metal content of 0.20 ppm, respectively, at the most.

The herein claimed process is conducted as a one-pot synthesis comprising only three steps and yielding essentially silicon-free compounds of the general formula [M(O)(OR)_{y}] (I), in particular [Mo(O)(OR)₄] and [W(O)(OR)₄]. Advantageously, the starting material is essentially silicon-free MOX_{y} (II) or [MOX_{y}(solv)ₚ](III), in particular WOCl₄, obtained according to any embodiment of the above described process for preparing an essentially silicon (Si) free compound of the general formula MOX_{y} (II) or [MOX_{y}(solv)ₚ](III). This is a major advantage compared to the usage of commercially available compounds of this type. Particularly, the commercially available tungsten(VI) compound WOCI₄ is — in some cases — contaminated with silicon (Si) and/or a silicon comprising compound due to the common application of hexamethyldisiloxane as starting material, leading to a purity being insufficient with respect to the application as starting material in the herein described process. A common impurity is the by-product TMSCI, which is toxic and reacts to hydrogen chloride during air contact, as well as the hexamethyldisiloxane residues and/or other siloxane and/or silane species. This is a major disadvantage, particularly if commercially available WOCI₄ is used as a starting material for preparing compounds for the field of electrical engineering, electrochemistry and semiconductors. By contrast, the herein applied compounds of the type MOX_{y} (II) or [MOX_{y}(solv)ₚ](III), either as isolated substances or as a solution or suspension comprising the essentially silicon (Si) free compound of the general formula MOX_{y} (II) or [MOX_{y}(solv)ₚ](III), are synthesised by a comparatively eco-friendly, straight-forward and cost-efficient synthesis starting from WCI₆ and an essentially silicon-free oxidizing agent, favourably methanol, tert-butanol, acetone, butanone, methyl tert-butyl ether, ethyl tert-butyl ether, diisopropyl ether, tert-amyl methyl ether or tetrahydrofuran. The reaction is conducted in an aprotic solvent or a solvent mixture, favourably in an aliphatic or an aromatic hydrocarbon being not halogenated, partly or fully halogenated, or a mixture thereof. Advantageously, the obtained MOX_{y} (II) or [MOX_{y}(solv)ₚ](III) does not have to be isolated as it is stable as a solution or suspension over several weeks, at least three. The solution or suspension might comprise comparatively environmentally friendly and easily to separate by-products, e.g. HCI, MeCI, tBuCl, C(CH₃)₂Cl₂ and isobutene. The by-products can be removed straightforward by creating subatmospheric pressure or vacuum. A further advantage is that the oxidizing agent is essentially silicon-free or silicon-free so that formation of silicon containing by-products is impossible. Usually the oxidizing agent is applied in a stoichiometric or a slight excess or shortage, i.e. an essentially stochiometric amount, which is particularly cost-efficient and ecologically advantageous. However, if an excess of the essentially silicon-free oxidizing agent is applied, excess oxidizing agent can be relatively easily removed, either after completion of step a) or before and/or during the isolation of the respective target compound. This applies in particular to oxidizing agents having comparatively few carbon atoms, particularly one, two, three, four or five carbon atoms, such as tert-butanol, acetone, methyl tert-butyl ether and tetrahydrofuran.

According to step b) of the herein claimed process for preparing compounds of the type [M(O)(OR)_{y}] (I) the respective oxyalkoxide complex is obtained by addition of at least four mole equivalents of the alcohol ROH - with regard to MOX_{y} (II) or [MOX_{y}(solv)ₚ](III) from step a), e.g. WOCI₄ -, whereby only four mole equivalents are required for the preparation of compounds of the general formula [M(O)(OR)_{y}] (I), e.g. [Mo(O)(OR)₄] and [W(O)(OR)₄]. Favourably, the reaction according to step b) is not disturbed by any contaminations or by-products resulting from a previous reaction step. Thus, in most cases only four equivalents of the alcohol are required. As the alcohol ROH is — in most cases — applied in a stoichiometric amount or in a slight excess and thus fully consumed during the formation of the respective target compound higher-boiling alcohols ROH are applicable in step b). By supply of an essentially silicon-free base according to step c), e.g. ammonia and/or at least one amine, favourably ammonia gas or an ammonia solution, the hydrogen chloride formed in step a) and/or step b) is trapped and consumed, respectively, by formation of NH₄C1, for example. After conducting the steps a) to c) of the claimed process only the desired essentially silicon-free oxyalkoxides of the type [M(O)(OR)_{y}], solvents, where appropriate, and the defined, easily separable by-product of the reaction of an amine and/or ammonia, e.g. NH₄C1, are present. These impurities can generally be present in amounts of less than two weight percent (< 2 wt.-%), less than one weight percent (< 1 wt.-%) and particularly less than one half of one weight percent (< 0.5 wt.-%). One reason for the fact that the by-product is easily separable, e.g. by filtration or centrifugation and/or decantation, is the advantageous choice of an aprotic solvent. For instance, use of heptane or another aliphatic solvent, such as iso-hexane or mixtures of hexane isomers, pentane, or dichloromethane as a solvent particularly leads to quantitative precipitation of NH₄C1, whereas the target compound, e.g. [Mo(O)(OR)₄] and [W(O)(OR)₄] remains in solution. Thus, advantageously a contamination of the respective oxyalkoxide by the formed NH₄Cl freight is significantly reduced. Another advantage of the claimed process is that no undefinable by-products such as lithium tungstate complex salts are formed, which are — if at all - very different to separate. The respective target compound being in solution can be reacted directly with one or more reactants. Alternatively, the compound of the type [Mo(O)(OR)₄] or [W(O)(OR)_{y}] can be isolated by a straightforward filtration using, where appropriate, a filter auxiliary such as e.g. charcoal, perlite, montmorillonite or an alumosilicate, followed by removal of all volatile components such as solvents. A major benefit of the claimed process is that NH₄Cl is almost quantitatively, preferably quantitatively, separable in a straightforward manner by a filtration step. Another major advantage is that the isolated compound contains neither ammonia nor contaminations by silicon or alkali metals or silicon or alkali metals comprising compounds In general, the final product can comprise solvent residues or the defined, easily separable by-product of the reaction of amine or ammonia such as NH₄Cl. Consequently, the final product has a purity of at least 95%, favourably of more than 95%, particularly of more than 98% or 99%. Thus, after isolation the target compound can be applied and/or stored without further purification. The reproducible yield is, depending on the chosen alcohol and the solvent or solvent mixture, even in case of an upscaling towards industrial scale, usually > 80% or > 90%.

Overall, the drawbacks of the state of the art are overcome by the claimed process. Thereby, in particular considerably less contaminations by challengingly separable salt freights, such as LiCl in tetrahydrofuran or NH₄Cl in an alcohol, are formed and/or present. The herein describe process is particularly versatile, straight-forward and cost-efficient as it is conducted as a one-pot synthesis. Moreover, only few reaction steps are required, all of them being relatively simple to accomplish and easily scalable, particularly for industrial production. Favourably, an essentially silicon (Si) free compound of the general formula MOX_{y} (II) or [MOX_{y}(solv)ₚ](III) or an essentially silicon (Si) free solution or suspension comprising the essentially silicon (Si) free compound of the general formula MOX_{y} (II) or [MOX_{y}(solv)ₚ](III), obtained according to any embodiment of the above described process for preparing an essentially silicon (Si) free compound of the general formula MOX_{y} (II) or [MOX_{y}(solv)ₚ](III) is applied. Exclusively definable, easily and well separable by-products are formed, being almost quantitatively, favourably quantitatively, separable. In particular, formation of non-separable lithium tungstate complexes, e.g. Li[W(O)(OR)₅], is excluded. Therefore, the desired oxyalkoxide is — without further distillative and/or sublimative purification -obtained reproducibly in an improved high purity. Particularly, the oxyalkoxides obtained by this process comply with the highly-demanding purity specifications required for applications relating to the deposition of compounds, semiconductor, photovoltaic or catalytic applications. The yields are good to very good and reproducible. Additionally, the process can also be conducted in industrial scale, wherein the target compounds are obtained in comparable yields and purities. The claimed process is time-efficient, comparatively environmentally friendly, energy and cost saving. In comparison it can be classified as more efficient.

When using a compound of the general formula MOX_{y} (II) or [MOX_{y}(solv)ₚ](III), in pure form or as a solution or suspension, obtained according to any embodiment of the above described process for preparing an essentially silicon (Si) free compound of the general formula MOX_{y} (II) or [MOX_{y}(solv)ₚ](III) and one of the above-mentioned alcohols, respectively, the compounds of the type [Mo(O)(OR)₄] or [W(O)(OR)_{y}] are obtained in a straightforward and reproducible manner in high purity, i.e. essentially ammonia-free, free of alkali metals, halogen-free and silicon-free, favourably ammonia-free, free of alkali metals, halogen-free and silicon-free, and in good to very good yields by the herein claimed process.

According to another embodiment of the process the at least one essentially silicon-free base is favourable selected from the group consisting of organic, organometallic and inorganic bases, and mixtures thereof. In a further variant the at least one essentially silicon-free base is selected from the group consisting of amines, ammonia, heterocyclic nitrogenous bases, alkali metal oxides and alkali metal amides, and mixtures thereof. In case the base is an alkali metal oxide and/or an alkali metal amide the base is favourably selected from the group consisting of lithium, sodium and potassium metal oxides and amides and more favourably selected from sodium and potassium metal oxides and amides. In a further embodiment of the claimed process the at least one essentially silicon-free base is an organic or an inorganic base. Advantageously, at least one essentially silicon-free base is selected from the group consisting of amines, ammonia and heterocyclic nitrogenous bases.

By supply and addition, respectively, of an essentially silicon-free base according to step c), e.g. ammonia and/or at least one amine, advantageously ammonia gas or an ammonia solution, e.g. a methanolic one, the hydrogen chloride formed in step b) is trapped and consumed, respectively, by formation of NH₄CI, for instance. After conducting the steps a) to c) of the claimed process only the desired essentially silicon-free oxyalkoxides of the type [M(O)(OR)_{y}], solvents, where appropriate, and the defined, easily separable by-product of the reaction of an amine and/or ammonia, e.g. NH₄CI, are present. These impurities can generally be present in amounts of less than two weight percent (< 2 wt.-%), less of one weight percent (< 1 wt.-%) and particularly less than one half of one weight percent (< 0.5 wt.-%). The halogen content, which may be halogenide, such as chloride, encompasses all kinds of halogen compounds, specifically chlorine compounds, such as chlorine impurities originating from halogenated educts or solvents, such as dichloromethane or tetrachloromethane as well as halogenide, such as chloride and in general, such halogen content, in particular a chlorine content, is usually below 1000 (thousand) ppm, or below 500 ppm (five hundred) or below 250 ppm (two hundred and fifty). One reason for the fact that the by-product being favourably NH₄Cl is easily separable, e.g. by filtration or centrifugation and/or decantation, is the choice of an aprotic solvent. For example, application of linear or cyclic, saturated or unsaturated, aliphatic or aromatic hydrocarbons, partly or fully halogenated linear or cyclic, saturated or unsaturated, aliphatic or aromatic hydrocarbons, ether, benzene and benzene derivatives, and mixtures thereof, usually selected from the group consisting of aliphatic hydrocarbons, halogenated aliphatic hydrocarbons, benzene derivates and mixtures thereof, such as benzene, petrol ether 40-60, hexane, heptane, octane or other alkanes, dichloromethane and chloroform usually leads to quantitative precipitation of NH₄CI, while the target compound, e.g. [Mo(O)(OR)₄] or [W(O)(OR)₄] remains in solution. Thus, advantageously a contamination of the respective oxyalkoxide by the formed NH₄Cl freight is significantly reduced. The respective target compound being in solution can be reacted directly with one or more reactants. Alternatively, the compound of the type [Mo(O)(OR)₄] or [W(O)(OR)_{y}] can be isolated by a straightforward filtration using, where appropriate, a filter auxiliary, e.g. charcoal, perlite, montmorillonite or an alumosilicate, followed by removal of all volatile components such as solvents. A major benefit of the claimed process is that NH₄Cl is almost quantitatively, preferably quantitatively, separable in a straightforward manner by a filtration step. Another major advantage is that the isolated compound contains neither ammonia nor amine residues or other contaminations resulting directly or indirectly, i.e. due to side-reactions of the base, from the applied base. In general, the final product can comprise solvent residues or the defined, easily separable by-product of the reaction of amine or ammonia, e.g. NH₄Cl. Consequently, the final product has a purity of at least 95%, favourably of more than 95%, particularly of more than 98% or 99%. Thus, after isolation the target compound can be applied and/or stored without further purification. The reproducible yield is, depending on the chosen alcohol and the solvent or solvent mixture, even in case of an upscaling towards industrial scale, usually > 80% or > 90%.

For example, a large variety of amines is applicable, also as a mixture. The amine can be selected from the group consisting of primary, secondary and tertiary amines and may be alkyl amines, aryl amines or combinations thereof. Alkyl amines can be advantageously used, e.g. methyl amine, ethyl amine, propyl amine, isopropyl amine, butyl amine, tert-butyl amine, cyclohexyl amine, dimethyl amine, diethyl amine, dipropyl amine, diisopropyl amine, dibutyl amine, di-tert-butyl amine, dicyclohexyl amine, trimethyl amine, triethyl amine, tripropyl amine, triisopropyl amine, tributyl amine, tri-tert-butyl amine, tricyclohexyl amine, and derivatives and mixtures thereof. Mixed substituted amines and mixtures thereof are also conceivable, e.g. diisopropyl ethyl amine (DIPEA). In addition, acetamidine, ethylene diamine, triethylene tetramine, N,N,N′,N′-tetramethylethylene diamine (TMEDA), guanidine, urea, thiourea, imines, aniline, pyridine, imidazole, dimethylaminopyridine, pyrrole, morpholine, quinoline and mixtures thereof are applicable.

Ammonia is advantageously applicable as the gas itself or as an ammonia solution. In one embodiment of the herein described process the ammonia solution comprises at least one aprotic organic solvent B and/or at least one alcohol R^{B}OH, wherein
R^{B} is selected from the group consisting of a linear, branched or cyclic alkyl group (C1 - C10), a linear, branched or cyclic partially or fully halogenated alkyl group (C1 -C10), an alkylene alkyl ether group (R^{K}-O)ₙ-R^{L}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{K} are independently from each other selected from the group consisting of a linear, a branched or a cyclic alkyl group (C1 - C6) and a linear, a branched or a cyclic partially or fully halogenated alkyl group (C1 - C6),
   R^{L} are independently from each other selected from the group consisting of a linear, a branched or a cyclic alkyl group (C1 - C10) and a linear, a branched or a cyclic partially or fully halogenated alkyl group (C1 - C10) and
R^{B}OH differs from the oxidizing agent Z.

In a further embodiment the aprotic organic solvent B is selected from the group hydrocarbons, halogenated hydrocarbons, ether, benzene, benzene derivatives, and mixtures thereof.

According to another embodiment the alcohol R^{B}OH is selected from the group consisting of sBuCH₂OH, iBuCH₂OH, (iPr)(Me)CHOH, (nPr)(Me)CHOH, (Et)₂CHOH, (Et)(Me)₂COH, C₆H₁₁OH, C₆H₅CH₂OH and C₆H₅OH, and mixtures thereof. In an alternative embodiment of the claimed process the R^{B}OH is selected from the group consisting of (2,2 dichlorocyclopropyl)methanol and (2,2-dichloro-1-phenylcyclopropyl)methanol, 1,1,5-trihydroperfluorpentol, 6-chloro-1-hexanol, 6-bromo-1-hexanol, 8-chloro-1-octol, 8-bromo-1-octol, 10-chloro-1-decol, 10-bromo-1-decol and C₆H₅C(CF₃)₂. and mixtures thereof. Another embodiment provides that the alcohol R^{B}OH is a glycol ether. For instance, the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof. Examples of a glycol ether are ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

Advantageously, the alcohol R^{B}OH is selected from the group consisting of iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

In another embodiment the alcohol R^{B}OH is advantageously identical to the alcohol ROH from step b) of the claimed process. In this case, the number of reagents and solvents is reduced, which leads to a further simplification of the herein claimed process and thus to an improvement under economic and ecological aspects. In general, a solution of ammonia gas in another protic or aprotic solvent is applicable, including, but not limited to, one of the following ammonia solutions can be applied: 7N in methanol, 0.4 M in dioxane, 2.0 M in ethanol, 4 M in methanol or 0.4 M in tetrahydrofuran. Advantageously, a methanolic ammonia solution can be used, wherein the solution comprises 20 weight percent ammonia gas

One or more heterocyclic nitrogenous essentially silicon-free base can be selected from the group consisting of urotropin, morpholine, N-methyl morpholine, 1,8-diazabicyclo[5.4.0]undec-7-en (DBU), 1,4-diazabicyclo[2.2.2]octane (DABCO®), pyridine, pyrazine, pyrazole, pyrimidine, pyridazine, triazine, triazole, oxazole, thiazole, purine, pteridine, quinoline, quinolinone, imidazole, quinazoline, quinoxaline, acridine, phenazine, cinnoline, 8-Methyl-8-azabicyclo[3.2.1]octane, derivatives, isomers and derivates thereof, and mixtures thereof.

The process according to claim any one of claims 1 to 11, wherein a pressure p_{R} is in the range of 1013.25 hectopascal (hPa) to 6000 hectopascal (hPa), preferably in the range of 1500 hectopascal (hPa) to 3000 hectopascal (hPa).

According to the present invention the term “pressure p_{R}” refers to the internal pressure of the respective reactor. The term “reactor” is defined as above.

According to a further variant of the claimed process the aprotic solvent A is selected from the group consisting of linear or cyclic, saturated or unsaturated, aliphatic or aromatic hydrocarbons, partly or fully halogenated linear or cyclic, saturated or unsaturated, aliphatic or aromatic hydrocarbons, ether, benzene and benzene derivatives, and mixtures thereof. In another embodiment of the process, the aprotic solvent A is favourably selected from the group consisting of aliphatic hydrocarbons, halogenated aliphatic hydrocarbons, and benzene derivates, and mixtures thereof. Advantageously, heptane, iso-hexane or mixtures of hexane isomers, pentane, dichloromethane or toluene are applied as the aprotic solvent A, for example.

In another embodiment of the process it is provided that the addition of the alcohol ROH in step b) is conducted by using a metering device. For example, the addition can be done drop-wise or by injection. Alternative, or as a complement, a stop valve and/or a stopcock and/or a metering pump can be provided in a supply line of the reactor. According to a further embodiment of the process a solution of the alcohol ROH in a solvent M is added to the reactant MOX_{y} (II) or [MOX_{y}(solv)ₚ](III) provided in step a) as a solid, a solution, also a saturated one, where appropriate, or a suspension. Thereby, the solvent M, in which the alcohol ROH is dissolved, is miscible with or identical to the aprotic solvent A of step a). Dependent on the other reaction parameters this approach can be advantageous in order to have increased control over the reaction process and the exothermicity, respectively.

In another embodiment of the process the molar ratio of MOX_{y} or [MOX_{y}(solv)ₚ](III) to the alcohol ROH is at least 1 : 3 or 1 : 4 or ranges from 1 : 4 to 1 : 40 or from 1 : 6.1 to 1 : 40 or from 1 : 4 to 1 : 6.1, more specifically the molar ratio of MOX_{y} or [MOX_{y}(solv)ₚ](III) to the alcohol ROH is at least 1 : 3 for y = 3 or is 1 : 4 for y = 4. Thereby the molar ratio is chosen dependent on the respective alcohol ROH and on the respective solvent and solvent mixture.

A further variant of the claimed process provides that a temperature Tc ranges from -30° C. to 50° C. during and/or after the addition of the alcohol ROH. In another embodiment the temperature Tc ranges from -25° C. to 30° C. during and/or after the addition of the alcohol ROH. Alternatively, the temperature Tc ranges from -15° C. to 20° C. during and/or after the addition of the alcohol ROH. Provision is made for at least one temperature sensor determining the internal temperature Tc, which is usual identical to an average internal temperature T_{A3} of the reactor.

Another embodiment of the process provides that the internal temperature Tc is regulated and/or controlled by means of a heat transfer medium W_{C}. For this purpose, a cryostat can be used which ideally comprises a heat transfer medium applicable for both cooling and heating. By using the heat transfer medium Wc deviations of the internal temperature Tc from a defined set point T_{S2} can be counterbalanced to the greatest extent. Realisation of a constant internal temperature Tc is — due to the common equipment impairments - hardly possible. However, by applying the heat transfer medium Wc step b) can be carried out in at least two predefined temperature ranges T_{C1} and T_{C2}. “Temperature T_{C1}” and “temperature T_{C2}”, respectively, refers to the internal temperature T_{C1} and T_{C2}, respectively, of the respective reactor. Provision is made for at least one temperature sensor determining the internal temperature T _{C1} and T_{C2}, respectively, which is usual identical to an average internal temperature T_{A4} and T_{A5}, respectively, of the reactor. The temperature sensor for determining the internal temperature T_{C1} and T_{C2}, respectively, may be identical to that one applied for determining the internal temperature T_{R}. It might be advantageous — dependent on the other reaction conditions — to implement a temperature program for the reaction of step b), the temperature program comprising at least two stages. Thereby a better control of the reaction process and/or the exothermicity can be achieved.

According to another embodiment of the process a temperature T_{N} ranges from -30° C. to 100° C. during and/or after of the supply of the at least one silicon (Si) free base, favourably ammonia gas. In a further variant the temperature T_{N} ranges from -25° C. to 80° C. during and/or after of the supply of the at least one silicon (Si) free base, favourably ammonia gas. Another embodiment of the process provides that the temperature T_{N} ranges from -20° C. to 60° C. during and/or after of the supply of the at least one silicon (Si) free base, favourably ammonia gas or an ammonia solution, e.g. a methanolic one. In this step c) ammonia and/or a base is introduced into the reaction mixture, which can be done by introducing a gas or a liquid being or comprising the at least one essentially silicon-free base, by introducing a solution comprising the at least one essentially silicon-free base or by pressurisation of the respective essentially silicon-free base. In case of pressurisation a pressure in the range of 1 mbar to 6 bar, particularly in the range of 100 mbar to 4.5 bar might be selected. Provision is made for at least one temperature sensor determining the internal temperature T_{N}, which is usual identical to an average internal temperature T_{A6} of the reactor. The temperature sensor for determining the internal temperature T_{N} may be identical to that one applied for determining the internal temperature T_{C}.

Another embodiment of the process provides that the internal temperature T_{N} is regulated and/or controlled by means of a heat transfer medium W_{N}. For this purpose, a cryostat can be used which ideally comprises a heat transfer medium applicable for both cooling and heating. By using the heat transfer medium W_{N} deviations of the internal temperature T_{R} from a defined set point T_{S3} can be counterbalanced to the greatest extent. Realisation of a constant internal temperature T_{N} is — due to the common equipment impairments — hardly possible. However, by applying the heat transfer medium W_{N}, usually being identical to the heat transfer medium Wc, step c) can be carried out in at least two predefined temperature ranges T_{N1} and T_{N2}. “Temperature T_{N1}” and “temperature T_{N2}”, respectively, refers to the internal temperature T_{N1} and T_{N2}, respectively, of the respective reactor. Provision is made for at least one temperature sensor determining the internal temperature T_{N1} and T_{N2}, respectively, which is usual identical to an average internal temperature T_{A7} and T_{A8}, respectively, of the reactor. The temperature sensor for determining the internal temperature T_{N1} and T_{N2}, respectively, may be identical to that one applied for determining the internal temperature T_{R} and/or T_{C}.

According to another embodiment of the claimed process
a temperature T_{N1} ranges from -30° C. to 20° C. during a first phase of the supply of the at least one silicon (Si) free base, and
a temperature T_{N2} ranges from 21° C. to 100° C. during and/or after a second phase of the supply of the at least one silicon (Si) free base,
wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution, is introduced into the reactor. Alternatively, or as a complement, an amine is introduced into the reactor. In another alternative the temperature T_{N2} ranges from 22° C. to 80° C. during and/or after a second phase of the supply of the at least one silicon (Si) free base, wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution is introduced into the reactor. Alternatively, or as a complement, an amine is introduced into the reactor. A further embodiment provides that the temperature T_{N2} ranges from 23° C. to 60° C. during and/or after a second phase of the supply of the at least one silicon (Si) free base wherein a gas or a liquid being or comprising the at least one essentially silicon-free base is introduced into the reactor or a solution comprising the at least one essentially silicon-free base is introduced into the reactor or the at least one silicon-free base is introduced into the reactor by pressurisation of the respective essentially silicon-free base. Favourably, ammonia gas or an ammonia solution in an organic solvent, particularly an alcoholic solution, e.g. a methanolic solution is introduced into the reactor. Alternatively, or as a complement, an amine is introduced into the reactor.

By such a temperature program for the supply and the introduction, respectively, or the pressurisation of amine or ammonia, in particular of ammonia gas, an even better control of the reaction process and/or the exothermicity can be achieved.

The period of the supply and the introduction, respectively, or the pressurisation of amine or ammonia, in particular of ammonia gas, as well as the temperature T_{N} or T_{N1} and T_{N2} are dependent on, amongst other reaction parameters, the batch size, the choice of the alcohol ROH and the selection of the solvent or solvent mixture.

If the first and the second phase of the supply and the introduction, respectively, or the pressurisation of amine or ammonia, in particular of ammonia gas, the first and the second phase can be different from each other, particularly with regard to their duration.

For instance, the first phase can comprise a longer period of time at a comparatively lower temperature T_{N1} than the second phase at the comparatively higher temperature T_{N2}. For example, the first phase of the supply and the introduction, respectively, or the pressurisation of amine or ammonia, in particular of ammonia gas, might comprise one hour, wherein T_{N1} < 20° C., and the second phase of the supply and the introduction, respectively, or the pressurisation of amine or ammonia, in particular of ammonia gas, might comprise 30 min, wherein T_{N2} ≥ 21° C. Dependent on the choice of the reactant ROH and the selection of the solvent this procedure might be favourable in order to achieve a quantitative trapping and consumption, respectively, of the released hydrogen chloride by formation of NH₄Cl, for example. According to another embodiment of the process the first phase and the second phase of the supply and the introduction, respectively, or the pressurisation of amine or ammonia, in particular of ammonia gas, comprise identical periods of time. As a result, the procedure is comparatively simpler.

In another embodiment of the process it is provided that after step b) a reaction step is conducted comprising a removal of volatile by-products and/or solvent. In one embodiment of the claimed process this reaction step is carried out before conducting step c). Alternatively, or as a complement, the reaction step is carried out after conducting step c). The separation of the volatile by-products and/or solvent and solvent mixture, respectively, is simply conducted by evaporation, e.g. under reduced pressure and below the boiling point of the by-products, or by distillation.

A further variant of the claimed process provides that after step c) a reaction step d) is conducted comprising an isolation of the compound of the general formula [M(O)(OR)_{y}] (I). The isolation of the target compound according to step d) can comprise further reaction steps, e.g. a concentration of the reaction mixture, i.e. a reduction of the solvent volume, for instance by bulb-to-bulb, evaporation or distillation, an addition of a solvent and/or a solvent exchange to achieve a crystallization or precipitation of the product and/or to remove impurities or starting materials from the reaction mixture, a solid/liquid separation by decantation or filtration, purification and drying of the product, a recrystallization, distillation and/or a sublimation. If the target compound being in solution shall not be a reactant in a secondary reaction immediately following the preparation of the target compound but shall be isolated and stored and/or further used, the separation might comprise one or more steps.

In another embodiment the isolation of the target compound comprises the removal of by-products formed during the claimed process. In doing so primarily the hydrogen chloride having been trapped and consumed, respectively, by reaction with amine or ammonia can be separated as precipitated ammonium chloride and ammonium salt, i.e. the chloride of the applied amine, e.g. diethyl ammonium chloride, respectively. Principally, this can be done by all appropriate methods.

For instance, filtration is suitable, wherein the filter cake can advantageously be washed off with the applied solvent. Similarly, the precipitated by-products can be sedimented or centrifugated and the solution of the product [M(O)(OR)_{y}] can be separated by decantation.

In one embodiment separation is done by filtration, in a second step remained insoluble by-products are separated by centrifugation of the filtrate and subsequent decantation.

In one variant of the process the isolation comprises a filtration step. Thereby several filtration steps can be provided, also, where appropriate, one or more filtrations over a cleaning agent, such as activated carbon or silica, e.g. charcoal, perlite, montmorillonite or an alumosilicate, so that soluble and fines can also be separated.

The filter cake, which can also comprise the NH₄Cl freight, for example, can be washed with a small amount of a highly volatile solvent, such as dichloromethane, in order to extract product possibly contained in the NH₄Cl freight. In a specific embodiment it is washed with the solvent applied as the reaction medium.

The problem is also solved by essentially silicon (Si) free compounds of the general formula

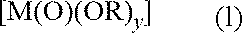

wherein
M = Mo and y = 3 or M = W and y = 3 or 4 and
R is selected from the group consisting of a linear, branched or cyclic alkyl group (C5 C10), a linear, branched or cyclic partially or fully halogenated alkyl group (C5 -C10), an alkylene alkyl ether group (R^{E}-O)ₙ-R_{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
   R^{E} are independently from each other selected from the group consisting of a linear, a branched or a cyclic alkyl group (C1 - C6) and a linear, a branched or a cyclic partially or fully halogenated alkyl group (C1 - C6),
   R^{F} are independently from each other selected from the group consisting of a linear, a branched or a cyclic alkyl group (C1 - C10) and a linear, a branched or a cyclic partially or fully halogenated alkyl group (C1 - C10), and
   n = 1 to 5 or 1, 2 or 3,
obtained according to any embodiment of the above described process for preparing an essentially silicon (Si) free compound of the general formula [M(O)(OR)_{y}] (I). Said process makes favourably use of an essentially silicon (Si) free compound of the general formula MOX_{y} (II) or [MOX_{y}(solv)ₚ](III) or of an essentially silicon (Si) free solution or suspension comprising the essentially silicon (Si) free compound of the general formula MOX_{y} (II) or [MOX_{y}(solv)ₚ](III), obtained according to any embodiment of the above described process for preparing an essentially silicon (Si) free compound of the general formula MOX_{y} (II) or [MOX_{y}(solv)ₚ](III).

Advantageously, oxyalkoxides of the type [M(O)(OR)_{y}] (l) are particularly straightforward producible in a one-pot synthesis. The oxyalkoxides are reproducibly prepared in high purity, i.e. essentially ammonia-free, free of alkali metals, halogen-free and silicon-free, favourably ammonia-free, free of alkali metals, halogen-free and silicon-free, without further purification, i.e. distillative and/or sublimative purification or recrystallisation. In particular, the oxyalkoxides obtained according to any embodiment of the above claimed process comply with the highly-demanding purity specifications required for precursors for applications relating to the deposition of compounds, semiconductor, photovoltaic or catalytic applications. The yields are good to very good and reproducible. Additionally, the process can also be conducted in industrial scale, wherein the target compounds are obtained in comparable yields and purities.

The terms “essentially ammonia-free”, “essentially free of alkali metals”, “essentially halogen-free” and “silicon-free” are defined as above. The term “ammonia-free”, “free of alkali metals”, “halogen-free” and “silicon-free”, respectively refers to a compound comprising ammonia, alkali metals, halogens and silicon, respectively, in an amount particularly equal to 0 (zero) ppm.

Oxyalkoxides, such as [W(O)(OiPr)₄] and [W(O)(OsBu)₄], are known in principle. Compounds of the type [M(O)(OR)_{y}] (I) obtained by a process for preparation of oxyalkoxides according to any one of the above described embodiments differ considerably — in terms of their characteristics - from those being prepared by a procedure from the state of the art. Particularly, without complex purification the isolated target compounds have a purity being at least as high as that of compounds of the type [M(O)(OR)_{y}], particularly [W(O)(OR)₄], which have been synthesised according to methods from the state of the art and purified — as is customary in literature — by fractionating distillation and/or sublimation. A major advantage is that the isolated compound contains neither ammonia nor contaminations by silicon or alkali metals or silicon or alkali metals comprising compounds. In general, the final product can comprise solvent residues or the defined, easily separable by-product of the reaction of amine or ammonia such as NH₄Cl. Impurities by solvents and the defined, easily separable by-product of the reaction of an amine and/or ammonia, e.g. NH₄CI, can generally be present in amounts of less than two weight percent (< 2 wt.-%), less than one weight percent (< 1 wt.-%) and particularly less than one half of one weight percent (< 0.5 wt.-%). Consequently, the final product has a purity of at least 95%, favourably of more than 95%, particularly of more than 98% or 99%. Thus, after isolation the target compound can be applied and/or stored without further purification.

In one embodiment of the essentially silicon (Si) free compounds of the general formula

[M(O)(OR)_{y}] (I), obtained by a process for preparation of metal oxyalkoxides according to any one of the above described embodiments, R is selected from the group consisting of CH₂sBu, CH₂iBu, CH(Me)(iPr), CH(Me)(nPr), CH(Et)₂, C(Me)₂(Et), C₆H₁₁, CH₂C₆H₅ und C₆H₅.

According to another embodiment of the essentially silicon (Si) free compounds of the general formula [M(O)(OR)_{y}] (I), obtained by a process for preparation of metal oxyalkoxides according to any one of the above described embodiments, R is selected from the group consisting of (2,2-Dichloro-3,3-dimethylcyclopropyl)methyl, (2,2-dichloro-1-phenylcyclopropyl)methyl, 1,1,5-trihydroperfluorpentyl, 6-chloro-1-hexanyl, 6-bromo-1-hexanyl, 8-chloro-1-octyl, 8-bromo-1-octyl, 10-chloro-1-decyl, 10-bromo-1-decyl and CₑH₅C(CF₃)₂.

In another embodiment of the essentially silicon (Si) free compounds of the general formula [M(O)(OR)_{y}] (I), obtained by a process for preparation of metal oxyalkoxides according to any one of the above described embodiments OR is a base corresponding to glycol ether. For instance, the glycol ether is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof.

According to a further embodiment of the essentially silicon (Si) free compounds of the general formula [M(O)(OR)_{y}] (I), obtained by a process for preparation of metal oxyalkoxides according to any one of the above described embodiments the glycol ether is selected from the group consisting of ethylene glycol monomethyl ether CH₃—O—CH₂CH₂—OH, ethylene glycol ethyl ether CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof. The indicated glycol ethers can also be used as isomer mixtures, as has been mentioned above. For instance, dipropylene glycol monobutyl ether may be an isomer mixture of various isomers of dipropylene glycol monobutyl ether, wherein dipropylene glycol monobutyl ether is the main isomer.

According to another variant of the essentially silicon (Si) free compounds of the general formula [M(O)(OR)_{y}] (I), obtained by a process for preparation of oxyalkoxides according to any one of the above described embodiments the isolated compounds contain 100 ppm (hundred) or less, favourably 10 ppm (ten) or less, particularly 1.500 ppb (fifteen hundred) or less, silicon each, wherein the silicon content is determined by inductively coupled plasma optical emission spectrometry.

Several of the aforementioned compounds of the type [M(O)(OR)_{y}] (I) exhibit comparatively low melting points due to the composition of the residue R and the ligand OR, respectively. Thereby some representatives of these metal oxyalkoxides are liquid at or slightly above ambient temperature. These low-melting compounds of the general formula [M(O)(OR)_{y}] (l), favourably [Mo(O)(OR)₄] or [W(O)(OR)₄], are particularly qualified for applications relating to the deposition of compounds, semiconductor, photovoltaic or catalytic applications.

Moreover, the problem is solved by use of a compound of the general formula [M(O)(OR)_{y}] (l), obtained according to any embodiment of one of the two above described process for an essentially silicon (Si) free compound of the general formula [M(O)(OR)_{y}] (l), for applications relating to the deposition of compounds, semiconductor, photovoltaic or catalytic applications.

Due to their high purity the applied metal oxyalkoxides are particularly qualified for applications relating to the deposition of compounds, semiconductor, photovoltaic or catalytic applications. Particularly, they are essentially silicon-free, free of alkaline metals, ammonia-free, halogen-free and solvent-free, wherein the solvent content is particularly one weight percent or less. In a special embodiment they are silicon-free, i.e. their silicon content, alkali metal content, ammonia content, halogen metal content and solvent content, respectively, is particularly equal to 0 (zero) ppm. All the aforementioned contaminations are — dependent on the type of contamination each —more or less unfavourable with regard to the deposition process and thus with respect to the performance of the coated substrates.

The problem is also solved by use of a compound of the general formula [Mo(O)(OR)₄] or [W(O)(OR)₄] (l), obtained according to any embodiment of one of the two above described processes for preparing an essentially silicon (Si) free compound of the general formula [M(O)(OR)_{y}] (l), for preparing a semiconductor element, a photovoltaic cell, a catalyst or is used for depositing compounds. The aforementioned use of a compound of the general formula [Mo(O)(OR)₄] or [W(O)(OR)₄] (l), obtained according to any embodiment of one of the two above described processes for preparing an essentially silicon (Si) free compound of the general formula [M(O)(OR)_{y}] (l), concerns a process for preparing a semiconductor element, a photovoltaic cell, a catalyst or for depositing a compound by using a compound of the general formula [Mo(O)(OR)₄] or [W(O)(OR)₄] (l), obtained according to any embodiment of one of the two above described processes for preparing an essentially silicon (Si) free compound of the general formula [M(O)(OR)_{y}] (l), wherein

R is selected from the group consisting of a linear, branched or cyclic alkyl group (C5 —C10), a linear, branched or cyclic partially or fully halogenated alkyl group (C5 — C10), an alkylene alkyl ether group (R^{E}-O)ₙ-R_{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
R^{E} are independently from each other selected from the group consisting of a linear, a branched or a cyclic alkyl group (C1 - C6) and a linear, a branched or a cyclic partially or fully halogenated alkyl group (C1 - C6),
R^{F} are independently from each other selected from the group consisting of a linear, a branched or a cyclic alkyl group (C1 - C10) and a linear, a branched or a cyclic partially or fully halogenated alkyl group (C1 - C10), and
n = 1 to 5 or 1, 2 or 3.

The process comprises the steps of
a) providing the compound of the general formula [Mo(O)(OR)₄] or [W(O)(OR)₄] (l),
b) deposition of the tungsten layer or the molybdenum layer, tungsten containing layer or molybdenum containing layer on the surface of the substrate of the semiconductor element, photovoltaic cell, the automotive exhaust gas catalyst and
c) completion of the semiconductor element, the photovoltaic cell or the automotive exhaust gas catalyst.

The process may also comprise the steps of
a) providing the compound of the general formula [Mo(O)(OR)4] or [W(O)(OR)_{y}] (l),
b) deposition of the molybdenum layer, tungsten layer, molybdenum containing layer or the tungsten containing layer on the surface of a particulate substrate,
c) formulating the particulate substrate to a washcoat and
d) applying the washcoat to the surface of the substrate of an automotive exhaust gas catalyst and completion of said automotive exhaust gas catalyst.

The process may also comprise the steps of
a) providing the compound of the general formula [Mo(O)(OR)4] or [W(O)(OR)_{y}] (l),
b) providing reactants and solvents for obtaining the catalyst,
c) allowing a reaction of compound of the general formula [Mo(O)(OR)4] or [W(O)(OR)_{y}] (l) with said reactants to obtain a catalyst under suitable reaction conditions, and
d) finishing the catalyst.

The catalyst can be employed to catalyse chemical reactions, e.g. metathesis reactions or coupling reactions. The catalyst may constitute a catalytically reactive species or create such species in situ.

An exception is made for metal oxyalkoxides of the general formula [M(O)(OR)_{y}] (l), wherein the four residues R are independently from each other selected from the group consisting of a linear, branched or cyclic alkyl group C6 - C8.

Due to their high purity the applied metal oxyalkoxides are particularly qualified as precursors for the preparation of high-quality tungsten layers or tungsten comprising layers. These substrates are used for applications relating to the deposition of compounds, semiconductor, photovoltaic or catalytic applications. In addition, the applied metal oxyalkoxides are particularly straightforward and cost-efficient prepared by a one-pot synthesis in good to very good and reproducible yields. Therefore, they are suitable for usage in industrial scale.

By both of the two claimed processes defined metal oxyalkoxides of the type [M(O)(OR)_{y}] (l) are reproducibly prepared in a straightforward, cost-efficient, and comparatively environmentally friendly one-pot synthesis, wherein high purities and good to very good yields are achieved. ¹H NMR spectra of the isolated compounds do not show any impurities of starting materials, by-products, decomposition products, solvent or the like. This is achieved without a complex purification of the respective isolated raw product by fractional distillation and/or sublimation and/or recrystallisation. In fact, no purification is required, i.e. the isolated raw product and the end product are identical, or a simple bulb-to-bulb distillation of the respective raw product is satisfying in order to obtain the end product. Because of their high purity metal oxyalkoxides, obtained by one of the two claimed processes, are particularly qualified for applications relating to the deposition of compounds, semiconductor, photovoltaic or catalytic applications. Particularly, they are essentially silicon-free, free of alkaline metals, ammonia-free, halogen-free and solvent-free, wherein the solvent content is particularly one weight percent or less. In a special embodiment they are silicon-free, i.e. their silicon content, alkali metal content, ammonia content, halogen metal content and solvent content, respectively, is particularly equal to 0 (zero) ppm. Additionally, both of the claimed processes are characterised in that it can also be conducted in industrial scale, with comparable purity and yield of the respective target compound. Overall, the two claimed processes for the preparation of metal oxyalkoxides of the general formula [M(O)(OR)_{y}] (l) are satisfying both from an economic and an ecological point of view.

The invention is now explained in more detail by the following examples which are considered illustrative. The examples are restricting neither the invention’s nor the claims’ scope.

### EXAMPLES

### General Experimental Remarks

### Materials and Methods

Reactions were performed in a three-neck round-bottom flask or a stirred reactor, under an inert gas atmosphere and under continuous stirring at an internal temperature of the reactor given in the synthesis procedures below. A cryostat was used to control and/or regulate the internal temperature of the reactor.

The applied solvents were dried according to standard procedures.

### Product Characterization

Identity of the isolated products WOCl₄ and [WOCl₄(solv)], respectively, was determined by X-ray diffraction (XRD) combined with W content determination. Purity of the isolated products - with respect to trace metals, in particular silicon (Si), - was determined by inductively coupled plasma optical emission spectrometry (ICP-OES). The determined silicon (Si) values are equal to or even lower than the limit of determination being 1.500 ppb.

Identity of the isolated products according to the general formula [W(O)(OR)_{y}] (l) was determined by nuclear magnetic resonance (NMR) spectroscopy. Purity of these products was determined by elemental analysis, NMR, W content and Cl content determination, trace metals analysis with an ICP-OES.

### Synthesis of WOCl₄ and [WOCl₄(L)]

### Example 1: Preparation of WOCl₄ From WCl₆ and Acetone; Solvent: Dichloromethane

10 g tungsten(VI) chloride (25.21 mmol, 1.00 eq.) are suspended and partly dissolved, respectively, in 50 mL dichloromethane. Subsequently, 1.464 g acetone (25.21 mmol, 1.00 eq.) dissolved in 20 mL dichloromethane are added within about 10 min by using a dropping funnel. During the addition of the acetone/dichloromethane mixture the internal temperature is held in the range 20° C. ± 5° C. After completion of the addition the dropping funnel is rinsed with 2 mL dichloromethane. Afterwards the reaction mixture is stirred for 2 h. The precipitate is separated by filtration and washed twice with 25 mL heptane each. After vacuum drying (900 mbar to 10-³ mbar) 7.82 g (90.78 %) of the desired essentially silicon-free product WOCl₄ are isolated.

### Example 2: Preparation of WOCl₄ From WCl₆ and Acetone; Solvent: Heptane

100 g tungsten(VI) chloride (252.15 mmol, 1.00 eq.) are dosed into a 1 L stirred reactor by a solid substances metering funnel. Afterwards the metering funnel is rinsed with 300 mL heptane, whereby the tungsten(VI) chloride is suspended and partly dissolved, respectively. A mixture of 14,644 g acetone (252.15 mmol, 1.00 eq.) and 200 mL heptane was added by a dropping funnel over a period of about 1 h. During this time the internal temperature was held in the range of 19° C. to 26° C. After completion of the addition the reaction mixture was heated to 30° C. for 2.5 h. After cooling to ambient temperature the precipitate is filtered off over a glass frit (D4) and washed twice with 100 mL heptane each. After vacuum drying (900 mbar to 10-³ mbar) for 4 h the desired essentially silicon-free product WOCl₄ is isolated as an orange solid in a yield of 83.12 g (96.49%).

### Example 3: Preparation of WOCl₄ From WCl₆ and Tert-Butanol; Solvent: Heptane

10 g tungsten(VI) chloride (25.21 mmol, 1.00 eq.) are suspended and partly dissolved, respectively, in 50 mL heptane. 1.888 g tert-butanol (25.21 mmol, 1.00 eq.) mixed with 20 mL heptane are dosed into the reaction vessel by a dropping funnel over a period of about 10 min. Thereby the internal temperature increases slightly. After completion of the addition the reaction mixture is stirred for another 4 h at ambient temperature. Subsequently, the precipitate is separated over a glass frit (D4) and washed twice with 10 mL heptane each. After vacuum drying (900 mbar to 10-³ mbar) the desired essentially silicon-free product WOCl₄ is isolated as an orange solid in a yield of 8.12 g (94.26%).

### Example 4: Preparation of WOCl₄ From WCl₆ and Methyl Tert-Butyl Ether; Solvent: Heptane

10 g tungsten(VI) chloride (25.21 mmol, 1.00 eq.) are suspended and partly dissolved, respectively, in 50 mL heptane. 2,245 g methyl tert-butyl ether (MTBE) (25.21 mmol, 1.00 eq.) mixed with 20 mL heptane are dosed into the reaction vessel by a dropping funnel over a period of about 5 min. After completion of the addition the reaction mixture is stirred for another 16 h at ambient temperature. The precipitate is filtered off over a glass frit (D4) and washed twice with 25 mL heptane each. After vacuum drying (900 mbar to 10-³ mbar) the desired essentially silicon-free product WOCl₄ is isolated as an orange solid in a yield of 8.11 g (94.14%).

### Example 5: Preparation of WOCl₄ From WCl₆ and Methanol; Solvent: Dichloromethane

10 g tungsten(VI) chloride (25.21 mmol, 1.00 eq.) are suspended and partly dissolved, respectively, in 50 mL dichloromethane. 0.808 g MeOH (25.21 mmol, 1.00 eq.) mixed with 20 mL dichloromethane are dosed into the reaction vessel by a dropping funnel over a period of about 15 min. Subsequently, the reaction mixture is stirred for 4 h at ambient temperature and then heated under reflux for about 80 min. After cooling to ambient temperature the precipitate is separated over a glass frit (D4) and washed twice with 25 mL heptane each. After vacuum drying (900 mbar to 10-³ mbar) the desired essentially silicon-free product WOCl₄ is isolated as an orange solid in a yield of 6.35 g (73.71%).

### Example 6: Preparation of [WOCl₄(Acetone)] From WCl₆ and Acetone; Solvent: Heptane

10 g tungsten(VI) chloride (25.21 mmol, 1.00 eq.) are suspended and partly dissolved, respectively, in 50 mL heptane. Subsequently, 2.93 g acetone (50.43 mmol, 2.00 eq.) dissolved in 20 mL dichloromethane are added within about 10 min by using a dropping funnel. During the addition of the acetone/dichloromethane mixture the internal temperature is held in the range 20° C. ± 5° C. After completion of the addition the dropping funnel is rinsed with 2 mL heptane. Afterwards the reaction mixture is stirred for 16 h. The precipitate is separated by filtration and washed twice with 25 mL heptane each. After vacuum drying (900 mbar to 10-³ mbar) 8.63 g (86.04%) of the desired essentially silicon-free product [WOCl₄(acetone)] are isolated as yellow crystalline solid.

### Synthesis of [W(O)(OR)₄] With NH₃ Starting From WCl₆

### Examples 7 to 10: Preparation of [W(O)(OR)_{4]}

The reactor was dried under vacuum at 60° C. for 1 hour. Heptane and the corresponding alcohols, glycol ether and polyglycol ether were dried over molecular sieve for several days according to standard methods.

Under inert gas atmosphere 100 g tungsten(VI) chloride (252.15 mmol; 1.0 eq.) are dosed into a 1 L stirred reactor by a solid substances metering funnel. Subsequently, tungsten(VI) chloride is suspended and partly dissolved, respectively, in 500 mL heptane (anhydrous) and the reaction mixture is stirred at ambient temperature. 14.66 g acetone (252.15 mmol, 1.0 eq.) in 200 mL heptane are added over a period of about 1 h. The reaction mixture is stirred for 16 h at ambient temperature, whereby a bright orange reaction mixture is obtained. To the WOCl₄ slurry stirred at about 20° C. the corresponding alcohol or glycol ether or polyglycol ether is added slowly over a period of about 1 h. During the addition of the corresponding alcohol or glycol ether or polyglycol ether the precipitate is slowly dissolved and the colour of the reaction mixture changes to yellow (sBuOH or glycol ether or polyglycol ether) or decolorates

$$\left(i \text{PrOH}\right) .$$

Finally, a solution is obtained. After the addition of the corresponding alcohol or glycol ether or polyglycol ether the reactor is flushed with nitrogen gas for 5 min to remove hydrogen chloride having formed during the reaction. After flushing with nitrogen gas the reactor is connected to the pressure release valve and ammonia gas is passed into the reactor (500 mL/min; 0.55 bar). The reaction process is controlled via a mass flow controller. Supply of ammonia gas is finished as soon as the ammonia gas flow decreases to 0 mL/ min. The pressure is released and the reactor is flushed purged with nitrogen gas to remove residual ammonia gas. Subsequently, the reaction mixture is filtered over a glass frit (D4). By a subsequent filtration over Celite® colloidal solid residues are separated. Finally, the solvent is removed under reduced pressure (10⁻² mbar, up to 60° C.) and the desired product [W(O)(OR)₄] is obtained as solid or liquid.

### Example 7 to 10: Analytical Data

Example 7: WO(OR)4 with R =

$$i \text{Pr;}$$

8.0 eq

$$i \text{PrOH} ;$$

colorless solid, 81% yield

¹H-NMR (CDCl₃, 600 MHz, 300 K) δ (ppm) = 1.30 (d, 24 H), 4.79-4.95 (m, 4 H); trace metals analysis (lCP-OES): all trace metals <10 ppm; silicon (Si) content (ICP-OES): < 10 ppm.

### Example 8: WO(OR)₄ With R = sBu; 8.0 eq sBuOH; Yellow Liquid, 83% Yield

¹H-NMR (CDCl₃, 600 MHz, 300 K) δ (ppm) = 0.95 (t, 12 H), 1.29 (dd, 12 H), 1.53-1.69 (m, 8 H), 4.60-4.69 (m, 4 H); trace metals analysis (lCP-OES): all trace metals <10 ppm; silicon (Si) content (lCP-OES): < 10 ppm.

### Example 9: WO(OR)₄ With R = C₃H₆OCH₃; 4.0 eq CH₃OC₃H₆OH; Yellow Liquid, 87% Yield

¹H-NMR (CDCl₃, 600 MHz, 300 K) δ (ppm) = 1.23-1.27 (m, 12 H, CHCH3) 3.38-3.43 (m, 20 H, OCH2+OCH3), 4.74-4.83 (m, 4 H, CH); elemental analysis: tungsten (W) content = 32.8%; trace metals analysis (lCP-OES): all trace metals <10 ppm silicon (Si) content (lCP-OES): < 10 ppm; chlorine (Cl) content < 250 ppm;

### Example 10: WO(OR)₄ With R = C₃H₆OC₃H₆OC₃H₇; 4.0 eq C₃H₇OC₃H₆OC₃H₆OH; Red-Orange Liquid, 86% Yield

¹H-NMR (CDCl₃, 600 MHz, 300 K) δ (ppm) = 0.85 - 0.97 (m, 3 H) 1.08 - 1.40 (m, 7 H), 1.58 (t, J=7.08 Hz, 2 H), 3.30 - 4.05 (m, 7 H), 4.24 - 4.61 (m, 1 H), 4.67 - 4.93 (m, 1 H); elemental analysis: tungsten (W) content = 20.1%; trace metals analysis (ICP-OES): all trace metals <10 ppm, silicon (Si) content (lCP-OES): < 10 ppm, chlorine (Cl) content < 250 ppm.

### Synthesis of [W(O)(OR)₄] With Et₂NH Starting From WCl₆

### Example 11: Preparation of [WO(OC₃H₆OCH₃)₄]

The reactor was dried under vacuum at 60° C. for 1 hour. Heptane and 1-methoxy-2-propanol were dried over molecular sieve for several days according to standard methods.

Under inert gas atmosphere 100 g tungsten(VI) chloride (252.15 mmol; 1.0 eq.) are dosed into a 1 L stirred reactor by a solid substances metering funnel. Subsequently, tungsten(VI) chloride is suspended and partly dissolved, respectively, in 500 mL heptane (anhydrous) and the reaction mixture is stirred at ambient temperature. 14.66 g acetone (252.15 mmol, 1.0 eq.) in 200 mL heptane are added over a period of about 1 h. The reaction mixture is stirred for 16 h at ambient temperature, whereby a bright orange reaction mixture is obtained. To the WOCl₄ slurry stirred at about 20° C. the 1-methoxy-2-propanol (1.01 mol, 4.0 eq) is added slowly over a period of about 1 h. During the addition of 1-methoxy-2-propanol the precipitate is slowly dissolved and the color of the reaction mixture changes to yellow. Finally, a solution is obtained. After the addition of 1-methoxy-2-propanol the reactor is flushed with nitrogen gas for 5 min to remove hydrogen chloride having formed during the reaction. After flushing with nitrogen gas, 74.57 g Et₂NH (1.02 mol, 4.04 eq) are added via dropping funnel over a period of 1 h, at 20° C. to the reaction solution. After complete addition of the Et₂NH the colorless reaction mixture is stirred for another 1 h at room temperature. Subsequently, the reaction mixture is filtered over a glass frit (D4). By a subsequent filtration over Celite® colloidal solid residues are separated. Finally, the solvent is removed under reduced pressure (10⁻² mbar, up to 60° C.) and the desired product [W(O)(OC₃H₆OCH₃)₄] is obtained as yellow liquid (84%).

¹H-NMR (CDCl₃, 600 MHz, 300 K) δ (ppm) = 1.19-1.23 (t, 12 H, CHCH3), 3.35-3.40 (m, 20 H, OCH2+OCH3), 4.69-4.78 (m, 4 H, CH); trace metals analysis (lCP-OES): all trace metals <10 ppm; silicon (Si) content (lCP-OES): < 10 ppm

### Synthesis of [W(O)(OR)₄] With Different Amine Bases, Starting From WOCl₄ Synthesized According to Example 2

### Example 12 to 19

A flask was charged with tungsten oxytetrachloride (3.00 g, 8.78 mmol, 1.00 eq) and suspended/ dissolved in 125 mL of anhydrous heptane. The reaction mixture was cooled with stirring to 0° C. To this stirred solution 6.35 g 1-methoxy-2-propanol (70.5 mmol, 8.00 eq) were added. To this reaction solution 4.00 eq corresponding base were added, whereas a colorless solid was formed. The reaction mixture was warmed to room temperature and the solids removed via filtration over Celite®. After removal of all volatile side products and components the product was obtained as slightly yellow liquid.

### Example 12 to 19: Analytical Data

### Example 12: WO(OC₃HeOCH₃)₄ With Base = Methylamine; Yellow Liquid; 67% Yield

¹H-NMR (CDCl₃, 600 MHz, 300 K) δ (ppm) = 1.20-1.24 (m, 12H, CHCH3), 3.35-3.41 (m, 20H, OCH2+OCH3), 4.71-4.79 (m, 4H, CH).

### Example 13: WO(OC₃HeOCH₃)₄ With Base = Triethylamine; Yellow Liquid; 83% Yield

¹H-NMR (CDCl₃, 600 MHz, 300 K) δ (ppm) = 1.19-1.23 (m, 12H, CHCH3), 3.34-3.40 (m, 20H, OCH2+OCH3), 4.68-4.82 (m, 4H, CH).

### Example 14: WO(OC₃HeOCH₃)₄ With Base = 1,2-ethylene Diamine; Yellow Liquid; 93% Yield

¹H-NMR (CDCl₃, 600 MHz, 300 K) δ (ppm) = 1.17-1.19 (m, 12H, CHCH3), 3.30-3.40 (m, 20H, OCH2+OCH3), 4.68-4.73 (m, 4H, CH).

### Example 15: WO(OC₃HeOCH₃)₄ With Base = N,N,N′,N′-tetramethylethylene Diamine; Yellow Liquid; 30% Yield

¹H-NMR (CDCl₃, 600 MHz, 300 K) δ (ppm) = 1.24-1.28 (m, 12H, CHCH3), 3.37-3.47 (m, 20H, OCH2+OCH3), 4.74-4.84 (m, 4H, CH).

### Example 16: WO(OC₃HeOCH₃)₄ With Base = 1,8-Diazabicyclo[5,4,0]undec-7-ene (DBU); Yellow Liquid; 25% Yield

¹H-NMR (CDCl₃, 600 MHz, 300 K) δ (ppm) = 1.29-1.33 (m, 12H, CHCH3), 3.36-3.45 (m, 20H, OCH2+OCH3), 4.97-5.05 (m, 4H, CH).

### Example 17: WO(OC₃HeOCH₃)₄ With Base = Morpholine; Yellow Liquid; 19% Yield

¹H-NMR (CDCl₃, 600 MHz, 300 K) δ (ppm) = 1.29-1.33 (m, 12H, CHCH3), 3.40-3.45 (m, 20H, OCH2+OCH3), 4.76-4.85 (m, 4H, CH).

### Example 18: WO(OC₃HeOCH₃)₄ With Base = Pyridine; Yellow Liquid; 80% Yield

¹H-NMR (CDCl₃, 600 MHz, 300 K) δ (ppm) = 1.24-1.28 (m, 12H, CHCH3), 3.38-3.43 (m, 20H, OCH2+OCH3), 4.74-4.84 (m, 4H, CH).

### Example 19: WO(OC₃HeOCH₃)₄ With Base = Imidazole; Yellow Liquid; 77% Yield

¹H-NMR (CDCl₃, 600 MHz, 300 K) δ (ppm) = 1.22-1.26 (m, 12H, CHCH3), 3.36-3.46 (m, 20H, OCH2+OCH3), 4.73-4.83 (m, 4H, CH).

### Synthesis of [W(O)(OR)₄] With WOCl₄ Synthesized According to Example 2

### Example 20: Preparation of W(O)(OC₃H₆OCH₃)₄

The reactor is dried under vacuum at 60° C. for 1 hour. Heptane and the glycol ether 1-methoxy-2-propanol are dried over molecular sieve for several days according to standard methods.

Under inert gas atmosphere a 1 L stirred reactor is charged with 1.0 eq. tungsten(VI) oxy tetrachloride (252.15 mmol) by a solid substances metering funnel. Subsequently, tungsten(VI) oxy tetrachloride is suspended and partly dissolved, respectively, in 500 mL heptane (anhydrous) and the reaction mixture is stirred at ambient temperature. To the tungsten(VI) oxy tetrachloride slurry stirred at about 20° C. 1-methoxy-2-propanol (1.01 mol; 4.0 eq.) are added slowly over a period of about 1 h. After the addition of 1-methoxy-2-propanol the reactor is flushed with nitrogen gas for 5 min to remove hydrogen chloride having formed during the reaction. After flushing with nitrogen gas the reactor is connected to the pressure release valve and ammonia gas is passed into the reactor (500 mL/min; 0.55 bar). The reaction process is controlled via a mass flow controller. Supply of ammonia gas is finished as soon as the ammonia gas flow decreases to 0 mL/ min. The pressure is released and the reactor is flushed purged with nitrogen gas to remove residual ammonia gas. Subsequently, the reaction mixture is filtered over a glass frit (D4). By a subsequent filtration over Celite® colloidal solid residues are separated. Finally, the solvent is removed under reduced pressure (10⁻² mbar, up to 60° C.) and the desired product [W(O)(OC₃H₆OCH₃)₄] (>80%) is obtained as yellow liquid.

From the results of successful one-pot synthesis according to Example 9 the conclusion is made that a synthesis, starting from isolated, essentially silicon-free WOel₄ does result in essentially silicon-free [WO(OR)₄] that is obtained analogous to Example 9. The reasons for this are as follows:

It has been proven herein that essentially silicon-free WOCl₄ with a silicon content of less than 1.500 ppb is obtained according to the process herein described (cf. Examples 1 to 6). When reaction of WOCl₄ with an alcohol ROH and essentially silicon-free base is carried out, then no further impurities by a silicon species can be introduced. Thus, a silicon content of < 1.500 ppb cannot be exceeded by the end-product of the synthesis according to Example 12. Yields and purities achieved by this Example are similar or identical to those obtained from the one-pot synthesis herein described.

In addition to the above mentioned reaction and according to Example 12, the following

### Examples 21

Based on Examples 7 to 11, the results of the following Examples can be obtained when varying the alcohol and the silicon-free based are varied.

Abbreviations: Yd.= Yield; Ex. No.: Example Number;

Bases used: MA= Methylamine, DA= Diethylamine, TA= Triethylamine, 12E=1,2-Ethylenediamine, TMEDA= N,N,N,N′,N′-Tetramethylethane-1,2-diamine (TMEDA), DBU=1,8-Diazabicyclo[5,4,0]undec-7-ene (DBU), Mo=Morpholine, Py=Pyridine, lm=lmidazole, DMAP=N,N-Dimethylaminopyridine, NH3=Ammonia

| Ex. No. | Alcohol | Base | | | | | | | | | | | Yd. [%] |
|---|---|---|---|---|---|---|---|---|---|---|---|---|---|
| | | | | | | T | | | | | | | |
| | | | | | | M | | | | | D | | |
| | | | | | | E | D | | | | M | N | |
| | | M | D | T | 12 | D | B | M | | | A | H | |
| | | A | A | A | E | A | U | o | Py | lm | P | 3 | |
| | MeOH | X | | | | | | | | | | | 83 |
| | | | X | | | | | | | | | | 96 |
| | | | | X | | | | | | | | | 86 |
| | | | | | X | | | | | | | | 97 |
| | | | | | | X | | | | | | | 52 |
| | | | | | | | X | | | | | | 38 |
| | | | | | | | | X | | | | | 25 |
| | | | | | | | | | X | | | | 83 |
| | | | | | | | | | | X | | | 88 |
| | | | | | | | | | | | X | | 91 |
| | | | | | | | | | | | | X | 95 |
| | Ethanol | X | | | | | | | | | | | 82 |
| | | | X | | | | | | | | | | 97 |
| | | | | X | | | | | | | | | 80 |
| | | | | | X | | | | | | | | 93 |
| | | | | | | X | | | | | | | 58 |
| | | | | | | | X | | | | | | 33 |
| | | | | | | | | X | | | | | 20 |
| | | | | | | | | | X | | | | 88 |
| | | | | | | | | | | X | | | 81 |
| | | | | | | | | | | | X | | 93 |
| | | | | | | | | | | | | X | 94 |
| | Propan-1-ol | X | | | | | | | | | | | 84 |
| | | | X | | | | | | | | | | 90 |
| | | | | X | | | | | | | | | 88 |
| | | | | | X | | | | | | | | 90 |
| | | | | | | X | | | | | | | 56 |
| | | | | | | | X | | | | | | 38 |
| | | | | | | | | X | | | | | 21 |
| | | | | | | | | | X | | | | 85 |
| | | | | | | | | | | X | | | 83 |
| | | | | | | | | | | | X | | 95 |
| | | | | | | | | | | | | X | 90 |
| | | X | | | | | | | | | | | 85 |
| | Propan-2-ol | | X | | | | | | | | | | 91 |
| | | | | X | | | | | | | | | 81 |
| | | | | | X | | | | | | | | 98 |
| | | | | | | X | | | | | | | 54 |
| | | | | | | | X | | | | | | 32 |
| | | | | | | | | X | | | | | 27 |
| | | | | | | | | | X | | | | 86 |
| | | | | | | | | | | X | | | 89 |
| | | | | | | | | | | | X | | 91 |
| | | | | | | | | | | | | X | 95 |
| | 2-Methylpropan-1-ol | X | | | | | | | | | | | 89 |
| | | | X | | | | | | | | | | 90 |
| | | | | X | | | | | | | | | 87 |
| | | | | | X | | | | | | | | 93 |
| | | | | | | X | | | | | | | 50 |
| | | | | | | | X | | | | | | 36 |
| | | | | | | | | X | | | | | 23 |
| | | | | | | | | | X | | | | 82 |
| | | | | | | | | | | X | | | 87 |
| | | | | | | | | | | | X | | 93 |
| | | | | | | | | | | | | X | 91 |
| | 2-Methylpropan-2-ol | X | | | | | | | | | | | 88 |
| | | | X | | | | | | | | | | 98 |
| | | | | X | | | | | | | | | 89 |
| | | | | | X | | | | | | | | 95 |
| | | | | | | X | | | | | | | 57 |
| | | | | | | | X | | | | | | 30 |
| | | | | | | | | X | | | | | 22 |
| | | | | | | | | | X | | | | 84 |
| | | | | | | | | | | X | | | 85 |
| | | | | | | | | | | | X | | 95 |
| | | | | | | | | | | | | X | 96 |
| | Butan-1-ol | X | | | | | | | | | | | 86 |
| | | | X | | | | | | | | | | 90 |
| | | | | X | | | | | | | | | 82 |
| | | | | | X | | | | | | | | 96 |
| | | | | | | X | | | | | | | 55 |
| | | | | | | | X | | | | | | 34 |
| | | | | | | | | X | | | | | 23 |
| | | | | | | | | | X | | | | 81 |
| | | | | | | | | | | X | | | 86 |
| | | | | | | | | | | | X | | 90 |
| | | | | | | | | | | | | X | 92 |
| | Butan-2-ol | X | | | | | | | | | | | 87 |
| | | | X | | | | | | | | | | 95 |
| | | | | X | | | | | | | | | 84 |
| | | | | | X | | | | | | | | 92 |
| | | | | | | X | | | | | | | 58 |
| | | | | | | | X | | | | | | 37 |
| | | | | | | | | X | | | | | 24 |
| | | | | | | | | | X | | | | 83 |
| | | | | | | | | | | X | | | 85 |
| | | | | | | | | | | | X | | 94 |
| | | | | | | | | | | | | X | 95 |
| | 2-Methylbutan-1-ol | X | | | | | | | | | | | 81 |
| | | | X | | | | | | | | | | 94 |
| | | | | X | | | | | | | | | 83 |
| | | | | | X | | | | | | | | 91 |
| | | | | | | X | | | | | | | 52 |
| | | | | | | | X | | | | | | 34 |
| | | | | | | | | X | | | | | 28 |
| | | | | | | | | | X | | | | 85 |
| | | | | | | | | | | X | | | 88 |
| | | | | | | | | | | | X | | 90 |
| | | | | | | | | | | | | X | 94 |
| | 3-Methylbutan-1-ol | X | | | | | | | | | | | 83 |
| | | | X | | | | | | | | | | 92 |
| | | | | X | | | | | | | | | 85 |
| | | | | | X | | | | | | | | 94 |
| | | | | | | X | | | | | | | 51 |
| | | | | | | | X | | | | | | 31 |
| | | | | | | | | X | | | | | 26 |
| | | | | | | | | | X | | | | 82 |
| | | | | | | | | | | X | | | 80 |
| | | | | | | | | | | | X | | 96 |
| | | | | | | | | | | | | X | 92 |
| | 2-Methylbutan-2-ol | X | | | | | | | | | | | 80 |
| | | | X | | | | | | | | | | 93 |
| | | | | X | | | | | | | | | 83 |
| | | | | | X | | | | | | | | 94 |
| | | | | | | X | | | | | | | 59 |
| | | | | | | | X | | | | | | 39 |
| | | | | | | | | X | | | | | 29 |
| | | | | | | | | | X | | | | 89 |
| | | | | | | | | | | X | | | 80 |
| | | | | | | | | | | | X | | 97 |
| | | | | | | | | | | | | X | 97 |
| | 3-Methylbutan-2-ol | X | | | | | | | | | | | 80 |
| | | | X | | | | | | | | | | 96 |
| | | | | X | | | | | | | | | 83 |
| | | | | | X | | | | | | | | 94 |
| | | | | | | X | | | | | | | 59 |
| | | | | | | | X | | | | | | 34 |
| | | | | | | | | X | | | | | 29 |
| | | | | | | | | | X | | | | 83 |
| | | | | | | | | | | X | | | 85 |
| | | | | | | | | | | | X | | 94 |
| | | | | | | | | | | | | X | 97 |
| | Pentan-1-ol | X | | | | | | | | | | | 83 |
| | | | X | | | | | | | | | | 97 |
| | | | | X | | | | | | | | | 86 |
| | | | | | X | | | | | | | | 95 |
| | | | | | | X | | | | | | | 52 |
| | | | | | | | X | | | | | | 37 |
| | | | | | | | | X | | | | | 25 |
| | | | | | | | | | X | | | | 88 |
| | | | | | | | | | | X | | | 80 |
| | | | | | | | | | | | X | | 96 |
| | | | | | | | | | | | | X | 92 |
| | Pentan-2-ol | X | | | | | | | | | | | 82 |
| | | | X | | | | | | | | | | 90 |
| | | | | X | | | | | | | | | 80 |
| | | | | | X | | | | | | | | 97 |
| | | | | | | X | | | | | | | 51 |
| | | | | | | | X | | | | | | 34 |
| | | | | | | | | X | | | | | 20 |
| | | | | | | | | | X | | | | 85 |
| | | | | | | | | | | X | | | 88 |
| | | | | | | | | | | | X | | 97 |
| | | | | | | | | | | | | X | 94 |
| | Pentan-3-ol | X | | | | | | | | | | | 84 |
| | | | X | | | | | | | | | | 91 |
| | | | | X | | | | | | | | | 88 |
| | | | | | X | | | | | | | | 93 |
| | | | | | | X | | | | | | | 52 |
| | | | | | | | X | | | | | | 31 |
| | | | | | | | | X | | | | | 21 |
| | | | | | | | | | X | | | | 86 |
| | | | | | | | | | | X | | | 81 |
| | | | | | | | | | | | X | | 90 |
| | | | | | | | | | | | | X | 95 |
| | 2,2-Dimethylpropan-1-ol | X | | | | | | | | | | | 85 |
| | | | X | | | | | | | | | | 90 |
| | | | | X | | | | | | | | | 81 |
| | | | | | X | | | | | | | | 90 |
| | | | | | | X | | | | | | | 58 |
| | | | | | | | X | | | | | | 39 |
| | | | | | | | | X | | | | | 27 |
| | | | | | | | | | X | | | | 82 |
| | | | | | | | | | | X | | | 83 |
| | | | | | | | | | | | X | | 95 |
| | | | | | | | | | | | | X | 94 |
| | Hexan-1-ol | X | | | | | | | | | | | 89 |
| | | | X | | | | | | | | | | 98 |
| | | | | X | | | | | | | | | 87 |
| | | | | | X | | | | | | | | 98 |
| | | | | | | X | | | | | | | 56 |
| | | | | | | | X | | | | | | 38 |
| | | | | | | | | X | | | | | 23 |
| | | | | | | | | | X | | | | 84 |
| | | | | | | | | | | X | | | 89 |
| | | | | | | | | | | | X | | 93 |
| | | | | | | | | | | | | X | 90 |
| | Hexan-2-ol | X | | | | | | | | | | | 88 |
| | | | X | | | | | | | | | | 90 |
| | | | | X | | | | | | | | | 89 |
| | | | | | X | | | | | | | | 93 |
| | | | | | | X | | | | | | | 54 |
| | | | | | | | X | | | | | | 33 |
| | | | | | | | | X | | | | | 22 |
| | | | | | | | | | X | | | | 81 |
| | | | | | | | | | | X | | | 87 |
| | | | | | | | | | | | X | | 90 |
| | | | | | | | | | | | | X | 95 |
| | Hexan-3-ol | X | | | | | | | | | | | 86 |
| | | | X | | | | | | | | | | 95 |
| | | | | X | | | | | | | | | 82 |
| | | | | | X | | | | | | | | 95 |
| | | | | | | X | | | | | | | 50 |
| | | | | | | | X | | | | | | 38 |
| | | | | | | | | X | | | | | 23 |
| | | | | | | | | | X | | | | 83 |
| | | | | | | | | | | X | | | 85 |
| | | | | | | | | | | | X | | 91 |
| | | | | | | | | | | | | X | 91 |
| | 2-Methylpentan-1-ol | X | | | | | | | | | | | 87 |
| | | | X | | | | | | | | | | 94 |
| | | | | X | | | | | | | | | 84 |
| | | | | | X | | | | | | | | 96 |
| | | | | | | X | | | | | | | 57 |
| | | | | | | | X | | | | | | 32 |
| | | | | | | | | X | | | | | 24 |
| | | | | | | | | | X | | | | 85 |
| | | | | | | | | | | X | | | 86 |
| | | | | | | | | | | | X | | 93 |
| | | | | | | | | | | | | X | 96 |
| | 3-Methylpentan-1-ol | X | | | | | | | | | | | 81 |
| | | | X | | | | | | | | | | 92 |
| | | | | X | | | | | | | | | 83 |
| | | | | | X | | | | | | | | 92 |
| | | | | | | X | | | | | | | 55 |
| | | | | | | | X | | | | | | 36 |
| | | | | | | | | X | | | | | 28 |
| | | | | | | | | | X | | | | 82 |
| | | | | | | | | | | X | | | 85 |
| | | | | | | | | | | | X | | 95 |
| | | | | | | | | | | | | X | 92 |
| | 4-Methylpentan-1-ol | X | | | | | | | | | | | 83 |
| | | | X | | | | | | | | | | 90 |
| | | | | X | | | | | | | | | 85 |
| | | | | | X | | | | | | | | 91 |
| | | | | | | X | | | | | | | 58 |
| | | | | | | | X | | | | | | 30 |
| | | | | | | | | X | | | | | 26 |
| | | | | | | | | | X | | | | 89 |
| | | | | | | | | | | X | | | 88 |
| | | | | | | | | | | | X | | 91 |
| | | | | | | | | | | | | X | 95 |
| | 2-Methylpentan-2-ol | X | | | | | | | | | | | 85 |
| | | | X | | | | | | | | | | 97 |
| | | | | X | | | | | | | | | 83 |
| | | | | | X | | | | | | | | 94 |
| | | | | | | X | | | | | | | 58 |
| | | | | | | | X | | | | | | 30 |
| | | | | | | | | X | | | | | 26 |
| | | | | | | | | | X | | | | 83 |
| | | | | | | | | | | X | | | 80 |
| | | | | | | | | | | | X | | 94 |
| | | | | | | | | | | | | X | 96 |
| | 3-Methylpentan-2-ol | X | | | | | | | | | | | 80 |
| | | | X | | | | | | | | | | 92 |
| | | | | X | | | | | | | | | 88 |
| | | | | | X | | | | | | | | 96 |
| | | | | | | X | | | | | | | 55 |
| | | | | | | | X | | | | | | 34 |
| | | | | | | | | X | | | | | 29 |
| | | | | | | | | | X | | | | 86 |
| | | | | | | | | | | X | | | 83 |
| | | | | | | | | | | | X | | 95 |
| | | | | | | | | | | | | X | 97 |
| | 4-Methylpentan-2-ol | X | | | | | | | | | | | 88 |
| | | | X | | | | | | | | | | 94 |
| | | | | X | | | | | | | | | 85 |
| | | | | | X | | | | | | | | 97 |
| | | | | | | X | | | | | | | 57 |
| | | | | | | | X | | | | | | 37 |
| | | | | | | | | X | | | | | 25 |
| | | | | | | | | | X | | | | 80 |
| | | | | | | | | | | X | | | 82 |
| | | | | | | | | | | | X | | 97 |
| | | | | | | | | | | | | X | 90 |
| | 2-Methylpentan-3-ol | X | | | | | | | | | | | 81 |
| | | | X | | | | | | | | | | 95 |
| | | | | X | | | | | | | | | 86 |
| | | | | | X | | | | | | | | 90 |
| | | | | | | X | | | | | | | 50 |
| | | | | | | | X | | | | | | 34 |
| | | | | | | | | X | | | | | 20 |
| | | | | | | | | | X | | | | 88 |
| | | | | | | | | | | X | | | 84 |
| | | | | | | | | | | | X | | 93 |
| | | | | | | | | | | | | X | 91 |
| | 3-Methylpentan-3-ol | X | | | | | | | | | | | 83 |
| | | | X | | | | | | | | | | 94 |
| | | | | X | | | | | | | | | 82 |
| | | | | | X | | | | | | | | 95 |
| | | | | | | X | | | | | | | 54 |
| | | | | | | | X | | | | | | 31 |
| | | | | | | | | X | | | | | 21 |
| | | | | | | | | | X | | | | 81 |
| | | | | | | | | | | X | | | 85 |
| | | | | | | | | | | | X | | 90 |
| | | | | | | | | | | | | X | 90 |
| | 2,2-Dimethylbutan-1-ol | X | | | | | | | | | | | 80 |
| | | | X | | | | | | | | | | 89 |
| | | | | X | | | | | | | | | 90 |
| | | | | | X | | | | | | | | 84 |
| | | | | | | X | | | | | | | 93 |
| | | | | | | | X | | | | | | 50 |
| | | | | | | | | X | | | | | 39 |
| | | | | | | | | | X | | | | 27 |
| | | | | | | | | | | X | | | 87 |
| | | | | | | | | | | | X | | 89 |
| | | | | | | | | | | | | X | 98 |
| | 2,3-Dimethylbutan-1-ol | X | | | | | | | | | | | 87 |
| | | | X | | | | | | | | | | 95 |
| | | | | X | | | | | | | | | 81 |
| | | | | | X | | | | | | | | 90 |
| | | | | | | X | | | | | | | 56 |
| | | | | | | | X | | | | | | 38 |
| | | | | | | | | X | | | | | 23 |
| | | | | | | | | | X | | | | 89 |
| | | | | | | | | | | X | | | 88 |
| | | | | | | | | | | | X | | 93 |
| | | | | | | | | | | | | X | 90 |
| | 3,3-Dimethylbutan-1-ol | X | | | | | | | | | | | 85 |
| | | | X | | | | | | | | | | 91 |
| | | | | X | | | | | | | | | 83 |
| | | | | | X | | | | | | | | 91 |
| | | | | | | X | | | | | | | 58 |
| | | | | | | | X | | | | | | 33 |
| | | | | | | | | X | | | | | 22 |
| | | | | | | | | | X | | | | 82 |
| | | | | | | | | | | X | | | 86 |
| | | | | | | | | | | | X | | 95 |
| | | | | | | | | | | | | X | 95 |
| | 2,3-Dimethylbutan-2-ol | X | | | | | | | | | | | 86 |
| | | | X | | | | | | | | | | 96 |
| | | | | X | | | | | | | | | 85 |
| | | | | | X | | | | | | | | 93 |
| | | | | | | X | | | | | | | 53 |
| | | | | | | | X | | | | | | 38 |
| | | | | | | | | X | | | | | 23 |
| | | | | | | | | | X | | | | 84 |
| | | | | | | | | | | X | | | 87 |
| | | | | | | | | | | | X | | 96 |
| | | | | | | | | | | | | X | 94 |
| | 3,3-Dimethylbutan-2-ol | X | | | | | | | | | | | 85 |
| | | | X | | | | | | | | | | 92 |
| | | | | X | | | | | | | | | 82 |
| | | | | | X | | | | | | | | 95 |
| | | | | | | X | | | | | | | 55 |
| | | | | | | | X | | | | | | 32 |
| | | | | | | | | X | | | | | 24 |
| | | | | | | | | | X | | | | 83 |
| | | | | | | | | | | X | | | 81 |
| | | | | | | | | | | | X | | 92 |
| | | | | | | | | | | | | X | 92 |
| | | X | | | | | | | | | | | 88 |
| | 2-Methyl-2-propanol | | X | | | | | | | | | | 95 |
| | | | | X | | | | | | | | | 89 |
| | | | | | X | | | | | | | | 91 |
| | | | | | | X | | | | | | | 52 |
| | | | | | | | X | | | | | | 36 |
| | | | | | | | | X | | | | | 28 |
| | | | | | | | | | X | | | | 85 |
| | | | | | | | | | | X | | | 83 |
| | | | | | | | | | | | X | | 91 |
| | | | | | | | | | | | | X | 90 |
| | 2-Methyl-2-propanol | X | | | | | | | | | | | 88 |
| | | | X | | | | | | | | | | 95 |
| | | | | X | | | | | | | | | 89 |
| | | | | | X | | | | | | | | 93 |
| | | | | | | X | | | | | | | 55 |
| | | | | | | | X | | | | | | 36 |
| | | | | | | | | X | | | | | 28 |
| | | | | | | | | | X | | | | 88 |
| | | | | | | | | | | X | | | 87 |
| | | | | | | | | | | | X | | 91 |
| | | | | | | | | | | | | X | 95 |
| | 2-Methyl-2-propanol | X | | | | | | | | | | | 85 |
| | | | X | | | | | | | | | | 92 |
| | | | | X | | | | | | | | | 85 |
| | | | | | X | | | | | | | | 90 |
| | | | | | | X | | | | | | | 52 |
| | | | | | | | X | | | | | | 38 |
| | | | | | | | | X | | | | | 26 |
| | | | | | | | | | X | | | | 81 |
| | | | | | | | | | | X | | | 81 |
| | | | | | | | | | | | X | | 94 |
| | | | | | | | | | | | | X | 92 |
| | 2-Methyl-2-propanol | X | | | | | | | | | | | 80 |
| | | | X | | | | | | | | | | 96 |
| | | | | X | | | | | | | | | 82 |
| | | | | | X | | | | | | | | 91 |
| | | | | | | X | | | | | | | 53 |
| | | | | | | | X | | | | | | 33 |
| | | | | | | | | X | | | | | 29 |
| | | | | | | | | | X | | | | 87 |
| | | | | | | | | | | X | | | 83 |
| | | | | | | | | | | | X | | 95 |
| | | | | | | | | | | | | X | 94 |
| | 2-Methyl-2-propanol | X | | | | | | | | | | | 88 |
| | | | X | | | | | | | | | | 97 |
| | | | | X | | | | | | | | | 83 |
| | | | | | X | | | | | | | | 93 |
| | | | | | | X | | | | | | | 58 |
| | | | | | | | X | | | | | | 32 |
| | | | | | | | | X | | | | | 25 |
| | | | | | | | | | X | | | | 89 |
| | | | | | | | | | | X | | | 80 |
| | | | | | | | | | | | X | | 97 |
| | | | | | | | | | | | | X | 96 |
| | 2-Methyl-2-propanol | X | | | | | | | | | | | 81 |
| | | | X | | | | | | | | | | 92 |
| | | | | X | | | | | | | | | 83 |
| | | | | | X | | | | | | | | 95 |
| | | | | | | X | | | | | | | 55 |
| | | | | | | | X | | | | | | 30 |
| | | | | | | | | X | | | | | 20 |
| | | | | | | | | | X | | | | 82 |
| | | | | | | | | | | X | | | 83 |
| | | | | | | | | | | | X | | 93 |
| | | | | | | | | | | | | X | 97 |
| | 2-Methyl-2-propanol | X | | | | | | | | | | | 83 |
| | | | X | | | | | | | | | | 94 |
| | | | | X | | | | | | | | | 88 |
| | | | | | X | | | | | | | | 91 |
| | | | | | | X | | | | | | | 57 |
| | | | | | | | X | | | | | | 34 |
| | | | | | | | | X | | | | | 21 |
| | | | | | | | | | X | | | | 84 |
| | | | | | | | | | | X | | | 82 |
| | | | | | | | | | | | X | | 90 |
| | | | | | | | | | | | | X | 90 |
| | 2-Methyl-2-propanol | X | | | | | | | | | | | 89 |
| | | | X | | | | | | | | | | 95 |
| | | | | X | | | | | | | | | 85 |
| | | | | | X | | | | | | | | 94 |
| | | | | | | X | | | | | | | 50 |
| | | | | | | | X | | | | | | 37 |
| | | | | | | | | X | | | | | 27 |
| | | | | | | | | | X | | | | 83 |
| | | | | | | | | | | X | | | 84 |
| | | | | | | | | | | | X | | 98 |
| | | | | | | | | | | | | X | 91 |
| | 2-Methyl-2-propanol | X | | | | | | | | | | | 87 |
| | | | X | | | | | | | | | | 94 |
| | | | | X | | | | | | | | | 86 |
| | | | | | X | | | | | | | | 96 |
| | | | | | | X | | | | | | | 54 |
| | | | | | | | X | | | | | | 34 |
| | | | | | | | | X | | | | | 23 |
| | | | | | | | | | X | | | | 85 |
| | | | | | | | | | | X | | | 85 |
| | | | | | | | | | | | X | | 93 |
| | | | | | | | | | | | | X | 90 |
| | 2-Methyl-2-propanol | X | | | | | | | | | | | 85 |
| | | | X | | | | | | | | | | 90 |
| | | | | X | | | | | | | | | 82 |
| | | | | | X | | | | | | | | 97 |
| | | | | | | X | | | | | | | 50 |
| | | | | | | | X | | | | | | 31 |
| | | | | | | | | X | | | | | 22 |
| | | | | | | | | | X | | | | 83 |
| | | | | | | | | | | X | | | 89 |
| | | | | | | | | | | | X | | 95 |
| | | | | | | | | | | | | X | 98 |
| | 2-Methyl-2-propanol | X | | | | | | | | | | | 86 |
| | | | X | | | | | | | | | | 95 |
| | | | | X | | | | | | | | | 84 |
| | | | | | X | | | | | | | | 90 |
| | | | | | | X | | | | | | | 56 |
| | | | | | | | X | | | | | | 39 |
| | | | | | | | | X | | | | | 23 |
| | | | | | | | | | X | | | | 86 |
| | | | | | | | | | | X | | | 88 |
| | | | | | | | | | | | X | | 96 |
| | | | | | | | | | | | | X | 90 |
| | 2-Methyl-2-propanol | X | | | | | | | | | | | 85 |
| | | | X | | | | | | | | | | 91 |
| | | | | X | | | | | | | | | 81 |
| | | | | | X | | | | | | | | 95 |
| | | | | | | X | | | | | | | 58 |
| | | | | | | | X | | | | | | 38 |
| | | | | | | | | X | | | | | 24 |
| | | | | | | | | | X | | | | 80 |
| | | | | | | | | | | X | | | 86 |
| | | | | | | | | | | | X | | 92 |
| | | | | | | | | | | | | X | 95 |
| | 2-Methyl-2-propanol | X | | | | | | | | | | | 87 |
| | | | X | | | | | | | | | | 90 |
| | | | | X | | | | | | | | | 87 |
| | | | | | X | | | | | | | | 95 |
| | | | | | | X | | | | | | | 50 |
| | | | | | | | X | | | | | | 37 |
| | | | | | | | | X | | | | | 24 |
| | | | | | | | | | X | | | | 89 |
| | | | | | | | | | | X | | | 88 |
| | | | | | | | | | | | X | | 93 |
| | | | | | | | | | | | | X | 91 |
| | 2-Methyl-2-propanol | X | | | | | | | | | | | 81 |
| | | | X | | | | | | | | | | 98 |
| | | | | X | | | | | | | | | 85 |
| | | | | | X | | | | | | | | 92 |
| | | | | | | X | | | | | | | 54 |
| | | | | | | | X | | | | | | 34 |
| | | | | | | | | X | | | | | 23 |
| | | | | | | | | | X | | | | 85 |
| | | | | | | | | | | X | | | 81 |
| | | | | | | | | | | | X | | 90 |
| | | | | | | | | | | | | X | 94 |
| | 3,3-Dimethylbutan-2-ol | X | | | | | | | | | | | 83 |
| | | | X | | | | | | | | | | 95 |
| | | | | X | | | | | | | | | 88 |
| | | | | | X | | | | | | | | 96 |
| | | | | | | X | | | | | | | 50 |
| | | | | | | | X | | | | | | 31 |
| | | | | | | | | X | | | | | 28 |
| | | | | | | | | | X | | | | 82 |
| | | | | | | | | | | X | | | 87 |
| | | | | | | | | | | | X | | 91 |
| | | | | | | | | | | | | X | 95 |
| | 2-Ethylbutan-1-ol | X | | | | | | | | | | | 80 |
| | | | X | | | | | | | | | | 90 |
| | | | | X | | | | | | | | | 80 |
| | | | | | X | | | | | | | | 90 |
| | | | | | | X | | | | | | | 50 |
| | | | | | | | X | | | | | | 30 |
| | | | | | | | | X | | | | | 20 |
| | | | | | | | | | X | | | | 80 |
| | | | | | | | | | | X | | | 80 |
| | | | | | | | | | | | X | | 90 |
| | | | | | | | | | | | | X | 90 |
| | Cyclohexanol | X | | | | | | | | | | | 80 |
| | | | X | | | | | | | | | | 90 |
| | | | | X | | | | | | | | | 85 |
| | | | | | X | | | | | | | | 97 |
| | | | | | | X | | | | | | | 56 |
| | | | | | | | X | | | | | | 39 |
| | | | | | | | | X | | | | | 26 |
| | | | | | | | | | X | | | | 83 |
| | | | | | | | | | | X | | | 89 |
| | | | | | | | | | | | X | | 93 |
| | | | | | | | | | | | | X | 97 |
| | Heptan-1-ol | X | | | | | | | | | | | 83 |
| | | | X | | | | | | | | | | 95 |
| | | | | X | | | | | | | | | 88 |
| | | | | | X | | | | | | | | 92 |
| | | | | | | X | | | | | | | 58 |
| | | | | | | | X | | | | | | 38 |
| | | | | | | | | X | | | | | 29 |
| | | | | | | | | | X | | | | 83 |
| | | | | | | | | | | X | | | 82 |
| | | | | | | | | | | | X | | 95 |
| | | | | | | | | | | | | X | 93 |
| | Heptan-2-ol | X | | | | | | | | | | | 80 |
| | | | X | | | | | | | | | | 90 |
| | | | | X | | | | | | | | | 80 |
| | | | | | X | | | | | | | | 90 |
| | | | | | | X | | | | | | | 50 |
| | | | | | | | X | | | | | | 30 |
| | | | | | | | | X | | | | | 20 |
| | | | | | | | | | X | | | | 80 |
| | | | | | | | | | | X | | | 80 |
| | | | | | | | | | | | X | | 90 |
| | | | | | | | | | | | | X | 90 |
| | Heptan-3-ol | X | | | | | | | | | | | 82 |
| | | | X | | | | | | | | | | 92 |
| | | | | X | | | | | | | | | 85 |
| | | | | | X | | | | | | | | 94 |
| | | | | | | X | | | | | | | 55 |
| | | | | | | | X | | | | | | 36 |
| | | | | | | | | X | | | | | 25 |
| | | | | | | | | | X | | | | 88 |
| | | | | | | | | | | X | | | 84 |
| | | | | | | | | | | | X | | 91 |
| | | | | | | | | | | | | X | 90 |
| | 1,1,1,3,3,3-Hexafluoro-propan-2-ol | X | | | | | | | | | | | 84 |
| | | | X | | | | | | | | | | 94 |
| | | | | X | | | | | | | | | 80 |
| | | | | | X | | | | | | | | 95 |
| | | | | | | X | | | | | | | 52 |
| | | | | | | | X | | | | | | 38 |
| | | | | | | | | X | | | | | 20 |
| | | | | | | | | | X | | | | 85 |
| | | | | | | | | | | X | | | 83 |
| | | | | | | | | | | | X | | 94 |
| | | | | | | | | | | | | X | 98 |
| | | X | | | | | | | | | | | 85 |
| | | | X | | | | | | | | | | 96 |
| | 1,1,1,3,3,3-Hexafluoro-2—(trifluoromethyl)-propan-2-ol | | | X | | | | | | | | | 88 |
| | | | | | X | | | | | | | | 94 |
| | | | | | | X | | | | | | | 53 |
| | | | | | | | X | | | | | | 33 |
| | | | | | | | | X | | | | | 21 |
| | | | | | | | | | X | | | | 86 |
| | | | | | | | | | | X | | | 85 |
| | | | | | | | | | | | X | | 96 |
| | | | | | | | | | | | | X | 93 |
| | 2-Fluoroethanol | X | | | | | | | | | | | 85 |
| | | | X | | | | | | | | | | 96 |
| | | | | X | | | | | | | | | 88 |
| | | | | | X | | | | | | | | 94 |
| | | | | | | X | | | | | | | 53 |
| | | | | | | | X | | | | | | 33 |
| | | | | | | | | X | | | | | 21 |
| | | | | | | | | | X | | | | 86 |
| | | | | | | | | | | X | | | 85 |
| | | | | | | | | | | | X | | 96 |
| | | | | | | | | | | | | X | 93 |
| | 3-Fluoropropan-1-ol | X | | | | | | | | | | | 89 |
| | | | X | | | | | | | | | | 97 |
| | | | | X | | | | | | | | | 81 |
| | | | | | X | | | | | | | | 90 |
| | | | | | | X | | | | | | | 58 |
| | | | | | | | X | | | | | | 32 |
| | | | | | | | | X | | | | | 27 |
| | | | | | | | | | X | | | | 82 |
| | | | | | | | | | | X | | | 83 |
| | | | | | | | | | | | X | | 97 |
| | | | | | | | | | | | | X | 95 |
| | 4-Fluoro-1-butanol | X | | | | | | | | | | | 88 |
| | | | X | | | | | | | | | | 90 |
| | | | | X | | | | | | | | | 83 |
| | | | | | X | | | | | | | | 95 |
| | | | | | | X | | | | | | | 55 |
| | | | | | | | X | | | | | | 30 |
| | | | | | | | | X | | | | | 23 |
| | | | | | | | | | X | | | | 84 |
| | | | | | | | | | | X | | | 86 |
| | | | | | | | | | | | X | | 90 |
| | | | | | | | | | | | | X | 96 |
| | (2,2-Dichloro-3,3-dimethylcyclopropyl)m ethanol | X | | | | | | | | | | | 86 |
| | | | X | | | | | | | | | | 91 |
| | | | | X | | | | | | | | | 89 |
| | | | | | X | | | | | | | | 91 |
| | | | | | | X | | | | | | | 57 |
| | | | | | | | X | | | | | | 34 |
| | | | | | | | | X | | | | | 22 |
| | | | | | | | | | X | | | | 81 |
| | | | | | | | | | | X | | | 80 |
| | | | | | | | | | | | X | | 95 |
| | | | | | | | | | | | | X | 92 |
| | (2,2-Dichloro-1-phenylcyclopropyl)met hanol | X | | | | | | | | | | | 84 |
| | | | X | | | | | | | | | | 89 |
| | | | | X | | | | | | | | | 81 |
| | | | | | X | | | | | | | | 91 |
| | | | | | | X | | | | | | | 56 |
| | | | | | | | X | | | | | | 38 |
| | | | | | | | | X | | | | | 29 |
| | | | | | | | | | X | | | | 86 |
| | | | | | | | | | | X | | | 83 |
| | | | | | | | | | | | X | | 94 |
| | | | | | | | | | | | | X | 93 |
| | 1,1,5-Trihydroperfluorpentan ol | X | | | | | | | | | | | 85 |
| | | | X | | | | | | | | | | 95 |
| | | | | X | | | | | | | | | 83 |
| | | | | | X | | | | | | | | 95 |
| | | | | | | X | | | | | | | 58 |
| | | | | | | | X | | | | | | 33 |
| | | | | | | | | X | | | | | 25 |
| | | | | | | | | | X | | | | 82 |
| | | | | | | | | | | X | | | 86 |
| | | | | | | | | | | | X | | 96 |
| | | | | | | | | | | | | X | 89 |
| | 6-Chloro-1-hexanol | X | | | | | | | | | | | 89 |
| | | | X | | | | | | | | | | 92 |
| | | | | X | | | | | | | | | 89 |
| | | | | | X | | | | | | | | 92 |
| | | | | | | X | | | | | | | 55 |
| | | | | | | | X | | | | | | 32 |
| | | | | | | | | X | | | | | 20 |
| | | | | | | | | | X | | | | 84 |
| | | | | | | | | | | X | | | 80 |
| | | | | | | | | | | | X | | 97 |
| | | | | | | | | | | | | X | 98 |
| | | X | | | | | | | | | | | 88 |
| | 6-Bromo-1-hexanol | | X | | | | | | | | | | 94 |
| | | | | X | | | | | | | | | 87 |
| | | | | | X | | | | | | | | 96 |
| | | | | | | X | | | | | | | 52 |
| | | | | | | | X | | | | | | 30 |
| | | | | | | | | X | | | | | 21 |
| | | | | | | | | | X | | | | 81 |
| | | | | | | | | | | X | | | 88 |
| | | | | | | | | | | | X | | 89 |
| | | | | | | | | | | | | X | 93 |
| | 8-Chloro-1-octanol | X | | | | | | | | | | | 86 |
| | | | X | | | | | | | | | | 96 |
| | | | | X | | | | | | | | | 85 |
| | | | | | X | | | | | | | | 97 |
| | | | | | | X | | | | | | | 53 |
| | | | | | | | X | | | | | | 34 |
| | | | | | | | | X | | | | | 27 |
| | | | | | | | | | X | | | | 85 |
| | | | | | | | | | | X | | | 81 |
| | | | | | | | | | | | X | | 95 |
| | | | | | | | | | | | | X | 95 |
| | 8-Bromo-1-octanol | X | | | | | | | | | | | 87 |
| | | | X | | | | | | | | | | 97 |
| | | | | X | | | | | | | | | 88 |
| | | | | | X | | | | | | | | 92 |
| | | | | | | X | | | | | | | 58 |
| | | | | | | | X | | | | | | 37 |
| | | | | | | | | X | | | | | 23 |
| | | | | | | | | | X | | | | 82 |
| | | | | | | | | | | X | | | 87 |
| | | | | | | | | | | | X | | 93 |
| | | | | | | | | | | | | X | 96 |
| | 2-Methyl-2-propanol | X | | | | | | | | | | | 81 |
| | | | X | | | | | | | | | | 89 |
| | | | | X | | | | | | | | | 85 |
| | | | | | X | | | | | | | | 94 |
| | | | | | | X | | | | | | | 55 |
| | | | | | | | X | | | | | | 34 |
| | | | | | | | | X | | | | | 22 |
| | | | | | | | | | X | | | | 83 |
| | | | | | | | | | | X | | | 89 |
| | | | | | | | | | | | X | | 89 |
| | | | | | | | | | | | | X | 92 |
| | 10-Chloro-1-decanol | X | | | | | | | | | | | 83 |
| | | | X | | | | | | | | | | 91 |
| | | | | X | | | | | | | | | 88 |
| | | | | | X | | | | | | | | 95 |
| | | | | | | X | | | | | | | 57 |
| | | | | | | | X | | | | | | 31 |
| | | | | | | | | X | | | | | 24 |
| | | | | | | | | | X | | | | 83 |
| | | | | | | | | | | X | | | 82 |
| | | | | | | | | | | | X | | 91 |
| | | | | | | | | | | | | X | 91 |
| | 10-Bromo-1-decanol | X | | | | | | | | | | | 80 |
| | | | X | | | | | | | | | | 89 |
| | | | | X | | | | | | | | | 85 |
| | | | | | X | | | | | | | | 94 |
| | | | | | | X | | | | | | | 50 |
| | | | | | | | X | | | | | | 39 |
| | | | | | | | | X | | | | | 23 |
| | | | | | | | | | X | | | | 88 |
| | | | | | | | | | | X | | | 84 |
| | | | | | | | | | | | X | | 93 |
| | | | | | | | | | | | | X | 94 |
| | 4-Trifluoromethan-cyclohexan-1-ol | X | | | | | | | | | | | 83 |
| | | | X | | | | | | | | | | 98 |
| | | | | X | | | | | | | | | 80 |
| | | | | | X | | | | | | | | 89 |
| | | | | | | X | | | | | | | 54 |
| | | | | | | | X | | | | | | 38 |
| | | | | | | | | X | | | | | 28 |
| | | | | | | | | | X | | | | 85 |
| | | | | | | | | | | X | | | 83 |
| | | | | | | | | | | | X | | 95 |
| | | | | | | | | | | | | X | 95 |
| | Ethylene glycol monomethyl ether | X | | | | | | | | | | | 82 |
| | | | X | | | | | | | | | | 95 |
| | | | | X | | | | | | | | | 88 |
| | | | | | X | | | | | | | | 95 |
| | | | | | | X | | | | | | | 50 |
| | | | | | | | X | | | | | | 36 |
| | | | | | | | | X | | | | | 26 |
| | | | | | | | | | X | | | | 89 |
| | | | | | | | | | | X | | | 85 |
| | | | | | | | | | | | X | | 91 |
| | | | | | | | | | | | | X | 97 |
| | Ethylene glycol ethyl ether | X | | | | | | | | | | | 83 |
| | | | X | | | | | | | | | | 93 |
| | | | | X | | | | | | | | | 84 |
| | | | | | X | | | | | | | | 90 |
| | | | | | | X | | | | | | | 57 |
| | | | | | | | X | | | | | | 40 |
| | | | | | | | | X | | | | | 22 |
| | | | | | | | | | X | | | | 81 |
| | | | | | | | | | | X | | | 86 |
| | | | | | | | | | | | X | | 91 |
| | | | | | | | | | | | | X | 94 |
| | Ethylene glycol monopropyl ether | X | | | | | | | | | | | 86 |
| | | | X | | | | | | | | | | 90 |
| | | | | X | | | | | | | | | 85 |
| | | | | | X | | | | | | | | 95 |
| | | | | | | X | | | | | | | 59 |
| | | | | | | | X | | | | | | 38 |
| | | | | | | | | X | | | | | 24 |
| | | | | | | | | | X | | | | 83 |
| | | | | | | | | | | X | | | 82 |
| | | | | | | | | | | | X | | 95 |
| | | | | | | | | | | | | X | 96 |
| | Ethylene glycol monoisopropyl ether | X | | | | | | | | | | | 80 |
| | | | X | | | | | | | | | | 98 |
| | | | | X | | | | | | | | | 89 |
| | | | | | X | | | | | | | | 92 |
| | | | | | | X | | | | | | | 54 |
| | | | | | | | X | | | | | | 35 |
| | | | | | | | | X | | | | | 23 |
| | | | | | | | | | X | | | | 89 |
| | | | | | | | | | | X | | | 84 |
| | | | | | | | | | | | X | | 92 |
| | | | | | | | | | | | | X | 97 |
| | Ethylene glycol monobutyl ether | X | | | | | | | | | | | 88 |
| | | | X | | | | | | | | | | 93 |
| | | | | X | | | | | | | | | 88 |
| | | | | | X | | | | | | | | 94 |
| | | | | | | X | | | | | | | 50 |
| | | | | | | | X | | | | | | 38 |
| | | | | | | | | X | | | | | 28 |
| | | | | | | | | | X | | | | 87 |
| | | | | | | | | | | X | | | 81 |
| | | | | | | | | | | | X | | 96 |
| | | | | | | | | | | | | X | 90 |
| | Ethylene glycol monopentyl ether | X | | | | | | | | | | | 80 |
| | | | X | | | | | | | | | | 90 |
| | | | | X | | | | | | | | | 80 |
| | | | | | X | | | | | | | | 90 |
| | | | | | | X | | | | | | | 50 |
| | | | | | | | X | | | | | | 30 |
| | | | | | | | | X | | | | | 20 |
| | | | | | | | | | X | | | | 80 |
| | | | | | | | | | | X | | | 80 |
| | | | | | | | | | | | X | | 90 |
| | | | | | | | | | | | | X | 90 |
| | Ethylene glycol monohexyl ether | X | | | | | | | | | | | 81 |
| | | | X | | | | | | | | | | 95 |
| | | | | X | | | | | | | | | 86 |
| | | | | | X | | | | | | | | 96 |
| | | | | | | X | | | | | | | 56 |
| | | | | | | | X | | | | | | 33 |
| | | | | | | | | X | | | | | 26 |
| | | | | | | | | | X | | | | 85 |
| | | | | | | | | | | X | | | 85 |
| | | | | | | | | | | | X | | 97 |
| | | | | | | | | | | | | X | 95 |
| | ethylene glycol monobenzyl ether | X | | | | | | | | | | | 87 |
| | | | X | | | | | | | | | | 96 |
| | | | | X | | | | | | | | | 87 |
| | | | | | X | | | | | | | | 97 |
| | | | | | | X | | | | | | | 58 |
| | | | | | | | X | | | | | | 32 |
| | | | | | | | | X | | | | | 30 |
| | | | | | | | | | X | | | | 88 |
| | | | | | | | | | | X | | | 82 |
| | | | | | | | | | | | X | | 92 |
| | | | | | | | | | | | | X | 93 |
| | diethylene glycol monomethyl ether | X | | | | | | | | | | | 89 |
| | | | X | | | | | | | | | | 92 |
| | | | | X | | | | | | | | | 81 |
| | | | | | X | | | | | | | | 90 |
| | | | | | | X | | | | | | | 55 |
| | | | | | | | X | | | | | | 30 |
| | | | | | | | | X | | | | | 25 |
| | | | | | | | | | X | | | | 85 |
| | | | | | | | | | | X | | | 83 |
| | | | | | | | | | | | X | | 94 |
| | | | | | | | | | | | | X | 90 |
| | diethylene glycol monoethyl ether | X | | | | | | | | | | | 82 |
| | | | X | | | | | | | | | | 91 |
| | | | | X | | | | | | | | | 83 |
| | | | | | X | | | | | | | | 91 |
| | | | | | | X | | | | | | | 52 |
| | | | | | | | X | | | | | | 34 |
| | | | | | | | | X | | | | | 20 |
| | | | | | | | | | X | | | | 88 |
| | | | | | | | | | | X | | | 83 |
| | | | | | | | | | | | X | | 95 |
| | | | | | | | | | | | | X | 91 |
| | diethylene glycol monopropyl ether | X | | | | | | | | | | | 84 |
| | | | X | | | | | | | | | | 94 |
| | | | | X | | | | | | | | | 80 |
| | | | | | X | | | | | | | | 95 |
| | | | | | | X | | | | | | | 53 |
| | | | | | | | X | | | | | | 37 |
| | | | | | | | | X | | | | | 21 |
| | | | | | | | | | X | | | | 85 |
| | | | | | | | | | | X | | | 88 |
| | | | | | | | | | | | X | | 94 |
| | | | | | | | | | | | | X | 93 |
| | diethylene glycol monoisopropyl ether | X | | | | | | | | | | | 83 |
| | | | X | | | | | | | | | | 95 |
| | | | | X | | | | | | | | | 83 |
| | | | | | X | | | | | | | | 98 |
| | | | | | | X | | | | | | | 58 |
| | | | | | | | X | | | | | | 34 |
| | | | | | | | | X | | | | | 27 |
| | | | | | | | | | X | | | | 80 |
| | | | | | | | | | | X | | | 85 |
| | | | | | | | | | | | X | | 90 |
| | | | | | | | | | | | | X | 95 |
| | diethylene glycol monobutyl ether | X | | | | | | | | | | | 85 |
| | | | X | | | | | | | | | | 97 |
| | | | | X | | | | | | | | | 82 |
| | | | | | X | | | | | | | | 95 |
| | | | | | | X | | | | | | | 55 |
| | | | | | | | X | | | | | | 31 |
| | | | | | | | | X | | | | | 23 |
| | | | | | | | | | X | | | | 88 |
| | | | | | | | | | | X | | | 89 |
| | | | | | | | | | | | X | | 95 |
| | | | | | | | | | | | | X | 91 |
| | diethylene glycol monopentyl ether | X | | | | | | | | | | | 88 |
| | | | X | | | | | | | | | | 94 |
| | | | | X | | | | | | | | | 86 |
| | | | | | X | | | | | | | | 91 |
| | | | | | | X | | | | | | | 55 |
| | | | | | | | X | | | | | | 39 |
| | | | | | | | | X | | | | | 22 |
| | | | | | | | | | X | | | | 85 |
| | | | | | | | | | | X | | | 86 |
| | | | | | | | | | | | X | | 95 |
| | | | | | | | | | | | | X | 95 |
| | | X | | | | | | | | | | | 81 |
| | | | X | | | | | | | | | | 95 |
| | diethylene glycol monohexyl ether | | | X | | | | | | | | | 87 |
| | | | | | X | | | | | | | | 95 |
| | | | | | | X | | | | | | | 50 |
| | | | | | | | X | | | | | | 38 |
| | | | | | | | | X | | | | | 24 |
| | | | | | | | | | X | | | | 88 |
| | | | | | | | | | | X | | | 82 |
| | | | | | | | | | | | X | | 94 |
| | | | | | | | | | | | | X | 93 |
| | diethylene glycol monophenyl ether | X | | | | | | | | | | | 87 |
| | | | X | | | | | | | | | | 97 |
| | | | | X | | | | | | | | | 81 |
| | | | | | X | | | | | | | | 98 |
| | | | | | | X | | | | | | | 54 |
| | | | | | | | X | | | | | | 35 |
| | | | | | | | | X | | | | | 23 |
| | | | | | | | | | X | | | | 85 |
| | | | | | | | | | | X | | | 83 |
| | | | | | | | | | | | X | | 90 |
| | | | | | | | | | | | | X | 90 |
| | diethylene glycol monobenzyl ether | X | | | | | | | | | | | 89 |
| | | | X | | | | | | | | | | 93 |
| | | | | X | | | | | | | | | 83 |
| | | | | | X | | | | | | | | 95 |
| | | | | | | X | | | | | | | 50 |
| | | | | | | | X | | | | | | 38 |
| | | | | | | | | X | | | | | 28 |
| | | | | | | | | | X | | | | 80 |
| | | | | | | | | | | X | | | 83 |
| | | | | | | | | | | | X | | 95 |
| | | | | | | | | | | | | X | 91 |
| | propylene glycol monoethyl ether | X | | | | | | | | | | | 82 |
| | | | X | | | | | | | | | | 90 |
| | | | | X | | | | | | | | | 80 |
| | | | | | X | | | | | | | | 90 |
| | | | | | | X | | | | | | | 56 |
| | | | | | | | X | | | | | | 33 |
| | | | | | | | | X | | | | | 26 |
| | | | | | | | | | X | | | | 88 |
| | | | | | | | | | | X | | | 88 |
| | | | | | | | | | | | X | | 91 |
| | | | | | | | | | | | | X | 93 |
| | propylene glycol monopropyl ether | X | | | | | | | | | | | 84 |
| | | | X | | | | | | | | | | 97 |
| | | | | X | | | | | | | | | 83 |
| | | | | | X | | | | | | | | 95 |
| | | | | | | X | | | | | | | 58 |
| | | | | | | | X | | | | | | 32 |
| | | | | | | | | X | | | | | 29 |
| | | | | | | | | | X | | | | 81 |
| | | | | | | | | | | X | | | 85 |
| | | | | | | | | | | | X | | 95 |
| | | | | | | | | | | | | X | 95 |
| | propylene glycol monoisopropyl ether | X | | | | | | | | | | | 83 |
| | | | X | | | | | | | | | | 93 |
| | | | | X | | | | | | | | | 82 |
| | | | | | X | | | | | | | | 92 |
| | | | | | | X | | | | | | | 55 |
| | | | | | | | X | | | | | | 30 |
| | | | | | | | | X | | | | | 25 |
| | | | | | | | | | X | | | | 83 |
| | | | | | | | | | | X | | | 89 |
| | | | | | | | | | | | X | | 92 |
| | | | | | | | | | | | | X | 91 |
| | propylene glycol monobutyl ether | X | | | | | | | | | | | 85 |
| | | | X | | | | | | | | | | 95 |
| | | | | X | | | | | | | | | 84 |
| | | | | | X | | | | | | | | 94 |
| | | | | | | X | | | | | | | 52 |
| | | | | | | | X | | | | | | 34 |
| | | | | | | | | X | | | | | 19 |
| | | | | | | | | | X | | | | 89 |
| | | | | | | | | | | X | | | 82 |
| | | | | | | | | | | | X | | 96 |
| | | | | | | | | | | | | X | 94 |
| | propylene glycol monopentyl ether | X | | | | | | | | | | | 83 |
| | | | X | | | | | | | | | | 96 |
| | | | | X | | | | | | | | | 85 |
| | | | | | X | | | | | | | | 96 |
| | | | | | | X | | | | | | | 53 |
| | | | | | | | X | | | | | | 35 |
| | | | | | | | | X | | | | | 21 |
| | | | | | | | | | X | | | | 87 |
| | | | | | | | | | | X | | | 84 |
| | | | | | | | | | | | X | | 97 |
| | | | | | | | | | | | | X | 96 |
| | | X | | | | | | | | | | | 86 |
| | propylene glycol monohexyl ether | | X | | | | | | | | | | 92 |
| | | | | X | | | | | | | | | 89 |
| | | | | | X | | | | | | | | 97 |
| | | | | | | X | | | | | | | 58 |
| | | | | | | | X | | | | | | 34 |
| | | | | | | | | X | | | | | 25 |
| | | | | | | | | | X | | | | 85 |
| | | | | | | | | | | X | | | 81 |
| | | | | | | | | | | | X | | 92 |
| | | | | | | | | | | | | X | 97 |
| | propylene glycol monophenyl ether | X | | | | | | | | | | | 80 |
| | | | X | | | | | | | | | | 91 |
| | | | | X | | | | | | | | | 88 |
| | | | | | X | | | | | | | | 90 |
| | | | | | | X | | | | | | | 55 |
| | | | | | | | X | | | | | | 31 |
| | | | | | | | | X | | | | | 23 |
| | | | | | | | | | X | | | | 88 |
| | | | | | | | | | | X | | | 85 |
| | | | | | | | | | | | X | | 94 |
| | | | | | | | | | | | | X | 90 |
| | propylene glycol monobenzyl ether | X | | | | | | | | | | | 83 |
| | | | X | | | | | | | | | | 96 |
| | | | | X | | | | | | | | | 86 |
| | | | | | X | | | | | | | | 92 |
| | | | | | | X | | | | | | | 55 |
| | | | | | | | X | | | | | | 35 |
| | | | | | | | | X | | | | | 20 |
| | | | | | | | | | X | | | | 81 |
| | | | | | | | | | | X | | | 85 |
| | | | | | | | | | | | X | | 97 |
| | | | | | | | | | | | | X | 94 |
| | iso-propylene glycol monomethyl ether | X | | | | | | | | | | | 86 |
| | | | X | | | | | | | | | | 92 |
| | | | | X | | | | | | | | | 87 |
| | | | | | X | | | | | | | | 94 |
| | | | | | | X | | | | | | | 52 |
| | | | | | | | X | | | | | | 34 |
| | | | | | | | | X | | | | | 21 |
| | | | | | | | | | X | | | | 83 |
| | | | | | | | | | | X | | | 84 |
| | | | | | | | | | | | X | | 92 |
| | | | | | | | | | | | | X | 93 |
| | iso-propylene glycol monoethyl ether | X | | | | | | | | | | | 80 |
| | | | X | | | | | | | | | | 91 |
| | | | | X | | | | | | | | | 81 |
| | | | | | X | | | | | | | | 96 |
| | | | | | | X | | | | | | | 53 |
| | | | | | | | X | | | | | | 31 |
| | | | | | | | | X | | | | | 25 |
| | | | | | | | | | X | | | | 89 |
| | | | | | | | | | | X | | | 81 |
| | | | | | | | | | | | X | | 94 |
| | | | | | | | | | | | | X | 89 |
| | iso-propylene glycol monopropyl ether | X | | | | | | | | | | | 88 |
| | | | X | | | | | | | | | | 94 |
| | | | | X | | | | | | | | | 83 |
| | | | | | X | | | | | | | | 97 |
| | | | | | | X | | | | | | | 58 |
| | | | | | | | X | | | | | | 39 |
| | | | | | | | | X | | | | | 23 |
| | | | | | | | | | X | | | | 87 |
| | | | | | | | | | | X | | | 85 |
| | | | | | | | | | | | X | | 95 |
| | | | | | | | | | | | | X | 91 |
| | iso-propylene glycol monoisopropyl ether | X | | | | | | | | | | | 81 |
| | | | X | | | | | | | | | | 95 |
| | | | | X | | | | | | | | | 80 |
| | | | | | X | | | | | | | | 89 |
| | | | | | | X | | | | | | | 55 |
| | | | | | | | X | | | | | | 38 |
| | | | | | | | | X | | | | | 22 |
| | | | | | | | | | X | | | | 85 |
| | | | | | | | | | | X | | | 86 |
| | | | | | | | | | | | X | | 94 |
| | | | | | | | | | | | | X | 93 |
| | iso-propylene glycol monobutyl ether | X | | | | | | | | | | | 87 |
| | | | X | | | | | | | | | | 97 |
| | | | | X | | | | | | | | | 83 |
| | | | | | X | | | | | | | | 91 |
| | | | | | | X | | | | | | | 55 |
| | | | | | | | X | | | | | | 35 |
| | | | | | | | | X | | | | | 24 |
| | | | | | | | | | X | | | | 88 |
| | | | | | | | | | | X | | | 82 |
| | | | | | | | | | | | X | | 90 |
| | | | | | | | | | | | | X | 95 |
| | iso-propylene glycol monopentyl ether | X | | | | | | | | | | | 89 |
| | | | X | | | | | | | | | | 93 |
| | | | | X | | | | | | | | | 82 |
| | | | | | X | | | | | | | | 95 |
| | | | | | | X | | | | | | | 50 |
| | | | | | | | X | | | | | | 38 |
| | | | | | | | | X | | | | | 23 |
| | | | | | | | | | X | | | | 85 |
| | | | | | | | | | | X | | | 83 |
| | | | | | | | | | | | X | | 95 |
| | | | | | | | | | | | | X | 91 |
| | iso-propylene glycol monohexyl ether | X | | | | | | | | | | | 82 |
| | | | X | | | | | | | | | | 90 |
| | | | | X | | | | | | | | | 84 |
| | | | | | X | | | | | | | | 98 |
| | | | | | | X | | | | | | | 54 |
| | | | | | | | X | | | | | | 33 |
| | | | | | | | | X | | | | | 28 |
| | | | | | | | | | X | | | | 88 |
| | | | | | | | | | | X | | | 83 |
| | | | | | | | | | | | X | | 91 |
| | | | | | | | | | | | | X | 94 |
| | iso-propylene glycol monophenyl ether | X | | | | | | | | | | | 84 |
| | | | X | | | | | | | | | | 97 |
| | | | | X | | | | | | | | | 85 |
| | | | | | X | | | | | | | | 95 |
| | | | | | | X | | | | | | | 50 |
| | | | | | | | X | | | | | | 32 |
| | | | | | | | | X | | | | | 26 |
| | | | | | | | | | X | | | | 85 |
| | | | | | | | | | | X | | | 88 |
| | | | | | | | | | | | X | | 95 |
| | | | | | | | | | | | | X | 96 |
| | dipropylene glycol monopropyl ether | X | | | | | | | | | | | 83 |
| | | | X | | | | | | | | | | 93 |
| | | | | X | | | | | | | | | 89 |
| | | | | | X | | | | | | | | 90 |
| | | | | | | X | | | | | | | 56 |
| | | | | | | | X | | | | | | 30 |
| | | | | | | | | X | | | | | 29 |
| | | | | | | | | | X | | | | 80 |
| | | | | | | | | | | X | | | 85 |
| | | | | | | | | | | | X | | 92 |
| | | | | | | | | | | | | X | 97 |
| | iso-propylene glycol monobenzyl ether | X | | | | | | | | | | | 85 |
| | | | X | | | | | | | | | | 95 |
| | | | | X | | | | | | | | | 88 |
| | | | | | X | | | | | | | | 95 |
| | | | | | | X | | | | | | | 58 |
| | | | | | | | X | | | | | | 34 |
| | | | | | | | | X | | | | | 25 |
| | | | | | | | | | X | | | | 88 |
| | | | | | | | | | | X | | | 89 |
| | | | | | | | | | | | X | | 96 |
| | | | | | | | | | | | | X | 90 |
| | dipropylene glycol monomethyl ether | X | | | | | | | | | | | 85 |
| | | | X | | | | | | | | | | 94 |
| | | | | X | | | | | | | | | 83 |
| | | | | | X | | | | | | | | 96 |
| | | | | | | X | | | | | | | 58 |
| | | | | | | | X | | | | | | 32 |
| | | | | | | | | X | | | | | 25 |
| | | | | | | | | | X | | | | 86 |
| | | | | | | | | | | X | | | 81 |
| | | | | | | | | | | | X | | 92 |
| | | | | | | | | | | | | X | 97 |
| | 1-methoxy-2-propanol | X | | | | | | | | | | | 84 |
| | | | X | | | | | | | | | | 93 |
| | | | | X | | | | | | | | | 86 |
| | | | | | X | | | | | | | | 92 |
| | | | | | | X | | | | | | | 55 |
| | | | | | | | X | | | | | | 34 |
| | | | | | | | | X | | | | | 20 |
| | | | | | | | | | X | | | | 87 |
| | | | | | | | | | | X | | | 83 |
| | | | | | | | | | | | X | | 94 |
| | | | | | | | | | | | | X | 92 |
| | tripropylene glycol monomethyl ether | X | | | | | | | | | | | 81 |
| | | | X | | | | | | | | | | 89 |
| | | | | X | | | | | | | | | 80 |
| | | | | | X | | | | | | | | 91 |
| | | | | | | X | | | | | | | 52 |
| | | | | | | | X | | | | | | 30 |
| | | | | | | | | X | | | | | 21 |
| | | | | | | | | | X | | | | 81 |
| | | | | | | | | | | X | | | 89 |
| | | | | | | | | | | | X | | 96 |
| | | | | | | | | | | | | X | 94 |
| | dipropylene glycol monobutyl ether | X | | | | | | | | | | | 85 |
| | | | X | | | | | | | | | | 91 |
| | | | | X | | | | | | | | | 88 |
| | | | | | X | | | | | | | | 94 |
| | | | | | | X | | | | | | | 53 |
| | | | | | | | X | | | | | | 35 |
| | | | | | | | | X | | | | | 25 |
| | | | | | | | | | X | | | | 83 |
| | | | | | | | | | | X | | | 87 |
| | | | | | | | | | | | X | | 97 |
| | | | | | | | | | | | | X | 95 |
| | 1-butoxy-2-propanol | X | | | | | | | | | | | 86 |
| | | | X | | | | | | | | | | 93 |
| | | | | X | | | | | | | | | 81 |
| | | | | | X | | | | | | | | 95 |
| | | | | | | X | | | | | | | 58 |
| | | | | | | | X | | | | | | 34 |
| | | | | | | | | X | | | | | 23 |
| | | | | | | | | | X | | | | 80 |
| | | | | | | | | | | X | | | 85 |
| | | | | | | | | | | | X | | 90 |
| | | | | | | | | | | | | X | 94 |
| | tripropylene glycol monobutyl ether | X | | | | | | | | | | | 82 |
| | | | X | | | | | | | | | | 95 |
| | | | | X | | | | | | | | | 87 |
| | | | | | X | | | | | | | | 97 |
| | | | | | | X | | | | | | | 55 |
| | | | | | | | X | | | | | | 31 |
| | | | | | | | | X | | | | | 22 |
| | | | | | | | | | X | | | | 83 |
| | | | | | | | | | | X | | | 88 |
| | | | | | | | | | | | X | | 91 |
| | | | | | | | | | | | | X | 95 |
| | 1-propoxy-2-propanol | X | | | | | | | | | | | 83 |
| | | | X | | | | | | | | | | 91 |
| | | | | X | | | | | | | | | 89 |
| | | | | | X | | | | | | | | 93 |
| | | | | | | X | | | | | | | 55 |
| | | | | | | | X | | | | | | 39 |
| | | | | | | | | X | | | | | 24 |
| | | | | | | | | | X | | | | 82 |
| | | | | | | | | | | X | | | 85 |
| | | | | | | | | | | | X | | 95 |
| | | | | | | | | | | | | X | 95 |
| | 1-methoxy-1-ethanol | X | | | | | | | | | | | 83 |
| | | | X | | | | | | | | | | 94 |
| | | | | X | | | | | | | | | 82 |
| | | | | | X | | | | | | | | 90 |
| | | | | | | X | | | | | | | 50 |
| | | | | | | | X | | | | | | 38 |
| | | | | | | | | X | | | | | 23 |
| | | | | | | | | | X | | | | 84 |
| | | | | | | | | | | X | | | 88 |
| | | | | | | | | | | | X | | 98 |
| | | | | | | | | | | | | X | 91 |
| | 1-Ethoxy-2-ethanol | X | | | | | | | | | | | 88 |
| | | | X | | | | | | | | | | 96 |
| | | | | X | | | | | | | | | 84 |
| | | | | | X | | | | | | | | 97 |
| | | | | | | X | | | | | | | 54 |
| | | | | | | | X | | | | | | 35 |
| | | | | | | | | X | | | | | 28 |
| | | | | | | | | | X | | | | 85 |
| | | | | | | | | | | X | | | 85 |
| | | | | | | | | | | | X | | 95 |
| | | | | | | | | | | | | X | 95 |
| | 1-Propoxy-2-ethanol | X | | | | | | | | | | | 85 |
| | | | X | | | | | | | | | | 97 |
| | | | | X | | | | | | | | | 83 |
| | | | | | X | | | | | | | | 93 |
| | | | | | | X | | | | | | | 50 |
| | | | | | | | X | | | | | | 38 |
| | | | | | | | | X | | | | | 26 |
| | | | | | | | | | X | | | | 89 |
| | | | | | | | | | | X | | | 80 |
| | | | | | | | | | | | X | | 90 |
| | | | | | | | | | | | | X | 92 |
| | 1-Butoxy-2-ethanol | X | | | | | | | | | | | 89 |
| | | | X | | | | | | | | | | 90 |
| | | | | X | | | | | | | | | 85 |
| | | | | | X | | | | | | | | 95 |
| | | | | | | X | | | | | | | 56 |
| | | | | | | | X | | | | | | 33 |
| | | | | | | | | X | | | | | 29 |
| | | | | | | | | | X | | | | 88 |
| | | | | | | | | | | X | | | 88 |
| | | | | | | | | | | | X | | 95 |
| | | | | | | | | | | | | X | 96 |
| | 1-Ethoxy-3-propanol | X | | | | | | | | | | | 89 |
| | | | X | | | | | | | | | | 95 |
| | | | | X | | | | | | | | | 85 |
| | | | | | X | | | | | | | | 90 |
| | | | | | | X | | | | | | | 56 |
| | | | | | | | X | | | | | | 31 |
| | | | | | | | | X | | | | | 30 |
| | | | | | | | | | X | | | | 82 |
| | | | | | | | | | | X | | | 88 |
| | | | | | | | | | | | X | | 91 |
| | | | | | | | | | | | | X | 96 |
| | 1-Propoxy-3-propanol | X | | | | | | | | | | | 85 |
| | | | X | | | | | | | | | | 91 |
| | | | | X | | | | | | | | | 83 |
| | | | | | X | | | | | | | | 97 |
| | | | | | | X | | | | | | | 58 |
| | | | | | | | X | | | | | | 39 |
| | | | | | | | | X | | | | | 25 |
| | | | | | | | | | X | | | | 84 |
| | | | | | | | | | | X | | | 81 |
| | | | | | | | | | | | X | | 95 |
| | | | | | | | | | | | | X | 97 |
| | 1-Methoxy-4-butanol | X | | | | | | | | | | | 84 |
| | | | X | | | | | | | | | | 84 |
| | | | | X | | | | | | | | | 86 |
| | | | | | X | | | | | | | | 93 |
| | | | | | | X | | | | | | | 55 |
| | | | | | | | X | | | | | | 38 |
| | | | | | | | | X | | | | | 20 |
| | | | | | | | | | X | | | | 85 |
| | | | | | | | | | | X | | | 83 |
| | | | | | | | | | | | X | | 98 |
| | | | | | | | | | | | | X | 92 |
| | 1-Ethoxy-4-butanol | X | | | | | | | | | | | 81 |
| | | | X | | | | | | | | | | 96 |
| | | | | X | | | | | | | | | 80 |
| | | | | | X | | | | | | | | 95 |
| | | | | | | X | | | | | | | 52 |
| | | | | | | | X | | | | | | 35 |
| | | | | | | | | X | | | | | 21 |
| | | | | | | | | | X | | | | 89 |
| | | | | | | | | | | X | | | 89 |
| | | | | | | | | | | | X | | 95 |
| | | | | | | | | | | | | X | 94 |
| | 1-Propoxy-4-butanol | X | | | | | | | | | | | 85 |
| | | | X | | | | | | | | | | 97 |
| | | | | X | | | | | | | | | 88 |
| | | | | | X | | | | | | | | 96 |
| | | | | | | X | | | | | | | 53 |
| | | | | | | | X | | | | | | 38 |
| | | | | | | | | X | | | | | 25 |
| | | | | | | | | | X | | | | 88 |
| | | | | | | | | | | X | | | 87 |
| | | | | | | | | | | | X | | 90 |
| | | | | | | | | | | | | X | 95 |
| | | X | | | | | | | | | | | 86 |
| | 1-Butoxy-4-butanol | | X | | | | | | | | | | 90 |
| | | | | X | | | | | | | | | 81 |
| | | | | | X | | | | | | | | 92 |
| | | | | | | X | | | | | | | 58 |
| | | | | | | | X | | | | | | 33 |
| | | | | | | | | X | | | | | 23 |
| | | | | | | | | | X | | | | 86 |
| | | | | | | | | | | X | | | 85 |
| | | | | | | | | | | | X | | 95 |
| | | | | | | | | | | | | X | 94 |
| | 1-Methoxy-5-pentanol | X | | | | | | | | | | | 82 |
| | | | X | | | | | | | | | | 94 |
| | | | | X | | | | | | | | | 87 |
| | | | | | X | | | | | | | | 91 |
| | | | | | | X | | | | | | | 55 |
| | | | | | | | X | | | | | | 32 |
| | | | | | | | | X | | | | | 22 |
| | | | | | | | | | X | | | | 87 |
| | | | | | | | | | | X | | | 88 |
| | | | | | | | | | | | X | | 92 |
| | | | | | | | | | | | | X | 95 |
| | 1-Ethoxy-5-pentanol | X | | | | | | | | | | | 83 |
| | | | X | | | | | | | | | | 93 |
| | | | | X | | | | | | | | | 89 |
| | | | | | X | | | | | | | | 94 |
| | | | | | | X | | | | | | | 55 |
| | | | | | | | X | | | | | | 34 |
| | | | | | | | | X | | | | | 24 |
| | | | | | | | | | X | | | | 81 |
| | | | | | | | | | | X | | | 85 |
| | | | | | | | | | | | X | | 94 |
| | | | | | | | | | | | | X | 95 |
| | 1-Propoxy-5-pentanol | X | | | | | | | | | | | 83 |
| | | | X | | | | | | | | | | 89 |
| | | | | X | | | | | | | | | 82 |
| | | | | | X | | | | | | | | 95 |
| | | | | | | X | | | | | | | 50 |
| | | | | | | | X | | | | | | 30 |
| | | | | | | | | X | | | | | 23 |
| | | | | | | | | | X | | | | 83 |
| | | | | | | | | | | X | | | 88 |
| | | | | | | | | | | | X | | 96 |
| | | | | | | | | | | | | X | 91 |

The invention is not limited to any one of the embodiments described above, but modifiable in various ways.

All features and advantages arising from the claims and the description, including design details, spatial arrangements and procedure steps, can be essential to the invention, either individually or in various combinations.

As can be seen the invention concerns a process for preparing an essentially silicon (Si) free compounds of the general formula [M(O)(OR)_{y}], wherein M = Mo, y = 3 or M = W, y = 3 or 4. Furthermore, it is directed towards compounds obtained by the aforementioned process, towards the use of such a compound obtained by the aforementioned process and a substrate having a layer of M or a layer comprising M on its surface obtained by the aforementioned process. Another objective of the herein described invention are essentially silicon free compounds obtained by the aforementioned process, of the general formula MOX_{y} or [MOX_{y}(solv)ₚ], wherein M = Mo, y = 3 or M = W, y = 3 or 4, X = Cl or Br, solv = an oxidizing agent Z binding or coordinating to M via at least one donor atom, p = 1 or 2. The invention is also directed towards the use of essentially silicon free compounds obtained by the aforementioned process, of the general formula MOX_{y} or [MOX_{y}(solv)ₚ].

1. A process for preparing an essentially silicon (Si) free compound of the general formula 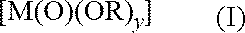
wherein
M = Mo and y = 3 or M = W and y = 3 or 4 and
R is selected from the group consisting of a linear, branched or cyclic alkyl group (C1 -C10), a linear, branched or cyclic partially or fully halogenated alkyl group (C1 - C10), an alkylene alkyl ether group (R^{E}-O)ₙ-R_{F}, a benzyl group, a partially or fully substituted benzyl group, a monocyclic or polycyclic aryl group, a partially or -fully substituted monocyclic or polycyclic aryl group, a monocyclic or polycyclic heteroaryl group and a partially or fully substituted monocyclic or polycyclic heteroaryl group,
wherein R^{E} are independently from each other selected from the group consisting of a linear, a branched or a cyclic alkylene group (C1 - C6) and a linear, a branched or a cyclic partially or fully halogenated alkylene group (C1 - C6),
R^{F} are independently from each other selected from the group consisting of a linear, a branched or a cyclic alkyl group (C1 - C10) and a linear, a branched or a cyclic partially or fully halogenated alkyl group (C1 - C10), a substituted or unsubstituted aryl group (C6 - C11), and
n = 1 to 5 or 1, 2 or 3,
comprising the steps of
a) reacting a compound of the general formula MX_{y+2} wherein
M and y are defined as above and
X = Cl or Br,
with an essentially silicon (Si) free oxidizing agent Z comprising 1 to 10 carbon atoms at a molar ratio of MX_{y+2} to the oxidizing agent Z of at least 1 : 0.75 in at least one aprotic solvent A,
b) addition of an alcohol ROH, wherein
R is defined as above,
a molar ratio of MX_{y+2} to the alcohol ROH is at least 1 : 4, and
ROH is different from the oxidizing agent Z of step a),
c) supply of at least one essentially silicon (Si) free base.

2. The process according to claim 1, wherein the essentially silicon-free oxidizing agent Z is selected from the group consisting of alcohols, ketones, ethers, and mixtures thereof.

3. The process according to claim 1, wherein the essentially silicon-free oxidizing agent Z comprises 1 to 8 carbon atoms or 1 to 6 carbon atoms or 1 to 4 carbon atoms.

4. The process according to claim 1, wherein the molar ratio of MX_{y+2} to the essentially silicon-free oxidizing agent Z is in the range of 1 : 0.75 to 1 : 2.50 or in the range of 1 : 0.80 to 1 : 1.50 or in the range of 1 : 0.85 to 1 : 1.30.

5. The process according to claim 1, wherein MX_{y+2} is applied as
a solid,
a saturated solution in the aprotic solvent A,
a suspension in the aprotic solvent A or
as a solution in the aprotic solvent A or in a solvent miscible with the solvent A.

6. The process according to claim 1, wherein
the neat essentially silicon-free oxidizing agent Z or
a solution of the essentially silicon-free oxidizing agent Z in the aprotic solvent A or in a solvent miscible with the aprotic solvent A
is applied.

7. The process according to claim 1, wherein R is selected from the group consisting of methyl, ethyl, propyl, isopropyl, butyl, isobutyl, tert-butyl, sec-butyl, pentyl, sec-pentyl, 3-pentyl, 2-methylbutyl, 3-methylbutyl, 2-methylbut-2-yl, 3-methylbut-2-yl, neopentyl, hexyl, 1-hexyl, 2-hexyl,3-hexyl,2-methylpent-1-yl, 3-methylpent-1-yl, 4-methylpent-1-yl, 2-methylpent-2-yl, 3-methylpent-2-yl, 4-methylpent-2-yl, 2-methylpent-3-yl, 3-methylpent-3-yl, 2,2-dimethylbut-1-yl, 2,3-dimethylbut-1-yl, 3,3-dimethylbut-1-yl, 2,3-dimethylbut-2-yl, 3,3-dimethylbut-2-yl, 2-ethylbut-1-yl, phenyl, benzyl, toluyl, mesityl, naphthyl and mixtures thereof.

8. Process according to claim 1, wherein the alcohol is selected from the group consisting of a monoethylene glycol monoalkyl ether, a diethylene glycol monoalkyl ether, a triethylene glycol monoalkyl ether, a monopropylene glycol monoalkyl ether, a dipropylene glycol monoalkyl ether, a tripropylene glycol monoalkyl ether, a monooxomethylene monoalkyl ether, a dioxomethylene monoalkyl ether and a trioxomethylene monoalkyl ether, a mixture of isomers thereof, and mixtures thereof, or when R corresponds to the formula (R^{E}-O)ₙ-R_{F}, then R^{E} is selected from the group consisting of methenyl (—CH₂—), ethenyl (—CH₂CH₂—), propenyl (—CH₂CH₂CH₂—), isopropenyl (—CH(CH₃)CH₂—), n-butenyl (—CH₂CH₂CH₂CH₂—), pentenyl (—CH₂CH₂CH₂CH₂CH₂—), hexenyl (—CH₂CH₂CH₂CH₂CH₂CH₂—) and mixtures thereof and R^{F} is selected from the group consisting of methyl, ethyl, propyl, isopropyl, butyl, isobutyl, tert-butyl, sec-butyl, pentyl, sec-pentyl, 3-pentyl, 2-methylbutyl, 3-methylbutyl, 2-methylbut-2-yl, 3-methylbut-2-yl, neopentyl, hexyl, 1-hexyl, 2-hexyl,3-hexyl, 2-methylpent-1-yl, 3-methylpent-1-yl, 4-methylpent-1-yl, 2-methylpent-2-yl, 3-methylpent-2-yl, 4-methylpent-2-yl, 2-methylpent-3-yl, 3-methylpent-3-yl, 2,2-dimethylbut-1-yl, 2,3-dimethylbut-1-yl, 3,3-dimethylbut-1-yl, 2,3-dimethylbut-2-yl, 3,3-dimethylbut-2-yl, 2-ethylbut-1-yl, phenyl, benzyl, toluyl, mesityl, naphthyl and mixtures thereof.

9. Process according to claim 1, wherein the alcohol is selected from the group consisting of methanol, ethanol, propanol, iso-propanol, n-butanol, iso-butanol, sec-butanol, tert-butanol, 1-pentanol, 2-pentanol, 3-pentanol, 2-methyl-1-butanol, 2-methyl-2-butanol, 3-methyl-1-butanol, 3-methyl-2-butanol, 2,2-dimethyl-1-propanol, 1-hexanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 3,3-dimethyl-1-butanol, 2,3-dimethyl-2-butanol, 3,3-dimethyl-2-butanol, 2-ethyl-1-butanol, 2-ethyl-hexanol, 1-heptanol, 2-heptanol, 3-heptanol, 4-heptanol, 2-propyl-1-heptanol, 2-butyl-1-octanol, sBuCH₂—OH, iBuCH₂—OH, (iPr)(Me)CH—OH, (nPr)(Me)CH—OH, (Et)₂CH—OH, (Et)(Me)₂C—OH, C₆H₁₁—OH, benzyl alcohol C₆H₅CH₂—OH, phenol C₆H₅OH, ethylene glycol monomethyl ether CH₃—O—CH₂CH₂—OH, ethoxy ethanol CH₃CH₂—O—CH₂CH₂—OH, ethylene glycol monopropyl ether CH₃CH₂CH₂—O—CH₂CH₂—OH, ethylene glycol monoisopropyl ether (CH₃)₂CH—O—CH₂CH₂—OH, ethylene glycol monobutyl ether CH₃CH₂CH₂CH₂—O—CH₂CH₂—OH, ethylene glycol monopentyl ether CH₃CH₂CH₂CH₂CH₂—O—CH₂CH₂—OH, ethylene glycol monohexyl ether CH₃CH₂CH₂CH₂CH₂CH₂—O—CH₂CH₂—OH, ethylene glycol monophenyl ether C₆H₅—O—CH₂CH₂—OH, ethylene glycol monobenzyl ether C₆H₅CH₂—O—CH₂CH₂—OH, diethylene glycol monomethyl ether CH₃—O—CH₂CH₂—O—CH₂CH₂—OH, diethylene glycol monoethyl ether CH₃CH₂—O—CH₂CH₂—O—CH₂CH₂—OH, diethylene glycol monopropyl ether CH₃CH₂CH₂—O—CH₂CH₂—O—CH₂CH₂—OH, diethylene glycol monoisopropyl ether (CH₃)₂CH—O—CH₂CH₂—O—CH₂CH₂—OH, diethylene glycol monobutyl ether CH₃CH₂CH₂CH₂—O—CH₂CH₂—O—CH₂CH₂—OH, diethylene glycol monopentyl ether CH₃CH₂CH₂CH₂CH₂—O—CH₂CH₂—O—CH₂CH₂—OH, diethylene glycol monohexyl ether CH₃CH₂CH₂CH₂CH₂CH₂—O—CH₂CH₂—O—CH₂CH₂—OH, diethylene glycol monophenyl ether C₆H₅—O—CH₂CH₂—O—CH₂CH₂—OH, diethylene glycol monobenzyl ether C₆H₅CH₂—O—CH₂CH₂—O—CH₂CH₂—OH, propylene glycol monomethyl ether CH₃—O—CH₂CH₂CH₂—OH, propylene glycol monoethyl ether CH₃CH₂—O—CH₂CH₂CH₂—OH, propylene glycol monopropyl ether CH₃CH₂CH₂—O—CH₂CH₂CH₂—OH, propylene glycol monoisopropyl ether (CH₃)₂CH—O—CH₂—C(CH₃)—OH, propylene glycol monobutyl ether CH₃CH₂CH₂CH₂—O—CH₂CH₂CH₂—OH, propylene glycol monopentyl ether CH₃CH₂CH₂CH₂CH₂—O—CH₂CH₂CH₂—OH, propylene glycol monohexyl ether CH₃CH₂CH₂CH₂CH₂CH₂—O—CH₂CH₂CH₂—OH, propylene glycol monophenyl ether C₆H₅—O—CH₂CH₂CH₂—OH, propylene glycol monobenzyl ether C₆H₅CH₂—O—CH₂CH₂CH₂—OH, iso-propylene glycol monomethyl ether CH₃—O—CH₂—C(CH₃)—OH, iso-propylene glycol monoethyl ether CH₃CH₂—O—CH₂—C(CH₃)—OH, iso-propylene glycol monopropyl ether CH₃CH₂CH₂—O—CH₂—C(CH₃)—OH, iso-propylene glycol monoisopropyl ether (CH₃)₂CH—O—CH₂—C(CH₃)—OH, iso-propylene glycol monobutyl ether CH₃CH₂CH₂CH₂—O—CH₂—C(CH₃)—OH, iso-propylene glycol monopentyl ether CH₃CH₂CH₂CH₂CH₂—O—CH₂—C(CH₃)—OH, iso-propylene glycol monohexyl ether CH₃CH₂CH₂CH₂CH₂CH₂—O—CH₂—C(CH₃)—OH, iso-propylene glycol monophenyl ether C₆H₅—O—CH₂—C(CH₃)—OH, dipropylene glycol monopropyl ether CH₃CH₂CH₂—O—CH₂CH(CH₃)OCH₂CH(CH₃)OH, iso-propylene glycol monobenzyl ether C₆H₅CH₂—O—CH₂—C(CH₃)—OH, dipropylene glycol monomethyl ether CH₃OCH₂CH₂CH₂OCH₂CH₂CH₂OH (mixture of isomers where appropriate), 1-methoxy-2-propanol CH₃OCH₂CH₂CH₂OH, tripropylene glycol monomethyl ether CH₃OCH₂CH₂CH₂OCH₂CH₂CH₂OCH₂CH₂CH₂OH, dipropylene glycol monobutyl ether C₄H₉OCH₂CH₂CH₂OCH₂CH₂CH₂OH, 1-butoxy-2-propanol C₄H₉OCH₂CH₂CH₂OH, tripropylene glycol monobutyl ether C₄H₉OCH₂CH₂CH₂OCH₂CH₂CH₂OCH₂CH₂CH₂OH, 1-propoxy-2-propanol C₃H₇OCH₂CH₂CH₂OH, a mixture of isomers thereof, and mixtures thereof.

10. The process according to claim 1, wherein the at least one essentially silicon-free base is selected from the group consisting of organic, organometallic and inorganic bases, and mixtures thereof.

11. The process according to claim 10, wherein the at least one essentially silicon-free base is selected from the group consisting of amines, ammonia, heterocyclic nitrogenous bases, alkali metal oxides and alkali metal amides, and mixtures thereof.

12. The process according to claim 1, wherein the supply of at least one essentially silicon (Si) free base according to step c) includes the options of adding the essentially silicon-free base
by introducing a gas or a liquid or a solid, each being or comprising the at least one essentially silicon-free base,
by introducing a solution comprising the at least one essentially silicon-free base or
by pressurisation of the respective essentially silicon-free base in a pressure vessel.

13. The process according to claim 1, wherein a pressure pR is in the range of 1013.25 hectopascal (hPa) to 6000 hectopascal (hPa) or in the range of 1500 hectopascal (hPa) to 3000 hectopascal (hPa).

14. The process according to claim 1, wherein the aprotic solvent A is selected from the group consisting of linear or cyclic, saturated or unsaturated, aliphatic or aromatic hydrocarbons, partly or fully halogenated linear or cyclic, saturated or unsaturated, aliphatic or aromatic hydrocarbons, ether, benzene and benzene derivatives, and mixtures thereof.

15. The process according to claim 1, wherein step a), step b) or both comprise a distillation.

16. The process according to claim 1, wherein the reaction according to step a) comprises the steps of
i. providing a solution or suspension of MX_{y+2} in the aprotic solvent A,
ii. addition of the essentially silicon-free oxidizing agent Z,
wherein during the addition and/or after the addition of the essentially silicon-free oxidizing agent Z a reaction between MX_{y+2} and the essentially silicon-free oxidizing agent Z occurs.

17. The process according to claim 1, wherein a temperature T_{R} is in the range of -100° C. to 200° C. or in the range of -90° C. to 170° C. or in the range of -20° C. to 140° C.

18. The process according to claim 1, wherein the molar ratio of MX_{y+2} to the alcohol ROH ranges from 1 : 3 for y = 3, or from 1 : 4 for y = 4 to 1 : 40 for y = 3 or 4.

19. The process according to claim 1, wherein a temperature Tc ranges from -30° C. to 50° C. during and/or after the addition of the alcohol ROH.

20. The process according to claim 1, wherein a temperature T_{N} ranges from -30° C. to 100° C. during and/or after the supply of at least one silicon (Si) free base.

21. The process according to claim 20, wherein
a temperature T_{N1} ranges from -30° C. to 20° C. during a first phase of the supply of the at least one silicon (Si) free base and
a temperature T_{N2} ranges from 21° C. to 100° C. during and/or after a second phase of the supply of the at least one silicon (Si) free base.

22. The process according to claim 1, wherein after step a) a reaction step is conducted comprising a removal of volatile by-products and/or solvent.

23. The process according to claim 1, wherein after step c) a reaction step d) is conducted comprising an isolation of the compound of the general formula [M(O)(OR)_{y}] (I).

24. Compounds of the general formula [M(O)(OR)_{y}] (I) having a silicon content of 1000 ppm or less, obtained by the process according to claim 1.

25. A process for preparing an essentially silicon (Si) free compound of the general formula 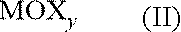
or 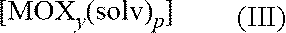
wherein
M = Mo and y = 3 or M = W and y = 3 or 4,
X=Cl or Br,
solv = an oxidizing agent Z binding or coordinating to M via at least one donor atom and
p = 1 and y = 4 or p = 2 and y = 3, the process comprising the steps of
a) providing a compound of the general formula MX_{y+2} and
b) reacting MX_{y+2} with at least one essentially silicon (Si) free oxidizing agent Z comprising 1 to 10 carbon atoms
at a molar ratio of MX_{y+2} to the oxidizing agent Z of at least 1 : 0.75 in at least one aprotic solvent A.

26. The process according to claim 25, wherein the essentially silicon-free oxidizing agent Z is selected from the group consisting of alcohols, ketones, ethers, and mixtures thereof.

27. The process according to claim 25, wherein the molar ratio of MX_{y+2} to the essentially silicon-free oxidizing agent Z is preferably in the range of 1 : 0.75 to 1 : 2.50, more preferably in the range of 1 : 0.80 to 1 : 1.50 and most preferably in the range of 1 : 0.85 to 1 : 1.30.

28. The process according to claim 25, wherein MX_{y+2} is applied as
a solid,
a saturated solution in the aprotic solvent A
a suspension in the aprotic solvent A or
as a solution in the aprotic solvent A or in a solvent miscible with the solvent A.

29. The process according to claim 25, wherein
the neat essentially silicon-free oxidizing agent Z or
a solution of the essentially silicon-free oxidizing agent Z in the solvent A or in a solvent miscible with the solvent A
is applied.

30. The process according to claim 25, wherein a temperature T_{R} is in the range of -100° C. to 200° C., preferably in the range of -90° C. to 170° C., more preferably in the range of -20° C. to 140° C.

31. The process according to claim 25, wherein after step b) a reaction step c) is conducted, the step c) comprising
i. a separation of by-products and/or
ii. an isolation of the compound of the general formula MOX_{y} (II) or [MOX_{y}(solv)ₚ] (III).

32. The process according to claim 25, wherein the reaction mixture from step a) and the isolated compound of the general formula MOX_{y} (II) or [MOX_{y}(solv)ₚ] (III) contain 1000 ppm (thousand) or less or 50 ppm or less or 10 ppm (ten) or less or 1.500 ppb (fifteen hundred) or less, silicon each, wherein the silicon content is determined by inductively coupled plasma optical emission spectrometry.

33. Essentially silicon (Si) free compounds of the general formula MOX_{y} (II) or [MOX_{y}(solv)ₚ] (III), obtained by the process according to claim 25.

34. A solution or suspension comprising a compound of the general formula MOX_{y} (II) or [MOX_{y}(solv)ₚ] (III), obtained by the process according to claim 25.

35. Use of an essentially silicon (Si) free compound of the general formula 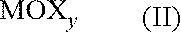
or 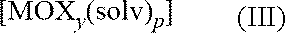
or of an essentially silicon (Si) free solution or suspension comprising the essentially silicon (Si) free compound of the general formula MOX_{y} (II) or [MOX_{y}(solv)ₚ] (III),
obtained by the process according to claim 25
for preparing an essentially silicon (Si) free compound of the general formula [M(O)(OR)_{y}] (I).

36. A process for preparing an essentially silicon (Si) free compound of the general formula 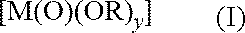
using an essentially silicon (Si) free compound of the general formula MOX_{y} (II) or [MOX_{y}(solv)ₚ] (III)
or an essentially silicon (Si) free solution or suspension comprising the essentially silicon (Si) free compound of the general formula MOX_{y} (II) or [MOX_{y}(solv)ₚ] (III), wherein
M = Mo and y = 3 or M = W and y = 3 or 4,
X=Cl or Br,
solv = an oxidizing agent Z binding or coordinating to M via at least one donor atom
p = 1 and y = 4 or p = 2 and y = 3 and
R is selected from the group consisting of a linear, branched or cyclic alkyl group (C5 -C10), a linear, branched or cyclic partially or fully halogenated alkyl group (C5 - C10), an alkylene alkyl ether group (R^{E}-O)ₙ-R^{F}, a benzyl group, a partially or fully substituted benzyl group, a monocyclic or polycyclic arene, a partially or fully substituted monocyclic or polycyclic arene, a monocyclic or polycyclic heteroarene and a partially or fully substituted monocyclic or polycyclic heteroarene, wherein
R^{E} are independently from each other selected from the group consisting of a linear, a branched or a cyclic alkylene group (C1 - C6) and a linear, a branched or a cyclic partially or fully halogenated alkylene group (C1 - C6),
R^{F} are independently from each other selected from the group consisting of a linear, a branched or a cyclic alkyl group (C1- C10) and a linear, a branched or a cyclic partially or fully halogenated alkyl group (C1 - C10), and
n = 1 to 5 or 1, 2 or 3,
obtained by the process according to claim 24
comprising the steps of
a) providing the essentially silicon (Si) free compound of the general formula MOX_{y} (II) or [MOX_{y}(solv)ₚ] (III) prepared by the aforementioned process
b) addition of an alcohol ROH, wherein
R is defined as above and
a molar ratio of MOX_{y} (II) or [MOX_{y}(solv)ₚ] (III) to the alcohol ROH is at least 1 : 3,
c) supply of at least one essentially silicon (Si) free base, wherein step a) or b) may optionally comprise a distillation.

37. Essentially silicon (Si) free compounds of the general formula [M(O)(OR)y] (I) obtained by the process according to claim 36.
